(19) United States
(12) Patent Application Publication
(10) Pub. No.: US 2024/0100502 A1
(43) Pub. Date: Mar. 28, 2024

(54) POROUS POLYMERIC CARBON SORBENTS FOR CO2 CAPTURE AND METHODS OF MAKING AND USING SAME

(71) Applicant: William Marsh Rice University, Houston, TX (US)

(72) Inventors: James M. Tour, Houston, TX (US); Wala Algozeeb, Houston, TX (US); Paul E. Savas, Jr., Houston, TX (US); Wilbur Carter Kittrell, Houston, TX (US)

(73) Assignee: WILLIAM MARSH RICE UNIVERSITY, Houston, TX (US)

(21) Appl. No.: 17/768,790

(22) PCT Filed: Oct. 14, 2020
(86) PCT No.: PCT/US20/55637

§ 371 Date: Apr. 13, 2022

Related U.S. Application Data
(60) Provisional application No. 62/914,826, filed on Oct. 14, 2019.

(51) Int. Cl. B01J 20/26; B01J 20/28; B01J 20/30; C08J 11/26

(52) U.S. Cl. CPC B01J 20/261; B01J 20/28011; B01J 20/28054; B01J 20/3078; C08J 11/26; B01J 2220/4875

(57) ABSTRACT

Rigid porous polymeric carbon sorbents, including particularly polymeric carbon sorbents for CO₂ capture for flue gas from power plants and for gases from other post combustion CO₂ emission outlets, and methods of making and using same. The porous carbon material can be prepared by heating plastic with an additive. The additive can be selected from metal hydroxide, metal oxalate, metal acetate, metal acetylacetonoate or mixtures thereof. By controlling the preparation, such as the temperature of preparation, the porous carbon sorbent can be controlled to be rigid.

### CROSS-REFERENCE TO RELATED PATENT APPLICATIONS

This application is a 35 U.S.C § 371 national application of PCT Application No. PCT/US20/55637, filed on Oct. 14, 2020, entitled “Porous Polymeric Carbon Sorbents For Co2 Capture And Methods Of Making And Using Same”, which claims priority to U.S. Patent Appl. Ser. No. 62/914,826, filed Oct. 14, 2019, entitled “Method To Convert Plastic Waste To Porous Polymeric Carbon Sorbents And Compositions Thereof,” which patent applications are commonly owned by the owner of the present invention.

This application relates to PCT Appl. No. PCT/US20/55638 (Attorney Docket No. 072174-01201), filed concurrent herewith, entitled “Porous Polymeric Carbon Sorbents For Gas Storage And Methods Of Making And Using Same,” and PCT Int'l Appl. No. PCT/US20/55639 (Attorney Docket No. 072174-01301), filed concurrent herewith, entitled “Porous Polymeric Carbon Sorbents For Direct Air Capture Of CO₂ And Methods Of Making And Using Same,” which patent applications are commonly owned by the owner of the present invention.

These patent applications are incorporated herein in their entirety.

### TECHNICAL FIELD

The present invention relates to porous polymeric carbon sorbents, including particularly porous polymeric carbon sorbents for CO₂ capture for flue gas from power plants and for gases from other post-combustion CO₂ emission outlets, for gas storage, and for direct air capture of CO₂, and methods of making and using same.

### BACKGROUND

Plastic pollution and ever-raising carbon dioxide (CO₂) levels are among the top environmental concerns of the 21st century. [Modak 2019; Younas 2016; Ramanathan 2009]. The concentration of CO₂ in the atmosphere has increased from preindustrial value of ˜280 ppm to 401 ppm in 2018. [Ramanathan 2009]. This increase in CO₂ levels is believed to be primarily due to the continuous combustion of fossil fuels and the lack of economical CO₂ capture routes. With the slow development of green and renewable energy sources, fossil fuels are expected to remain the least expensive energy source for the next 40 years. [Haszeldine 2009; Pacala 2004]. To lessen the impact caused by fossil fuel consumption, efficient and economic post-combustion CO₂ capture technologies are needed to replace the expensive and energy intensive amine-based chemical absorption that has been practiced in industry for years. [Rochelle 2009].

Amine-based technologies for CO₂ capture rely on the chemical reaction between amines and CO₂ to form a carbamate complex as shown in eq. 1. [Rochelle 2009; Astaria 1983; Rao 2002].

2R—NH₂+CO₂⇄R—NH₃⁺+R—NHCOO⁻ (eq. 1)

Carbamates are stable and require heating to 125° C. to regenerate the amine, making it an extremely energy intensive technology given the high heat capacity of aqueous amine solution. [Camper 2008]. On top of the high regeneration cost, aqueous amines are corrosive and cause continuous equipment failures in the CO₂ capture units, degrade upon heating, are expensive to replace, produce large amounts of wastewater and sludge as byproducts, and they occupy a large footprint. Thus, the development of a greener and cheaper technology is sought after. [Dutcher 2008].

Solid sorbents have received more interest in recent years due to their low heat of regeneration and high thermal stability. [Jalilov I 2017; Jung 2013]. Out of all reported solid sorbents, activated carbons are inexpensive, non-toxic and they have a resilient structure [Gray 2008; Jalilov 2015; Sevilla 2018; Siriwardane 2001; Tour 2010; Xu 2018], making them great candidates for applications with severe and harsh conditions as found in crude oil desulfurization [Bandosz 2006; Wang 2007], gas storage [Sun 1996], and high-pressure CO₂ capture [Jalilov I 2017]. The surface area and pore volume of carbonaceous materials can be easily tuned and economically generated. Moreover, carbonaceous materials can be synthesized from various feedstocks ranging from a renewable biomass like glucose [Sevilla 2018] to industrial carbon waste like asphalt [Jalilov II 2017], which makes the precursors of carbonaceous material highly abundant.

With the increasing awareness of the harmful effects of microplastics, nanoplastics and other plastic waste [Cox 2019; Tetu 2019], new technologies for plastic waste utilization are being pursued. One of the proposed technologies to treat plastic waste is pyrolysis of plastic, also called chemical recycling. [Al-Salem 2009]. This method involves heating plastics in an inert atmosphere, a process which breaks up the plastic into smaller molecules such as monomers, oligomers, oils and waxes, along with a nonvolatile carbonaceous residue or char. [Al-Salem 2009; Panda 2018]. This process occurs at ˜600° C. [Panda 2018]. The waxes and oil products are further cracked over acidic zeolites or bentonite clay to obtain higher value petrochemicals and fuels. [Nishino 2008; Mani 2011; Budsaereechai 2019]. One of the drawbacks of pyrolysis methods is the formation of large amounts of char that currently has no significant usefulness. [Kiran Ciliz 2004].

Accordingly, there is a need for improved processes to address the large environmental issues that are being faced today, namely plastic waste pollution and the rising CO₂ levels in the atmosphere.

Moreover, existing porous sorbent synthesis technologies require heating carbon source with potassium salts (KOH most often used) at 700° C.-900° C., making the process very energy intensive and hard to scale up. Also, at high temperatures and mass quantities there is a risk of formation of potassium metal making the current routes for sorbent synthesis difficult to commercialize because traces of potassium can cause fires, igniting the carbon upon work-up. While in a lab the danger is small, industrially, in large scale, the danger is enormous. Thus an improved process that is safer, less energy intensive, scalable, and commercial is needed.

Furthermore, while the demand for ethylene increases every year, ethylene trade is limited due to challenges in transporting and refrigerating ethylene. FIGS. 1A-1B show two current commercial processes for ethylene production, which require high temperatures greater than 850° C. to produce ethylene. Accordingly, there is a need for an improved process for ethylene production.

### SUMMARY OF THE INVENTION

In general, in one embodiment, the invention features a method of synthesizing a rigid porous polymeric carbon sorbent. The method includes the step of mixing a polymer with an additive to form a mixture. The polymer has a polymer chain order including long range order and short range order as detected by powder X-ray diffraction (XRD). The additive is an activation reagent that is selected from the group consisting of metal hydroxide, metal oxalate, metal acetate, metal acetylacetonoate, and mixtures thereof. The method further includes the step of heating the mixture to a temperature to form a porous polymeric carbon sorbent via chemical activation. The chemical activation results in a loss of the long range order and the short range order of the polymer as detected by powder XRD such that the porous polymeric carbon sorbent material is a rigid porous polymeric carbon sorbent. The rigid porous polymeric carbon sorbent is operable for capturing CO₂ at a pressure between 0.75 atm to 5 atm. The rigid polymeric carbon sorbent has a selectivity for capturing CO₂ over N₂ at least 40:1 at 0.15 bar of CO₂ in 0.85 bar of N₂ at 23° C.

Implementations of the invention can include one or more of the following features:

The polymer can be selected from a group consisting of high density polyethylene (HDPE), low density polyethylene (LDPE), polypropylene (PP), and combinations thereof.

The polymer can be selected from a group consisting of polyvinyl chloride (PVC), nylon, melamine mixed with HDPE, melamine mixed with LDPE, melamine mixed with PP, melamine-formaldehyde resins, polyethylene imine (PEI), PEI mixed with HDPE, polyurethanes (PU), polyacrylonitrile, (PAN), and polyethyleneteraphthalte (PET) and mixtures therefrom.

The polymer can include nitrogen atoms.

The rigid polymeric carbon sorbent can have a selectivity for capturing CO₂ over N₂ at least 300:1 in 0.15 bar of CO₂ in 0.85 bar N₂ at 23° C.

The polymer can include a plastic from a waste plastic source.

The step of heating can be performed at a temperature that is between 550° C. and 700° C.

The step of heating can be performed at a temperature that is between 575° C. and 600° C.

The activation reagent can be an acetate salt of potassium or calcium.

The activation reagent can be potassium acetate.

The activation reagent can be calcium acetate.

The weight ratio of the additive and the polymer in the mixture can be between 0.5:1 and 5:1.

The weight ratio of the additive and the polymer in the mixture can be between 2:1 and 4:1.

The rigid porous polymeric carbon sorbent can be operable for capturing CO₂ from a post-combustion CO₂ emission outlet gas.

The post-combustion CO₂ emission outlet gas can be a flue gas.

The rigid porous polymeric carbon sorbent can be operable for capturing more than 15 wt % CO₂ from a post-combustion CO₂ emission outlet gas at 25° C. and at 1 atm.

The rigid porous polymeric carbon sorbent can be operable for releasing the CO₂ captured from a post-combustion CO₂ emission outlet gas by heating the rigid porous polymeric carbon sorbent to at most 110° C. at 1 atm.

The rigid porous polymeric carbon sorbent can be operable for releasing the CO₂ captured from a post-combustion CO₂ emission outlet gas by heating the rigid porous polymeric carbon sorbent to at most 75° C. at 1 atm.

The rigid porous polymeric carbon sorbent can be operable for capturing more than 18 wt % CO₂ from a post-combustion CO₂ emission outlet gas at 25° C. and at most 5 atm.

The rigid porous polymeric carbon sorbent can be operable for capturing more than 100 wt % CO₂ from a post-combustion CO₂ emission outlet gas at 25° C. and at most 300 atm.

The method can further include controlling pore size of the rigid porous polymeric carbon sorbent by controlling pressure during the step of heating.

The step of heating the mixture can be performed at a near vacuum pressure of at least 0.01 bars.

In general, in another embodiment, the invention features a rigid porous polymeric carbon sorbent. The rigid porous polymeric carbon sorbent is operable to capture more than 15 wt % CO₂ from a post-combustion CO₂ emission outlet gas at 25° C. and at 1 atm. The rigid polymeric carbon sorbent has a selectivity for capturing CO₂ over N₂ at least 40:1 at 0.15 bar of CO₂ in 0.85 bar of N₂ at 23° C.

Implementations of the invention can include one or more of the following features:

The rigid porous polymeric carbon sorbent can include a polymer that has no polymeric long range order and no polymeric short range order detectable by powder X-ray diffraction.

The rigid porous polymeric carbon sorbent can include pores having an average pore size of between 2 Å and 100 Å.

The rigid porous polymeric carbon sorbent can include pores having an average pore size of between 5 Å and 20 Å.

The rigid porous polymeric carbon sorbent can be operable for releasing the CO₂ captured from post-combustion CO₂ emission outlet gas by heating the rigid porous polymeric carbon sorbent to at most 110° C. at about 1 atm pressure.

The rigid porous polymeric carbon sorbent can be operable for releasing the CO₂ captured from post-combustion CO₂ emission outlet gas by heating the rigid porous polymeric carbon sorbent to at most 75° C. at about 1 atm pressure.

The rigid porous polymeric carbon sorbent can be operable for capturing more than 18 wt % CO₂ from post-combustion CO₂ emission outlet gas at 25° C. and at 5 atm.

The rigid porous polymeric carbon sorbent can be operable for capturing more than 100 wt % CO₂ from post-combustion CO₂ emission outlet gas at 25° C. and at 300 atm.

The rigid porous polymeric carbon sorbent can include nitrogen atoms.

The rigid polymeric carbon sorbent can have a selectivity for capturing CO₂ over N₂ of at least 250:1 at 0.15 bar of CO₂ in 0.85 bar of N₂ at 23° C.

In general, in another embodiment, the invention features a method that includes selecting a rigid porous polymeric carbon sorbent having a selectivity for capturing CO₂ over N₂ least 40:1 at 0.15 bar of CO₂ in 0.85 bar of N₂ at 23° C. The method further includes utilizing the rigid porous polymeric carbon sorbent to capture more than 15 wt % CO₂ from post-combustion CO₂ emission outlet gas.

Implementations of the invention can include one or more of the following features:

The post-combustion CO₂ emission outlet gas can be a flue gas.

The CO₂ can be captured from post-combustion CO₂ emission outlet gas at atmospheric pressure.

The CO₂ can be captured from post-combustion CO₂ emission outlet gas at room temperature at around 25° C.

The rigid porous polymeric carbon sorbent can be utilized to capture more than 18 wt % CO₂ from post-combustion CO₂ emission outlet gas.

The CO₂ can be captured from post-combustion CO₂ emission outlet gas at a pressure that is at most 5 atm.

The rigid porous polymeric carbon sorbent can be utilized to capture more than 100 wt % CO₂ from post-combustion CO₂ emission outlet gas.

The CO₂ can be captured from post-combustion CO₂ emission outlet gas at a pressure that is at most 300 atm.

The method can further include releasing the CO₂ captured from post-combustion CO₂ emission outlet by heating the rigid porous polymeric carbon sorbent.

The CO₂ can be released by heating the rigid porous polymeric carbon sorbent to at most 110° C.

The CO₂ can be released by heating the rigid porous polymeric carbon sorbent to at most 75° C.

The method can further include repeating the capture and release of the CO₂ by the rigid porous polymeric carbon sorbent for at least 1000 cycles.

The method can further include repeating the capture and release of the CO₂ by the rigid porous polymeric carbon sorbent for at least 100,000 cycles.

The rigid porous polymeric carbon sorbent can have a selectivity for capturing CO₂ over N₂ of at least 70:1 at 0.15 bar of CO₂ in 0.85 bar of N₂ at 23° C.

The rigid porous polymeric carbon sorbent can include nitrogen atoms.

The rigid porous polymeric carbon sorbent can have a selectivity for capturing CO₂ over N₂ of at least 300:1 at least 40:1 at 0.15 bar of CO₂ in 0.85 bar of N₂ at 23° C.

In general, in another embodiment, the invention feature a method of synthesizing a flexible porous polymeric carbon sorbent. The method includes the step of mixing a polymer with an additive to form a mixture. The polymer has a polymer chain order including long range order and short range order as determined by powder X-ray diffraction (XRD). The additive is an activation reagent that is selected from the group consisting of metal hydroxide, metal oxalate, metal acetate, metal acetylacetonoate and mixtures thereof. The method further includes heating the mixture to a temperature to form a porous polymeric carbon sorbent via chemical activation. The chemical activation results in a loss of the long range order while maintaining short range order of the polymer as detected by powder XRD such that the porous polymeric carbon sorbent material is a flexible porous polymeric carbon sorbent. The flexible porous polymeric carbon sorbent is operable for storing 4.5 wt % H₂ at room temperature and 100 atm.

Implementations of the invention can include one or more of the following features:

The flexible porous polymeric carbon sorbent gas can be operable for storing each of H₂, CO₂, O₂, methane, natural gas, and combinations thereof.

The flexible porous polymeric carbon sorbent can be independently: (a) operable to store at least 150 wt % of CO₂ at room temperature and 50 atm; (b) operable to store at least 140 wt % of O₂ at room temperature and 110 atm; and (c) operable to store at least 80 wt % of CH₄ at room temperature and 100 atm.

The polymer can be selected from a group consisting of high density polyethylene (HDPE), low density polyethylene (LDPE), polypropylene (PP), and combinations thereof.

The polymer can be selected from a group consisting of polyvinyl chloride (PVC), nylon, melamine with HDPE, melamine with LDPE, melamine with PP, melamine-formaldehyde resins, melamine resins, urea, polyurethanes (PU), polyacrylonitrile, (PAN), polyethylene imine, polyethylene imine mixed with HDPE, and polyethyleneteraphthalte (PET) and mixtures therefrom.

The polymer can include nitrogen atoms.

The step of heating can be performed at a temperature that is between 400° C. and 525° C.

The step of heating can be performed at a temperature that is between 475° C. and 500° C.

The activation reagent can be an acetate salt of potassium or calcium.

The activation reagent can be potassium acetate.

The activation reagent can be calcium acetate.

The weight ratio of the additive and the polymer in the mixture can be between 0.5:1 and 5:1.

The weight ratio of the additive and the polymer in the mixture can be between 2:1 and 4:1.

The flexible porous polymeric carbon sorbent can be operable for storing more than 5.5 wt % of H₂ at room temperature and 100 atm.

The flexible porous polymeric carbon sorbent can be operable for storing more than 8 wt % of H₂ at room temperature and 100 atm.

The flexible porous polymeric carbon sorbent can be operable for storing about 13 wt % of H₂ at room temperature and 200 atm.

The flexible porous polymeric carbon sorbent can be operable for storing about 15 wt % of H₂ at room temperature and 300 atm.

The flexible porous polymeric carbon sorbent can be operable for storing more than 80 wt % of CH₄ at room temperature and 100 atm.

The flexible porous polymeric carbon sorbent can be operable for storing more than 150 wt % of CH₄ at room temperature and 200 atm.

The flexible porous polymeric carbon sorbent can be operable for storing more than 175 wt % of CH₄ at room temperature and 300 atm.

The flexible porous polymeric carbon sorbent can be operable for releasing the stored gas by lowering the pressure back to 1 atm.

The method can further include controlling pore size of the flexible porous polymeric carbon sorbent by controlling pressure during the step of heating.

The step of heating the mixture can be performed at a near vacuum pressure of at least 0.01 bars.

In general, in another embodiment, the invention features a flexible porous polymeric carbon sorbent that is operable for storing 4.5 wt % H₂ at room temperature and 100 atm.

Implementations of the invention can include one or more of the following features:

The flexible porous polymeric carbon sorbent can be independently: (a) operable to store at least 150 wt % of CO₂ at room temperature and 50 atm; (b) operable to store at least 140 wt % of O₂ at room temperature and 110 atm; and (c) operable to store at least 80 wt % of CH₄ at room temperature and 100 atm.

The flexible porous polymeric carbon sorbent can include a polymer that has short range order and no long range order by powder X-ray diffraction (XRD).

The flexible porous polymeric carbon sorbent can include pores having an average pore size of between 2 Å and 100 Å.

The flexible porous polymeric carbon sorbent can include pores having an average pore size of between 5 Å and 20 Å.

The flexible porous polymeric carbon sorbent can be operable for storing more than 5.5 wt % of H₂ at room temperature and 100 atm.

The flexible porous polymeric carbon sorbent can be operable for storing more than 8 wt % of H₂ at room temperature and 100 atm.

The flexible porous polymeric carbon sorbent can be operable for storing more than 13 wt % of H₂ at room temperature and 200 atm.

The flexible porous polymeric carbon sorbent can be operable for storing more than 13 wt % of H₂ at room temperature and 300 atm.

The flexible porous polymeric carbon sorbent can be operable for storing more than 15 wt % of H₂ at room temperature and 300 atm.

The flexible porous polymeric carbon sorbent can be operable for storing about 20 wt % of H₂ at 100° C. and 100 atm.

The flexible porous polymeric carbon sorbent can be operable for storing more than 90 wt % of CH₄ at room temperature and 100 atm.

The flexible porous polymeric carbon sorbent can be operable for storing more than 150 wt % of CH₄ at room temperature and 200 atm.

The flexible porous polymeric carbon sorbent can be operable for storing more than 175 wt % of CH₄ at room temperature and 300 atm.

The flexible porous polymeric carbon sorbent can include nitrogen atoms.

In general, in another embodiment, the invention features a method that includes positioning a flexible porous polymeric carbon sorbent in a container that can contain a gas under pressure. The flexible porous polymeric carbon sorbent is operable for storing 4.5 wt % H₂ at room temperature and 100 atm. The method further includes storing gas in the container. The container can store more of the gas at room temperature and 100 atm than in the container without the flexible porous polymeric carbon sorbent at the same conditions.

Implementations of the invention can include one or more of the following features:

The flexible porous polymeric carbon sorbent can be independently: (a) operable to store at least 150 wt % of CO₂ at room temperature and 50 atm; (b) operable to store at least 140 wt % of O₂ at room temperature and 110 atm; and (c) operable to store at least 80 wt % of CH₄ at room temperature and 100 atm.

The flexible porous polymeric carbon sorbent can include a polymer that has short range order and no long range order by powder X-ray diffraction (XRD).

The flexible porous polymeric carbon sorbent can include pores having an average pore size of between 2 Å and 100 Å.

The flexible porous polymeric carbon sorbent can include pores having an average pore size of between 5 Å and 20 Å.

The flexible porous polymeric carbon sorbent can store more than 4.5 wt % H₂ at room temperature and at most 100 atm.

The flexible porous polymeric carbon sorbent can store more than 13 wt % H₂ at room temperature and at most 200 atm.

The flexible porous polymeric carbon sorbent can store more than 15 wt % H₂ at room temperature and at most 300 atm.

The flexible porous polymeric carbon sorbent can store at least 8 wt % of H₂ at room temperature and at most 100 atm.

The flexible porous polymeric carbon sorbent can store at least 10 wt % of H₂ at room temperature and at most 100 atm.

The flexible porous polymeric carbon sorbent can store more than 175 wt % of CH₄ at room temperature and at most 300 atm.

The flexible porous polymeric carbon sorbent can store more than 175 wt % of CH₄ at room temperature and at most 275 atm.

The flexible porous polymeric carbon sorbent can store more than 150 wt % of CH₄ at room temperature and at most 200 atm.

The flexible porous polymeric carbon sorbent can include nitrogen atoms.

In general, in another embodiment, the invention features a vehicle comprising an onboard hydrogen storage container. The container includes a flexible porous polymeric carbon sorbent. The container includes at least 4.5 wt % of H₂ at a pressure below 300 atm at room temperature.

Implementations of the invention can include one or more of the following features:

The container can include at least 4.5 wt % of H₂ at a pressure below 200 atm at room temperature.

The container can include at least 4.5 wt % of H₂ at a pressure below 100 atm at room temperature.

The container can include at least 5.5 wt % of H₂ at a pressure below 300 atm at room temperature.

The container can include at least 5.5 wt % of H₂ at a pressure below 200 atm at room temperature.

The container can include at least 5.5 wt % of H₂ at a pressure below 100 atm at room temperature.

The container can include at least 8 wt % of H₂ at a pressure below 300 atm at room temperature.

The container can include at least 8 wt % of H₂ at a pressure below 200 atm at room temperature.

The container can include at least 8 wt % of H₂ at a pressure below 100 atm at room temperature.

The container can include comprises at least 13 wt % of H₂ at a pressure below 300 atm at room temperature.

The container can include at least 13 wt % of H₂ at a pressure below 200 atm at room temperature.

The container can include at least 15 wt % of H₂ at a pressure below 300 atm at room temperature.

In general, in another embodiment, the invention features a method that includes selecting a flexible porous polymeric carbon sorbent. The flexible porous polymeric carbon sorbent is operable for storing 4.5 wt % H₂ at room temperature and 100 atm. The method further includes utilizing the flexible porous polymeric carbon sorbent to capture a gas.

Implementations of the invention can include one or more of the following features:

The gas can be selected from the group consisting of H₂, CO₂, O₂, methane, natural gas, and combinations thereof.

In general, in another embodiment, the invention features a method of synthesizing a porous polymeric carbon sorbent. The method includes the step of mixing a polymer with an additive to form a mixture. The polymer has a polymer chain order comprising long range order and short range order as detected by powder X-ray diffraction (XRD). The additive is an activation reagent that is selected from the group consisting of metal hydroxide, metal oxalate, metal acetate, metal acetylacetonoate, and mixtures thereof. The method further includes the step of heating the mixture to a temperature to form a porous polymeric carbon sorbent via chemical activation. The chemical activation results in a loss of the long range order and the short range order of the polymer as detected by powder XRD such that the porous polymeric carbon sorbent material is a rigid porous polymeric carbon sorbent. The porous polymeric carbon sorbent is operable for direct air capturing of at least 4 wt % of CO₂ at room temperature and 4 mbar partial pressure of CO₂ in air.

Implementations of the invention can include one or more of the following features:

The polymer can be selected from a group consisting of high density polyethylene (HDPE), low density polyethylene (LDPE), polypropylene (PP), and combinations thereof.

The polymer can be selected from a group consisting of polyvinyl chloride (PVC), nylon, melamine mixed with HDPE, melamine mixed with LDPE, melamine mixed with PP, melamine-formaldehyde resins, polyethylene imine (PEI), PEI mixed with HDPE, polyurethanes (PU), polyacrylonitrile, (PAN), and polyethyleneteraphthalte (PET) and mixtures therefrom.

The polymer can include a plastic from a waste plastic source.

The step of heating can be performed at a temperature that is between 550° C. and 700° C.

The step of heating can be performed at a temperature that is between 575° C. and 600° C.

The activation reagent can be an acetate salt of potassium or calcium.

The activation reagent can be potassium acetate.

The activation reagent can be calcium acetate.

The weight ratio of the additive and the polymer in the mixture can be between 0.5:1 and 5:1.

The weight ratio of the additive and the polymer in the mixture can be between 2:1 and 4:1.

The porous polymeric carbon sorbent can be operable for releasing the CO₂ direct air captured by heating the porous polymeric carbon sorbent to at most 200° C.

The porous polymeric carbon sorbent can be operable for releasing the CO₂ direct air captured by heating the porous polymeric carbon sorbent to at most 75° C.

The porous polymeric carbon sorbent can be operable for releasing the CO₂ direct air captured by heating the rigid porous polymeric carbon sorbent to at most 100° C.

The porous polymeric carbon sorbent can be operable for releasing the CO₂ direct air captured by removing the CO₂ with vacuum.

The polymer can include nitrogen atoms.

The porous polymeric carbon sorbent can be operable for direct air capturing of at least 6 wt % of CO₂ at 4 mbar partial pressure of CO₂ in air.

The porous polymeric carbon sorbent can be operable for releasing the CO₂ direct air captured by heating the rigid porous polymeric carbon sorbent to at most 110° C.

The porous polymeric carbon sorbent can be operable for releasing the CO₂ direct air captured by removing the CO₂ with vacuum.

The method can further include controlling pore size of the porous polymeric carbon sorbent by controlling pressure during the step of heating.

The step of heating the mixture can be performed at a near vacuum pressure of at least 0.01 bars.

In general, in another embodiment, the invention features a rigid porous polymeric carbon sorbent that is operable to direct air capture more than 4 wt % CO₂ at room temperature and 4 mbar partial pressure of CO₂ in air.

Implementations of the invention can include one or more of the following features:

The rigid porous polymeric carbon sorbent can include a polymer that has no polymeric long range order and no polymeric short range order detectable by powder X-ray diffraction (XRD).

The porous polymeric carbon sorbent can be operable for releasing the CO₂ direct air captured by heating the porous polymeric carbon sorbent to at most 200° C.

The porous polymeric carbon sorbent can be operable for releasing the CO₂ direct air captured by heating the porous polymeric carbon sorbent to at most 75° C.

The porous polymeric carbon sorbent can be operable for releasing the CO₂ direct air captured by heating the rigid porous polymeric carbon sorbent to at most 100° C.

The porous polymeric carbon sorbent can be operable for releasing the CO₂ direct air captured by removing the CO₂ with vacuum.

The porous polymeric carbon sorbent can include nitrogen atoms.

The porous polymeric carbon sorbent can be operable for direct air capturing of at least 6 wt % of CO₂ at 4 mbar partial pressure of CO₂ in air.

The porous polymeric carbon sorbent can be operable for releasing the CO₂ direct air captured by heating the rigid porous polymeric carbon sorbent to at most 110° C.

The porous polymeric carbon sorbent can be operable for releasing the CO₂ direct air captured by removing the CO₂ with vacuum.

In general, in another embodiment, the invention features a method that includes selecting a rigid porous polymeric carbon sorbent. The porous polymeric carbon sorbent is operable for direct air capturing of at least 4 wt % of CO₂ at room temperature and 4 mbar partial pressure of CO₂ in air. The method further includes utilizing the rigid porous polymeric carbon sorbent to direct air capture more than 4 wt % CO₂.

Implementations of the invention can include one or more of the following features:

The method can further include releasing the direct air captured CO₂ by heating the rigid porous polymeric carbon sorbent.

The CO₂ can be released by heating the rigid porous polymeric carbon sorbent to at most 200° C.

The CO₂ can be released by heating the rigid porous polymeric carbon sorbent to at most 75° C.

The CO₂ can be released by heating the rigid porous polymeric carbon sorbent to at most 100° C.

The method can further include releasing the direct air captured CO₂ by applying a vacuum to the rigid porous polymeric carbon sorbent.

The method can further comprising repeating the direct air capture and release of the CO₂ by the porous polymeric carbon sorbent for at least 1000 cycles.

The porous polymeric carbon sorbent can include nitrogen atoms.

The porous polymeric carbon sorbent can be operable for direct air capturing of at least 6 wt % of CO₂ at 4 mbar partial pressure of CO₂ in air.

The rigid porous polymeric carbon sorbent can be utilized to direct air capture more than 6 wt % CO₂ at 4 mbar partial pressure of CO₂ in air.

The method can further include releasing the direct air captured CO₂ by heating the rigid porous polymeric carbon sorbent.

The CO₂ can be released by heating the rigid porous polymeric carbon sorbent to at most 200° C.

The CO₂ can be released by heating the rigid porous polymeric carbon sorbent to at most 100° C.

The method can further include releasing the direct air captured CO₂ by applying a vacuum to the rigid porous polymeric carbon sorbent.

In general, another embodiment, the invention features a method of synthesizing a porous carbon material. The method includes mixing a plastic with an additive. The method further includes heating the plastic and the additive to a temperature in the range of 400° C. and 700° C. to form the porous carbon material.

Implementations of the invention can include one or more of the following features:

The plastic can be selected from a group consisting of HDPE, LDPE, PP, and combinations thereof.

The plastic can be selected from a group consisting of polyvinyl chloride (PVC), nylon.

The plastic can be a polymer that includes nitrogen atoms.

The polymer that includes nitrogen atoms can be a polymer selected from a group consisting of melamine mixed with HDPE, melamine mixed with LDPE, melamine mixed with PP, melamine mixed with other polymers, melamine-formaldehyde resins, urea, polyethylene imine (PEI), PEI mixed with HDPE, PEI mixed with other polymers, polyurethanes (PU), polyacrylonitrile, (PAN), and polyethyleneteraphthalte (PET).

The plastic can be from a mixture of plastic sources.

The plastic can be from at least one waste plastic source.

The plastic can be from plastic waste.

The plastic can be selected from a group consisting of plastics made from chain grow polymerization, vinyl polymerization, step growth polymerization, condensation polymerization, living polymerization, radical polymerization, cationic polymerization, anionic polymerization, synthetic polymers, naturally occurring polymers, and combinations thereof.

The additive can be potassium acetate.

The additive can be calcium acetate.

The additive can be selected from a group consisting of potassium hydroxide, potassium oxalate, potassium acetate, potassium acetylacetonoate, and mixtures thereof.

The additive can be selected from a group consisting of metal hydroxide, metal oxalate, metal acetate, metal acetylacetonoate, and mixtures thereof.

The metal can be selected from a group consisting of Groups 1A, 2A, and 3A of the Periodic Table, transitional metal, lanthanide, and actinide.

The metal can be an alkali-metal.

The metal can be lithium or cesium.

The additive can be a salt.

The weight ratio of the additive to the plastic can be between 0.5:1 and 5:1.

The weight ratio can be between 1:1 and 2:1.

The temperature of heating the plastic and the additive can be greater than about 550° C. The porous carbon material can be a mechanically rigid porous carbon material.

The temperature of heating the plastic and the additive can be at most about 550° C. The porous carbon material can be a mechanically flexible porous carbon material.

The temperature of heating the plastic and the additive can be at most about 500° C.

The temperature of heating the plastic and the additive can be at most about 550° C. The porous carbon material can be a flexible porous carbon material.

The temperature of heating the plastic and the additive can be at most about 500° C.

The diffraction bands in the X-ray diffraction analysis of the porous carbon material that are characteristic of the plastic can be remaining in the porous carbon material.

The method of any of any of the above-described methods can further include controlling pore size of the flexible porous carbon material by controlling the temperature and pressure of the method.

The method of any of the above-described methods can further include controlling pore size of the porous carbon material by controlling the temperature and pressure of the method.

In general, in another embodiment, the invention features a porous carbon material that is made according to the method of one or more of the above-described methods.

In general, in another embodiment, the invention features a porous carbon material that can capture more than 15 wt % CO₂ at about 25° C. and at 1 atm.

Implementations of the invention can include one or more of the following features:

The porous carbon material can release the CO₂ when heating the porous carbon material to less than 125° C.

The porous carbon material can release the CO₂ when heating the porous carbon material to less than 100° C.

The porous carbon material can release the CO₂ when heating the porous carbon material to about 70-75° C.

The porous carbon material of any of the above-described porous carbon materials and can be made according to any of the above-described methods.

The porous carbon material can capture more than 15 wt % CO₂ at about 25° C. and at a pressure less than 5 atm.

The porous carbon material can capture more than 18 wt % CO₂ at about 25° C. and at a pressure less than 5 atm.

The porous carbon material can capture more than 100 wt % CO₂ at about 25° C. and at a pressure less than 300 atm.

The porous carbon material can capture more than 100 wt % CO₂ at about 25° C. and at a pressure less than 50 atm.

The porous carbon material can capture up to 190 wt % CO₂ at about 25° C. and at a pressure less than 50 atm.

The porous carbon material can be any of the above-described porous carbon materials. The porous carbon material can be a flexible porous carbon material made by any of the above-described methods.

In general, in another embodiment, the invention features a method that includes selecting a porous carbon material selected from any of the above-described porous carbon materials. The method further includes utilizing the porous carbon material to capture more than 15 wt % CO₂.

Implementations of the invention can include one or more of the following features:

More than 15 wt % CO₂ can be captured at about 25° C. and at a pressure less than 5 atm.

More than 18 wt % CO₂ can be captured at about 25° C. and at a pressure less than 5 atm.

More than 25 wt % CO₂ can be captured at about 25° C. and at a pressure less than 5 atm.

More than 100 wt % CO₂ can be captured at about 25° C. and at a pressure less than 300 atm.

More than 100 wt % CO₂ can be captured at about 25° C. and at a pressure less than 50 atm.

More than 190 wt % CO₂ can be captured at about 25° C. and at a pressure less than 50 atm.

The CO₂ can be captured from flue gas.

The CO₂ can be captured from a post-combustion process.

The CO₂ can be captured from a pre-combustion process.

The pre-combustion process can include separation of the CO₂ from natural gas.

The CO₂ can be being selectively captured over the capture of N₂.

The porous carbon material can be made according to the method of one or more of the above-described methods.

The porous carbon material can be a flexible porous material.

The flexible porous carbon material can be made according to the method of one or more of the above-described methods.

In general, in another embodiment, the invention features a flexible porous carbon material made according to the method of one or more of the above-described methods. The flexible porous carbon materials has tunable pore sizes based upon the gas used, the temperature, the pressure, or a mixture of those conditions.

In general, in another embodiment, the invention features a porous carbon material that can capture O₂, methane, or natural gas at about 25° C. and at 100 atm.

Implementations of the invention can include one or more of the following features:

The porous carbon material can be a flexible porous material.

The flexible porous carbon material can be made according to the method of one or more of the above-described methods.

In general, in another embodiment, the invention features a storage container that includes a flexible porous carbon material. The storage container can store more H₂, O₂, methane, or natural gas at about 25° C. and about 100 atm to 300 atm than in the storage container without the flexible porous carbon material at the same conditions.

In general, in another embodiment, the invention features a method that includes feeding plastic bags into a chopper. The method further includes sheering the plastic bags in the chopper to produce flakes. The method further includes utilizing a sizing mesh to allow flakes below a pre-determined size to flow out of the chopper. The flakes that are above the pre-determined size remain in the chopper for further sheering. The method further includes gathering the flakes in a receptacle.

Implementations of the invention can include one or more of the following features:

The flakes can be utilized in a flash graphene process.

The flakes can be utilized in method to synthesize a porous carbon material.

### BRIEF DESCRIPTION OF THE DRAWINGS

FIG. 1A is a flow diagram of a generalized steam cracker process (known in the prior art) for ethylene production from natural gas and oil.

FIG. 1B is a flow diagram of a coal to olefin process (known in the prior art) for ethylene production from coal.

FIG. 2 is a scheme of the post-combustion process and the CO₂ capture unit.

FIG. 3 illustrates an embodiment of the present invention showing a one-step activation method of plastic waste to produce a solid sorbent with high CO₂ capacity at room temperature and pressure along with monomer and oligomer that can be recycled or used for other chemical applications.

FIG. 4 is the CO₂ sorption isotherm of activated polypropylene at 700° C. using potassium oxalate (2,1-A-PP-700) and potassium acetate (2,1-A-PP-700) at 2:1 base: plastic ratio.

FIG. 5A is the CO₂ sorption isotherms of HDPE activated at 500° C. (2,1-A-HDPE-500), 600° C. (2,1-A-HDPE-600), 700° C. (2,1-A-HDPE-700), 800° C. (2,1-A-HDPE-800) at 2:1 acetate: plastic ratio.

FIG. 5B is the CO₂ sorption isotherms of HDPE samples activated at different acetate:polymer ratio of 2:1 (2,1-A-HDPE-600), 1:1 (1,1-A-HDPE-600), and 1:2 (1,2-A-HDPE-600) all activated at 600° C.

FIG. 6A is nitrogen sorption isotherm for 2,1-A-HDPE-600 at 77 K.

FIG. 6B is the DFT-calculated pore size distribution for FIG. 6A.

FIG. 6C is the X-ray diffraction pattern of 2,1-A-HDPE-600 after washing with DI water.

FIG. 6D is survey scan XPS of 2,1-A-HDPE-600.

FIG. 6E is the high resolution XPS C1s spectrum of 2,1-A-HDPE-600.

FIGS. 7A-7C are ESEM images of 2,1-A-HDPE-600 showing the highly porous structure of the sorbent.

FIG. 8A is the XRD pattern of unwashed 2,1-A-HDPE-600 showing peaks characteristic of K₂CO₃ (stars).

FIG. 8B is the TGA of potassium acetate demonstrating mass losses consistent with proposed decomposition mechanism; an initial ˜10% mass reduction is due to dehydration of hygroscopic potassium acetate.

FIG. 8C is TGA profile of potassium acetate/HDPE (2:1) mixture showing the mass change and the rate of mass change as a function of temperature.

FIG. 9A is the CO₂ sorption isotherm LDPE and PP all activated at 600° C. and 2:1 ratio of potassium acetate to plastic.

FIG. 9B is CO₂ sorption isotherm of sorbent synthesized from a PP and HDPE mixture.

FIG. 9C is a CO₂ sorption isotherm of sorbent synthesized from wax activated at 600° C. and 2:1 various ratios of potassium acetate to wax.

FIG. 10A is the CO₂ and N₂ sorption isotherms of activated 2,1-HDPE-600.

FIG. 10B is a graph of the calculated ideal adsorbed solution theory (LAST) selectivity of 2,1-A-HDPE-600.

FIG. 11A is CO₂ sorption isotherm of 2,1-HDPE-600 at 25° C. and 20° C.

FIG. 11B is a graph of calculated isosteric heat of adsorption of 2,1-HDPE-600 showing an overall decrease of the heat of adsorption as the surface of the sorbent gets occupied by CO₂ molecules.

FIG. 11C is a graph of CO₂ release from the pores of 2,1-PP-600 after saturation as function of temperature showing full release of CO₂ at 70-75° C.

FIG. 11D is a graph showing 10-cycles of adsorption and desorption of 2,1-HDPE-600 showing high stability in performance over the cycles.

FIG. 11E is a graph of CO₂ release from the pores of 2,1-wax-600 and 4,1-wax 600 after saturation as function of temperature showing full release of CO₂ at 80° C.

FIG. 12A is the MS of the evolved gases during potassium acetate/HDPE (2:1) mixture pyrolysis at 600° C. showing ethylene formation as a gas.

FIG. 12B is the FTIR spectrum of the waxes formed as a byproduct of potassium acetate/HDPE (2:1) mixture pyrolysis at 600° C. showing typical hydrocarbon profile.

FIG. 13A is the CO₂ sorption isotherm of activated 2,1-HDPE-500 compared to 2,1-HDPE-600.

FIG. 13B is nitrogen sorption isotherm for 2,1-A-HDPE-500 at 77 K.

FIG. 13C is the DFT-calculated pore size distribution for FIG. 13B.

FIG. 13D is the XRD patterns of 2,1-HDPE-500 compared to and 2,1-HDPE-600 the starting HDPE after twin-screw blending with potassium acetate.

FIG. 13E is the FTIR spectra of the CO₂ captured within the pores of 2,1-HDPE-500 in a high pressure IR cell.

FIG. 14A is the CO₂ sorption isotherm of activated 2,1-HDPE-500 at 20° C., 25° C., 40° C., and 100° C.

FIG. 14B is CO₂ sorption isotherm of activated 2,1-HDPE-500 at different temperatures showing the change in density as the temperature and pressure increase.

FIG. 15 is a scheme of the scale-up reactor to get porous carbon and high value chemicals from plastic waste.

FIG. 16A is the hydrogen sorption isotherm 2,1-HDPE-500 at 25° C.

FIG. 16B is the hydrogen uptakes of 2,1-HDPE-500 when cycled 8 times where the uptake increases with each cycle as the sorbed water is purged out.

FIG. 16C is hydrogen uptakes at different temperatures at 100 bar, showing a sharp increase in hydrogen uptake at 96° C. to 100° C.

FIG. 16D is a hydrogen sorption isotherm of 2,1-HDPE-500 at 100° C.

FIG. 17 is methane and methane mixed gas sorption isotherm of 2,1-HDPE-500 at 25° C.

FIG. 18 is the oxygen sorption isotherm 2,1-HDPE-500 at 25° C. showing an uptake of 155 wt % at 125 bar.

FIG. 19 is a scheme of N-doping of mesoporous sorbent to get microporous carbon.

FIGS. 20A-20B are CO₂ sorption isotherms of N-doped sorbent at low and high pressure, respectively.

FIG. 20C shows CO₂ isotherm of NH₄⁺ exchanged 4,1-HDPE-600.

FIG. 21A is the TGA-DSC profile of 2,1-HDPE-500 showing a glass transition temperature around 96° C.

FIG. 21B is the CO₂ sorption isotherms of 2,1-HDPE pyrolized at 600° C. and 500° C.

FIG. 21C is the CO₂ sorption isotherms of 2,1-HDPE-500 and 2,1-HDPE-600,

FIG. 22 is the CO₂ sorption isotherm of 2,1-HDPE-500 after subjecting the sorbent to 0.01 bar and then 0.005 bar showing the catastrophic destruction of the material at this small pretreatment pressure declination.

FIG. 23 is a schematic of the pressure control manifold installed on the Rubotherm gravimetric uptake measurement system in order to monitor the precise pressure on the sample during the evacuation pre-treatment.

FIG. 24 is a digital picture of the actual pressure control manifold with valve labeling as installed on the Rubotherm gravimetric uptake system.

FIG. 25 is an alternative schematic for the pressure control manifold made of stainless steel.

FIG. 26 is an illustration of an embodiment of a system and method for converting plastic bags into flakes.

FIG. 27 is an illustration of a second embodiment of a system and method for converting plastic bags into flakes.

FIG. 28A is the CO2 isotherms of rigid sorbets synthesized at different potassium acetate/HDPE ratios.

FIG. 28B is the gravimetric and volumetric CO₂ isotherms of 4,1-HDPE-600 showing that the two are in close agreement.

FIG. 29A is the CO₂ uptake and change in pressure overtime of a rigid sorbet of the present invention demonstrating the fast kinetics of the uptake.

FIG. 29B is the CO₂ capacity change with time upon subjecting a rigid sorbet to CO₂.

FIG. 29C is the CO₂ and N₂ sorption isotherms for 4,1-HDPE-600.

FIG. 29D is the N₂ and N₂+CO₂ sorption isotherms for 4,1-HDPE-600.

FIG. 29E are ideal adsorbed solution theory (LAST) selectivity for 4,1-HDPE-600.

FIG. 30A is the TGA/DSC of HDPE and potassium acetate mixture showing weight loss and heat required to synthesize rigid sorbent of the present invention.

FIG. 30B is the heat loss and heat gain over time during the pyrolysis of HDPE+ acetate to synthesize rigid sorbent of the present invention.

FIG. 31A is the isosteric heat versus uptake of CO₂ for 4,1-HDPE-600.

FIG. 31B is the CO₂ capacity of 4,1-HDPE-600 upon the first, second, and third times.

FIG. 31C is the CO₂ capacity of 4,1-HDPE-600 upon cycling 110 times. The small decline occurs only because there was fast cycling in this test so complete CO₂ was not extracted between the runs.

FIG. 32 shows the change in the micropores (<1 nm in radius) percentage upon changing the potassium acetate/HDPE ratio.

FIG. 33 is the CO₂ isotherm of plastic obtained from mixed post-consumer waste plastic.

FIG. 34A is the CO₂ isotherm of sorbent activated with calcium acetate in replacement of potassium acetate.

FIG. 34B are XRD pattern of unwashed sorbent activated with calcium acetate.

FIG. 35 is the CO₂ isotherm of N-doped sorbent by the addition of polyethyleneimine.

FIGS. 36A-36B are, respectively, the survey XPS scan and high resolution N 1s XPS of the N-doped sorbent.

FIG. 37 are ideal sorbed solution theory (LAST) selectivity of the sorbent.

FIGS. 38A-38B are CO₂ sorption isotherm of 1,1-polyamic acid and 1,1-nylon acid, respectively.

FIG. 39 is isosteric heat of adsorption and regeneration temperature of the N-doped sorbent.

FIGS. 40A-40B are, respectively, the gravimetric and volumetric H₂ isotherm of 2,1-HDPE-500.

FIG. 41 is the H₂ isotherm of 2,1-HDPE-500.

FIG. 42 is CH₄ isotherm of 2,1-HDPE-500.

FIGS. 43A-43B are the H₂ isotherm of 2,1-HDPE-500 at room temperature.

FIGS. 43C-43D are the H₂ isotherm of 2,1-HDPE-500 at 100° C.

FIG. 44A is the CH₄ isotherm of 2,1-HDPE-500.

FIG. 44B is the O₂ isotherm of 2,1-HDPE-500.

FIG. 44C is the isotherm of 2,1-HDPE-500 for interchanged gases (CO₂, H₂, O₂, and CH₄).

FIGS. 45A-45B are the change in heat observed during H₂ cycling.

FIG. 46A is the methane CO₂ isotherm of different sorbent in very low pressure.

FIGS. 46B-46C are the CO₂ isotherm in very low pressure.

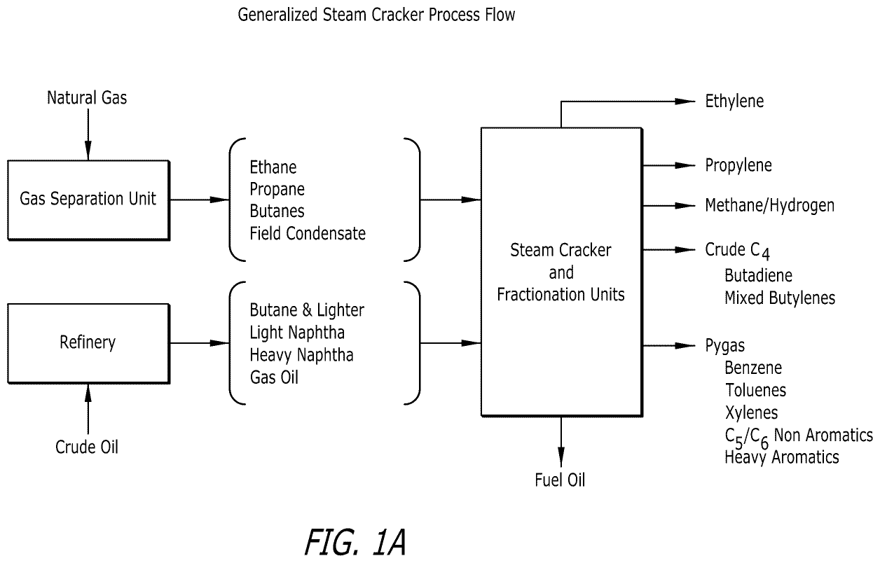

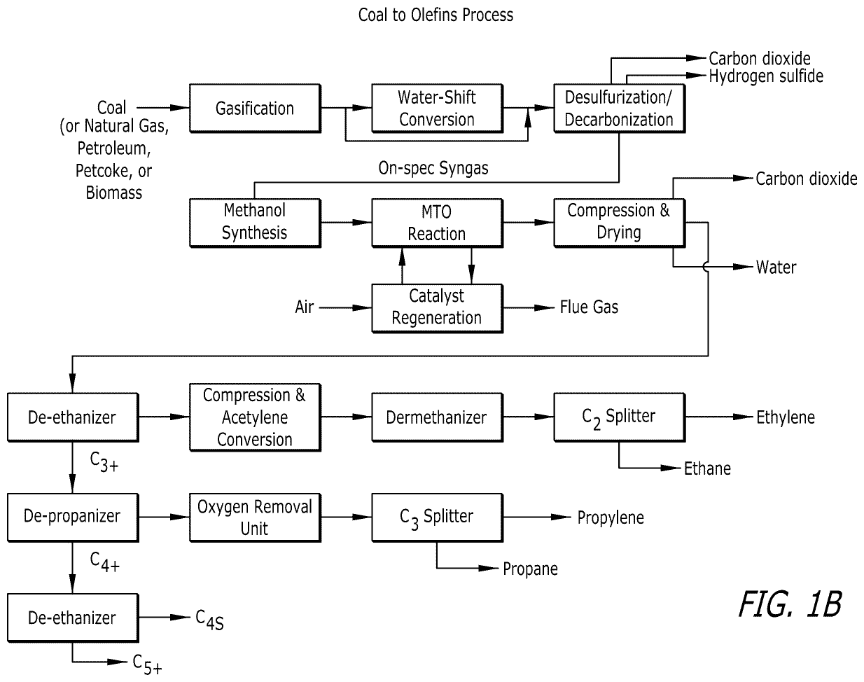

### DETAILED DESCRIPTION

The present invention relates to porous polymeric carbon sorbents for CO₂, H₂, and other gases and methods of making and using same. For instance, the present invention relates to a cost-effective way to process plastic waste (such as, for example, waste plastic milk jugs, which are high density polyethylene, HDPE) to produce value added chemicals and products that can capture >17 wt % CO₂ at room temperature and 1 atm. Such processes easily release the captured CO₂ at 70° C. and are reversible in this capture and release cycling.

### Synthesis Processes

Embodiments of the present invention encompass an alternative approach to plastic pyrolysis of the prior art, which alternative approach results in obtaining a porous carbon that has high CO₂ capture capacity. The developed approach also results in thermal cracking of the polymer, yielding the typical chemicals and fuels that are usually produced with the conventional pyrolysis including monomers and oligomers. The advantage of this technology over conventional pyrolysis, is the elimination of an unusable char by simply adding potassium acetate (or other metal salt, such as an alkali-metal salt) to the process. The process produces a high surface area carbonaceous residue that is an effective CO₂ sorbent. This addresses two enormous environmental issues, namely the reuse of waste plastics and the capture of post-combustion or pre-combustion CO₂ from a single new technological approach.

In embodiments of the present invention, thermal cracking of polymers and plastic waste is used to emit chemicals including monomers, oligomers and high surface porous carbon. While thermal cracking of plastic waste is known in the prior art, the prior art processes do not produce the porous carbon like obtained using embodiments of the present invention when cracking the plastic waste over potassium acetate and/or other potassium salt additives like potassium hydroxide, potassium oxalate, potassium acetylacetonoate, etc. In lieu of (or in addition to) such additives, the additives include other metal hydroxides, metal oxalates, metal acetates, metal acetylacetonoates, and mixtures thereof (including those in which the metal is one or more of Group 1A, 2A, and 3A from the periodic table, transitional metals, lanthanide, and actinide). A particular good one is calcium acetate.

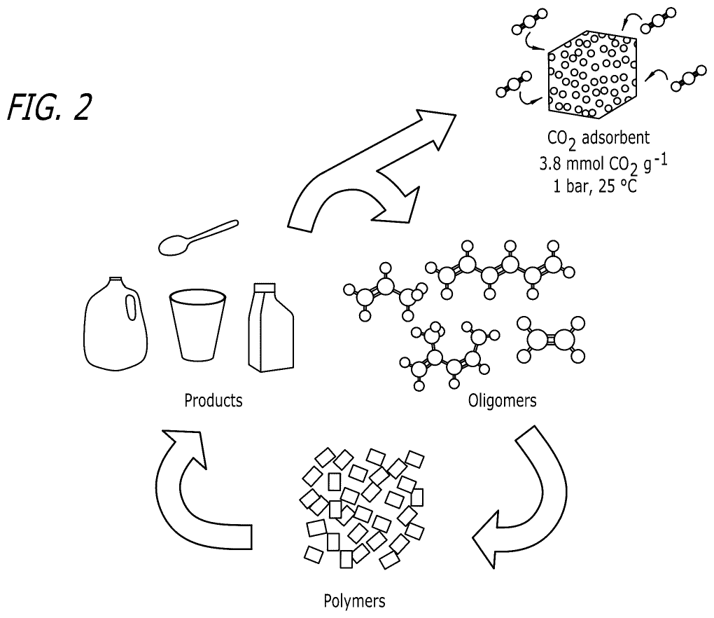

The porous carbon can be used as a CO₂ sorbent while it has a much higher sorbing affinity to CO₂ than to N₂, thus making it useful to even capture CO₂ from flue gas, such as the evolved CO₂ from a power plant stack (such as the scheme of the post-combustion process and CO₂ capture unit shown in FIG. 2) and from gases from other post-combustion CO₂ emission outlets. As used herein, the term “sorbing” includes physisorbing (noncovalent), chemisorbing (covalent), adsorbing (within), and absorbing (on the surface). The term “sorb” and “capture” are also used interchangeably herein. Here, “atm” is used interchangeably with “bar”. While other metal salts (such as alkali-metal salts and calcium acetate) can be utilized in the present invention, embodiments utilizing potassium salts will be described in more detail herein.

Since the cracking temperature is maintained below 700° C. (and typically below 600° C., and even more typically at or below 500° C.), the potassium in the additive (i.e., the potassium salt) does not reduce to potassium metal. So, there is little, if any, risk of generating H₂ gas with ignition upon washing with water to remove the remaining additive after the cracking process. Hence, this has an additional benefit of lessening production costs.

In embodiments of the present invention the same porous carbon generated via the process can also sorb H₂ gas. A goal is to make a material that is both dense (i.e., density ˜1 g/cc) and can sorb 5.5 wt % H₂ at room temperature and 100 atm of pressure. In this invention, the carbon materials have a density greater than 1.5 g/cc and even 1.7 g/cc. So unlike an aerogel which is too low density and therefore voluminous to be easily used in mobile tanks, the carbon material here, though porous, is high density so low in overall volume. The material porous carbon made using embodiments of the present invention captures ˜7 wt % to 8 wt % H₂ at room temperature and 100 atm and ˜15 wt % at room temperature and 300 atm, and oddly ˜20 wt % H₂ at 100° C. and 100 atm. This is counterintuitive since most materials capture less gas at higher temperature. But this goes back to the interesting behavior of the materials of the present invention, as described and discussed below. The 5.5 wt % is an essential goal set by the US Department of Energy to make hydrogen fuel cell vehicles widely available. Presently they can only use H₂ tanks that are 5000-10,000 psi (340-680 atm) to provide the range needed in a car. But those tanks are spherical to handle the high pressures, and therefore hard to fit in vehicles, and considered dangerous. If H₂ is liquefied, the density is low and 30% of the energy content is lost in the liquefaction process. So to be able to store H₂ at 100 atm (1470 psi) is a huge advance since light weight composite tanks can be used. Although the results here can be advantageous even up to 300 atm where the H₂ storage starts to saturate at ˜13 wt %.

Moreover, embodiments of the present invention shows that the properties of the resultant material can be tunable by simply controlling the activation temperature or the pressure or a combination of both temperature and pressure. For example, a porous carbon obtained by activating high density polyethylene (HDPE plastic at ˜475-500° C. shows properties that are similar to porous polymers (rather than porous carbons) where they are mechanically flexible in that the pores can vary in sizes depending upon the pressure and temperature used during the sorption process. This allows the polymer to tune its pore sizes for a particular gas at a particular pressure and temperature. So at 500° C., the material has both the properties of a porous carbon and the properties of a porous polymer. If however, a higher temperature is utilized (such as ˜575-600° C.), the resulting materials is stiff, rather than flexible.

Further embodiments include sorbing of other gases, such as O₂ and methane. O₂ sorbing can be very useful in that if one can add even obtain 20% more O₂ to a compressed cylinder, at the same pressure, then it would enormously reduce the price of O₂ gas cylinder deliveries. But since this material can be flexible like a polymer, it can sorb most any gas since it can accommodate variable size molecules due to its mechanical flexibility. The sorption of methane has also been seen with the flexible porous polymer here, and that could increase the amount of methane that can be contained in a methane or natural gas tank. Again, lowering cost of deliver per amount of gas in the cylinder and making the use of natural gas more attractive for vehicular (car and truck) and maritime (boat and ship) use.

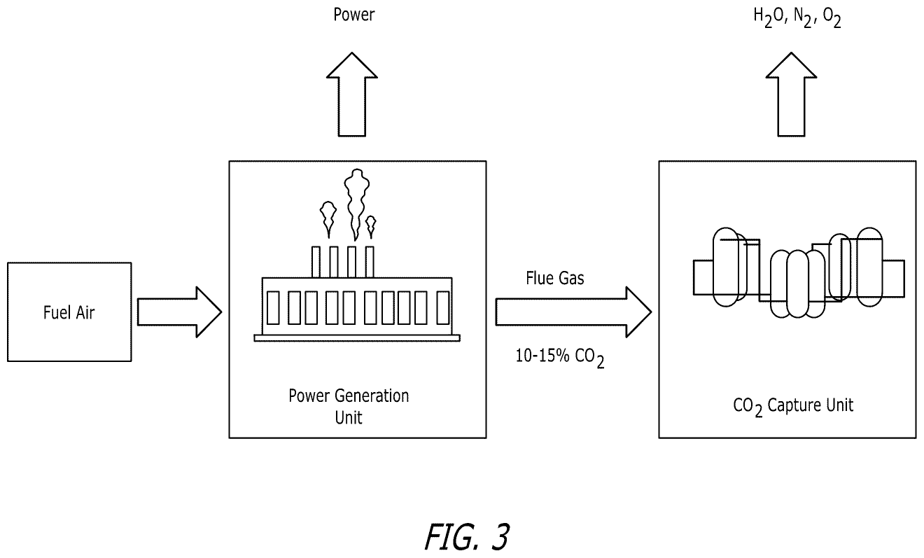

Embodiment of the present invention encompass a one-step activation method of plastic waste to produce a solid sorbent with high CO₂ capacity at room temperature and pressure along with monomer and oligomer that can be recycled or used for other chemical applications. See FIG. 3. The CO₂ capacity of sorbent can go up to 17 wt % (3.8 mmol/g) at 25° C. and 1 bar. The process is green and relies on the mild decomposition of potassium acetate (or other potassium additives, or calcium acetate), which is a nontoxic activation reagent. The sorbent can be synthesized at 475° C.-600° C. via pyrolysis of plastic waste such as HDPE (such as bottle waste), LDPE (such as plastic bag waste) and PP (polypropylene), (low density polypropylene and polypropylene) to get a highly porous sorbent with surface area of 930 m²/g.

The ability to synthesize sorbent <700° C. eliminates the possibility of potassium metal formation, making the scale up of this process highly attractive since there is no formation of potassium metal at these temperatures. The nature of the sorbent can be manipulated by changing the activation temperature. For example, activating at around 600° C. can yield a rigid porous carbon while activating below 550° C., and more preferably 475 to 500° C., can yield an sorbent with porous polymer-like properties. TG-MS data of the evolved gases during the synthesis of the sorbent showed that the predominant product in the gas phase is propylene and ethylene, which are monomers that can potentially be used to synthesize fresh plastics. The synthesized sorbent has a selectivity of CO₂ over N₂ of 230 at 0.1 bar, and the sorbent is stable upon cycling. The sorbent has low heat of sorption, making it possible to regenerate at 70 to 75° C. using waste heat from power plants and refineries. In comparison, one of the dominant technologies used today for CO₂ capture at 1 bar is aqueous amine towers. These trap 13 wt %, they are corrosive, require a large footprint, and they need to be heated to 120-140° C. to yield the CO₂. Moreover, since aqueous amine towers have a high heat capacity (water), the amount of energy needed to heat them to 120-140° C. is exceedingly high.

Porous sorbents were prepared by carbonization of plastic waste (polyolefins) at below 700° C. under inert atmosphere (such as argon or nitrogen) in the presence of activation reagents. High density polyethylene (HDPE) was utilized. It was found that the same conditions can be used to activate plastic cups (PP) and plastic bags (LDPE), the latter being one of the most challenging materials to recycle and is one of the main sources of microplastics after polyethylene terephthalate (PET). Samples were named so that the first two numbers represent the activation reagent to polymer ratio followed by the plastic type and the numbers after the plastic type represents the activation temperature. I.e., “2-1-A-HDPE-500” represents a 2:1 activation reagent to polymer ratio, “A” for thermally activated, a plastic type of HDPE, and an activation temperature of 500° C. In some cases the “A” is not used since “activation” can be understood in the context here.

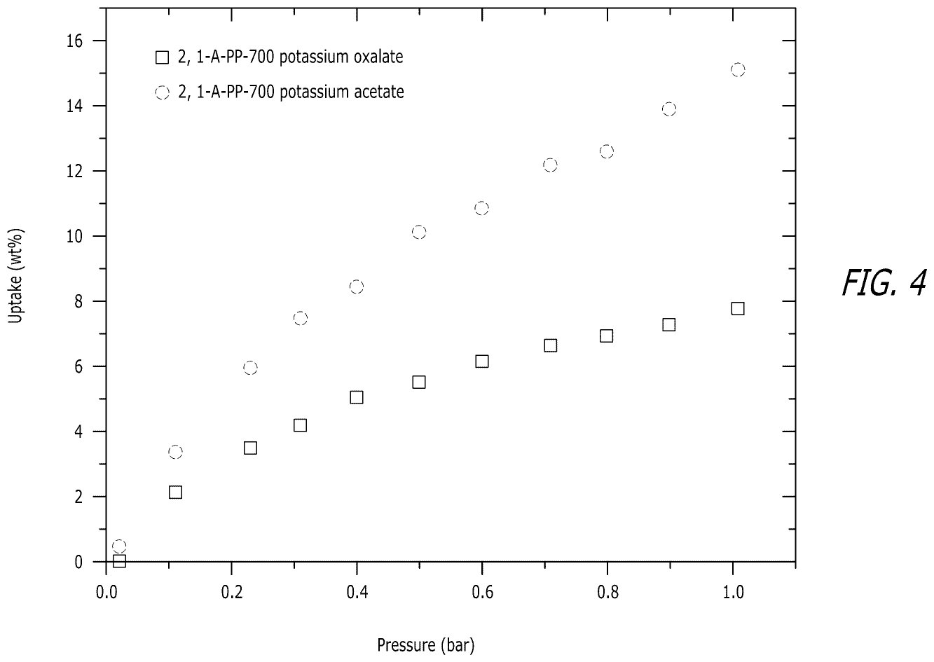

Different activation agents can be utilized, including potassium hydroxide, potassium oxalate, potassium acetate, and calcium acetate. See FIG. 4. It was found that, in some embodiments, activating with potassium acetate can yield the most effective sorbent with a CO₂-capacity as high as 17 wt % at 1 bar and 25° C. (Generally, potassium acetate is more effective at making porous carbon with high CO₂ capacity than potassium oxalate).

This adsorption capacity surpasses amine scrubbing which has 13 wt % CO₂-capacity at 1 bar at 25° C. While KOH is commonly reported in literature as an effective activation reagent for high surface area porous carbon synthesis [He 2016; Otowa 1997]; it is corrosive, hard to handle in large quantities and can have detrimental human health effects. The utilization of potassium acetate or calcium acetate as an activation reagent in embodiments of the present invention is highly advantageous because potassium acetate is a greener and nontoxic activation reagent and calcium salts are green and even less toxic that most other metal salts. In fact, potassium acetate is commonly used as food additive as acidity regulator and flavor enhancer.

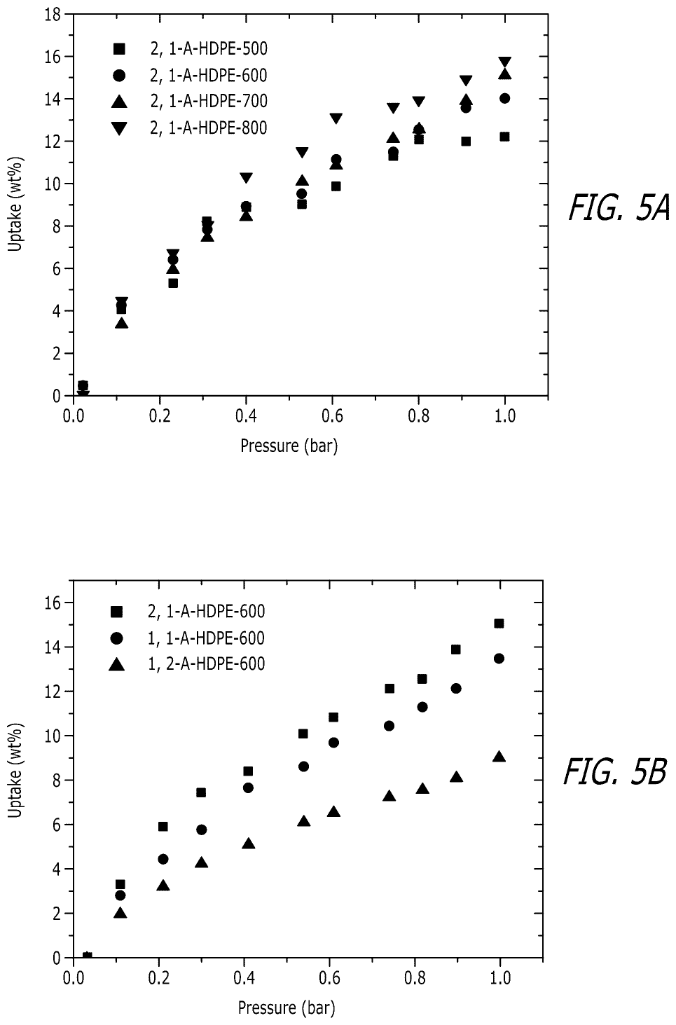

Synthesis was carried at different temperatures (FIG. 5A) and various salt: plastic ratios (FIG. 5B) to find that a good sorbent can be synthesized at temperatures as low as 500° C. The activation method for this synthesis process require much lower synthesis temperature than other reported synthesis methods that require activation at 700° C.-900° C. [Zhu 2014]. The ability to synthesize sorbents at such low temperatures eliminates the risk of potassium metal formation, thereby mitigating one of the biggest risks associated with scaling up such activation methods. Also, the utilization of lower activation temperature of the polymer lowers the overall cost of the synthesis. The CO₂ uptake and synthesis conditions were analyzed carefully to find the plastic is treated at 600° C. with salt. In this embodiment, a plastic ratio of 2:1 was the most attractive sorbent commercially with a CO₂ capacity of 16% at 1 bar and 25° C.

In exemplar methods of the present invention, plastic waste was chemically activated using potassium acetate. 8 grams of plastic cups and milk bottles were cut into small 2 cm² pieces and the plastic mixture was processed at 160° C.-180° C. in a Brabender melt mixer (model type 808-400-DTI). Once melted, potassium acetate was added to the polymer melt at salt: plastic weight ratio of 0.5-2. After adding potassium acetate to the polymer melt, the mixture was mixed in the Brabender at 50 RPM for 15 min to form a homogenous blend. The mixture was cool before transferring the polymer-based mixture to a ceramic boat and heating in a tube furnace at rate of 20° C./min under argon atmosphere. Once the targeted temperature was reached, the temperature was held for 50 min to obtain 6 grams of product. The mixture was washed with DI water to obtain 0.8 g of porous carbon. While heating, the polymer was observed to crack and some liquids distilled out into the cool region of the tube. These are the volatile fractions that have ancillary commercial value in the pyrolysis.

### Structural and Chemical Properties

The structural and chemical properties of the synthesized sorbent is presented in TABLE I.

TABLE I
Structural and chemical properties of the porous carbon
obtained via chemical activation of HDPE waste

| | |
|---|---|
| Surface area | Composition |

| Sample name | (m²/g) | O | C |
|---|---|---|---|
| 2,1-A-HDPE-500 | 355 | NA | NA |
| 2,1-A-HDPE-600 | 950 | 21 | 79 |
| 2,1-A-HDPE-700 | 604 | 17 | 83 |
| 2,1-A-HDPE-800 | 590 | 11 | 98 |
| 1,1-A-HDPE-600 | 433 | 19 | 81 |
| 1,2-A-HDPE-600 | 334 | 15 | 85 |

The Brunauer-Emmett-Teller (BET) surface area were characterized via N₂ physisorption analysis at 87 K. The results show that the surface area and total pore volume decrease as temperature increase indicating a collapse in the pore structure as temperature increase (TABLE I). Pore size distribution was studied via DFT theory to find that sorbents activated 600° C. have pores diameter of 10, 25 and 30 Å. Samples activated at higher temperatures have larger pore diameter that could go up to 100 Å. While larger pore diameter is favorable for high pressure CO₂ capture, narrow pore diameter is better for CO₂ capture at 1 bar.

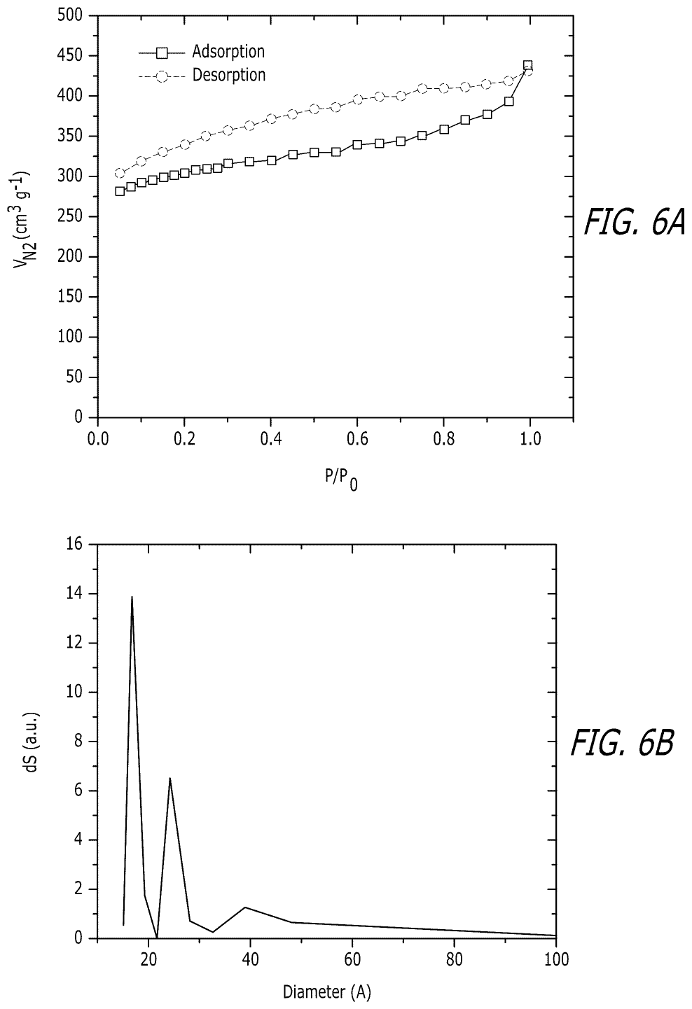

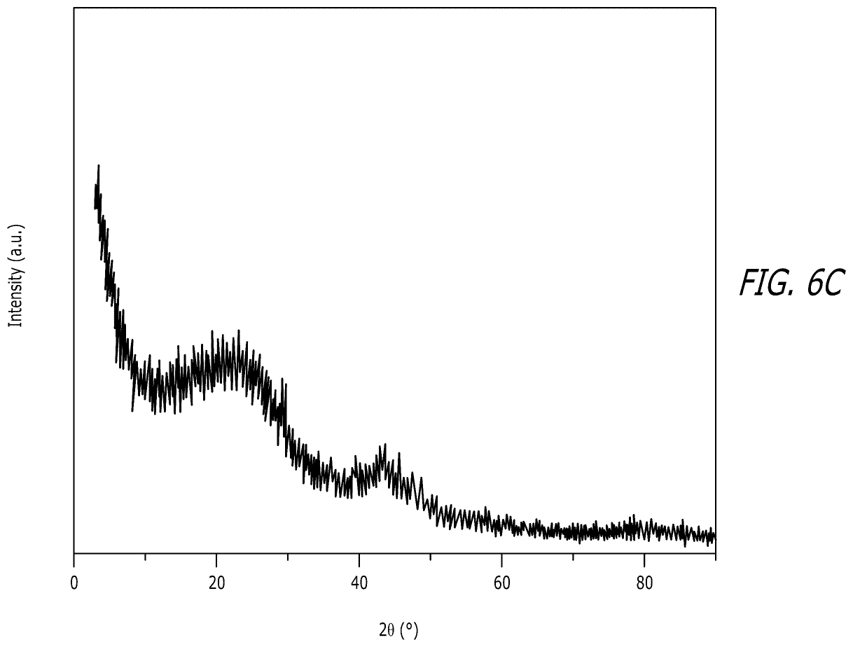

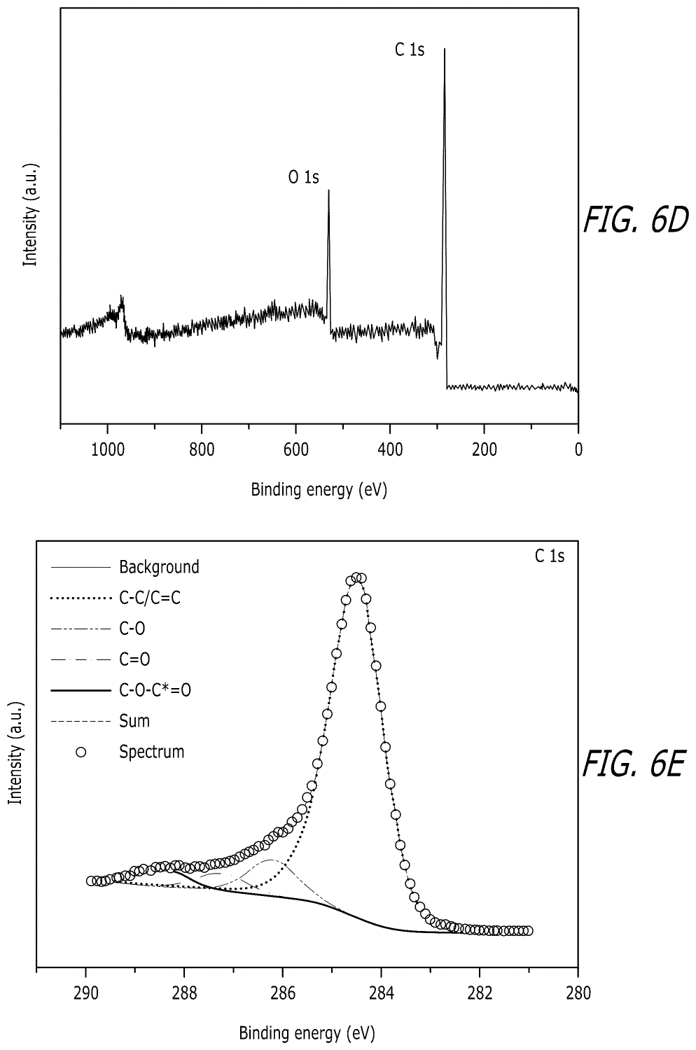

FIGS. 6A-6E a show the N₂ sorption isotherm for 2,1-HDPE-600 showing a surface area of 950 m²g⁻¹. Moreover, adding less than 2 equivalent potassium acetate to the polymer mixture was shown to yield sorbents with lower surface area and total pore volume, which is expected since higher amount of activation reagent leads to higher porosity and thus, higher surface area. XRD patterns of the sorbent showed broad signals with no sharp lines, indicating the amorphous nature of the sorbent. The elemental composition of the sorbent was studied using XPS. The oxygen content was observed to decrease as the synthesis temperature increased, which was expected since a higher degree of carbonization is obtained at higher temperatures. High resolution XPS and survey scan of 2,1-HDPE-600 (FIG. 6D-6E) showed 01s and C1s signals with 10% 0 and 89% C. Detailed analysis of the 0 type is shown in FIG. 6E.

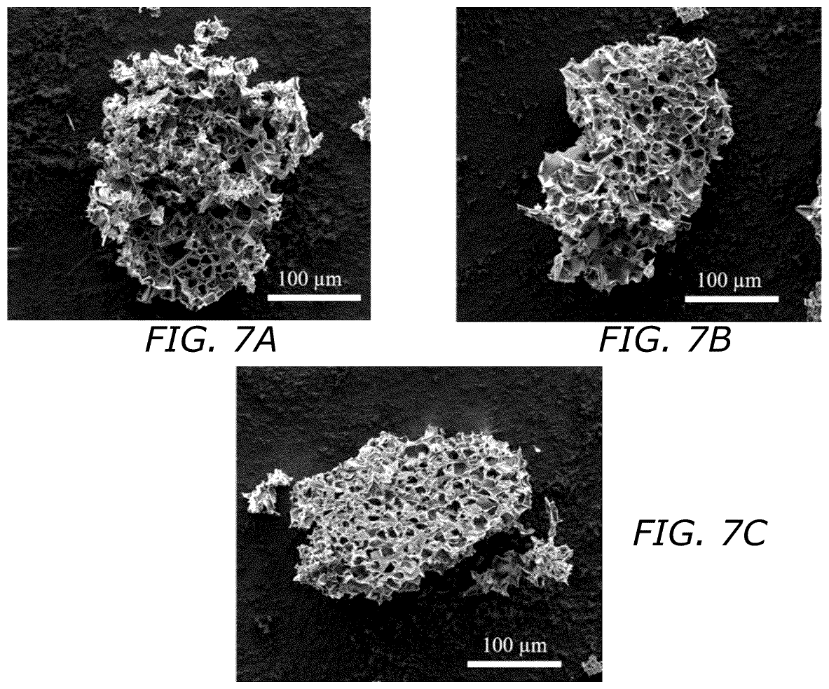

The morphology of the sorbent was studied using environmental scanning electron microscope (ESEM). FIGS. 7A-7C show ESEM images of 2,1-A-HDPE-600 with pores and pockets throughout the material. Due to the mild decomposition of potassium acetate, the sorbent exhibited a porous structure; this highly porous morphology differs from other reported carbon sorbents, which are characterized by their structural irregularity. [Sevilla 2018]. The average particle size was found to be around 250 μm. It is worth noting that activation at higher temperatures yield an sorbent with sheet-like morphology. This might be due to the formation of potassium metal at elevated temperature (>700° C.), which induces the formation of the sheet-like morphology.

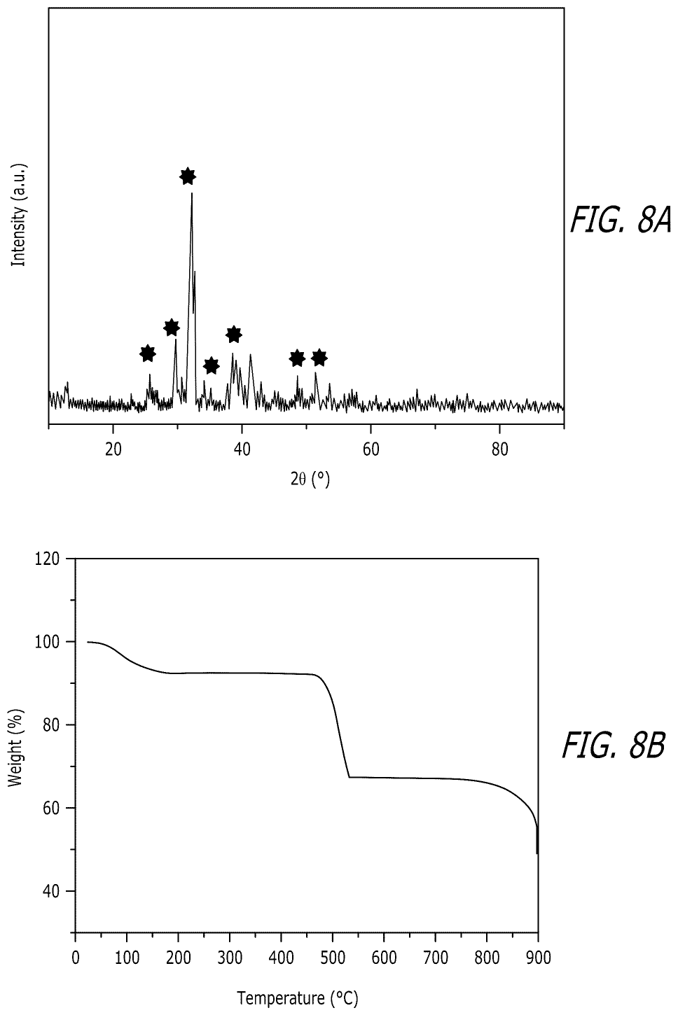

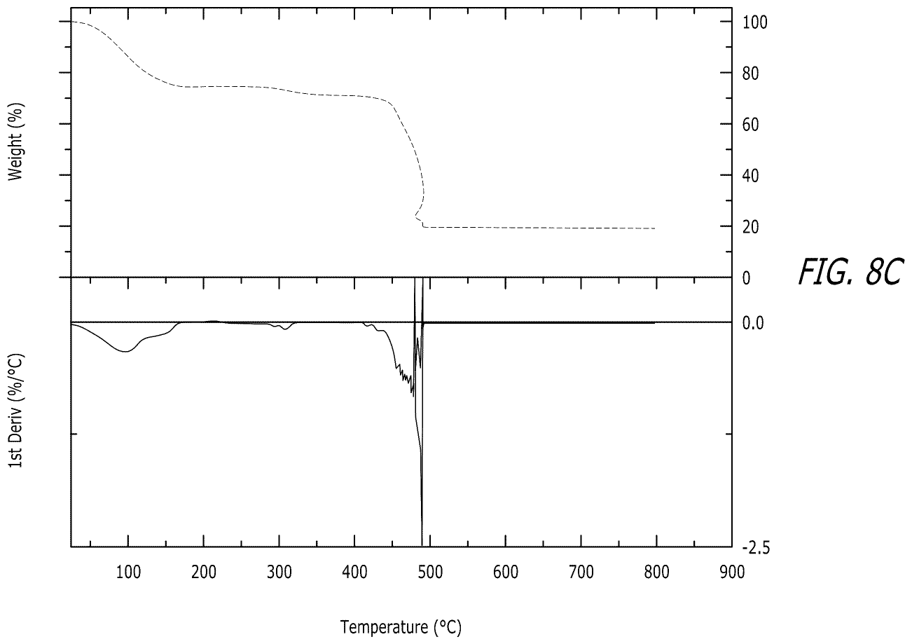

XRD and TGA were utilized to study the activation mechanism of the sorbent. XRD of the unwashed sorbent after synthesis at 600° C. indicates the formation of potassium carbonate (FIG. 8A). This suggests that from −450° C. to 520° C., potassium acetate decomposes into K₂CO₃ and acetone [Cheng 2014], a process which results in ˜30% weight loss due to acetone volatilization as shown in the TGA profile of potassium acetate (FIG. 8B).

2CH₃COO⁻K⁺→K₂CO₃+CH₃COCH₃↑T=˜450-520° C. (1)

At 400° C., while some of the polymer decomposes to monomers, the carbon material is oxidized, and the formed CO is subsequently oxidized to generate CO₂ and H₂ gas (2-3).

C+H₂O→CO+H₂↑T=˜400° C.-460° C. (2)

CO+H₂O→CO₂+H₂↑T=˜400° C.-460° C. (3)

This process occurs from −400° C.-460° C. in the carbon material (FIG. 8C). Potassium metal is formed by reduction of K₂CO₃ by carbon above 700° C. (4). That is something that we avoid in our process to minimize the risks of working with potassium metal which flame on contact with water.

K₂CO₃+2C→2K+3CO T>700° C. (4)

Therefore, synthesizing an sorbent at temperatures lower 700° C. is highly advantageous because it eliminate the risk forming potassium metal, (potassium is flammable and can even be explosive upon contact with air or water), which is one of the biggest challenges standing before commercializing the synthesis of porous carbon. Moreover, the use of potassium acetate instead of potassium hydroxide as an activation reagent is advantageous because potassium acetate is non-corrosive. Unlike potassium hydroxide, potassium acetate is easy to handle and will not cause continuous corrosion in the scale-up rector. Moreover, the use of potassium acetate is environmentally favorable because it is non-toxicity and the byproduct of the activation reaction is potassium carbonate, which is non-toxic, too, making it simple to deal with the waste product of this reaction.

### Varying Plastic Waste Types

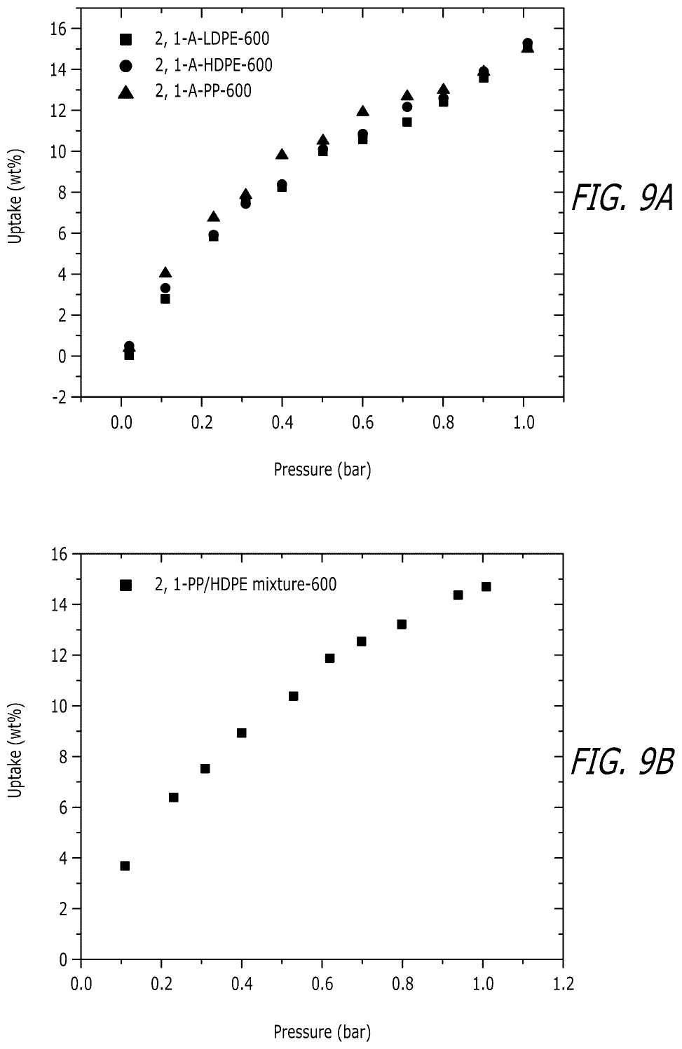

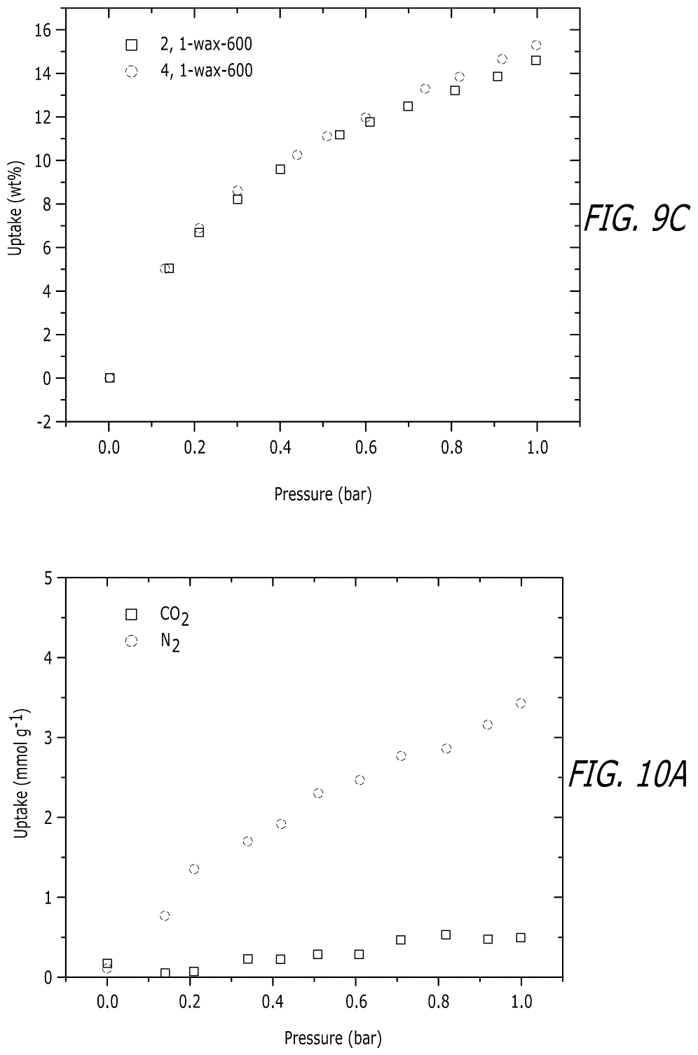

Embodiments of the present invention (and its method of activation) can utilize different plastic types, including LDPE and PP (see FIG. 9A), which LDPE and PP are commonly used in plastic bags and plastic cups, respectively. Due to the softness and stretchiness of LDPE, it is known to be one of the most problematic waste types making it is hard to handle and recycle, which embodiments of the present invention offer solutions to. Moreover, different plastic waste products (PP, HDPE, LDPE) were mixed, melted, and activated together to yield an sorbent with a CO₂ capacity of 15 wt % (FIG. 9B) indicating the possibility of single streaming waste product into one pot. Thus, embodiments of the present invention can eliminate the necessary separation and sorting steps present in conventional recycling.

As shown in FIG. 9C, waxes can be activated just like plastic.

### Sorbent Selectivity and Heat of Sorbtion

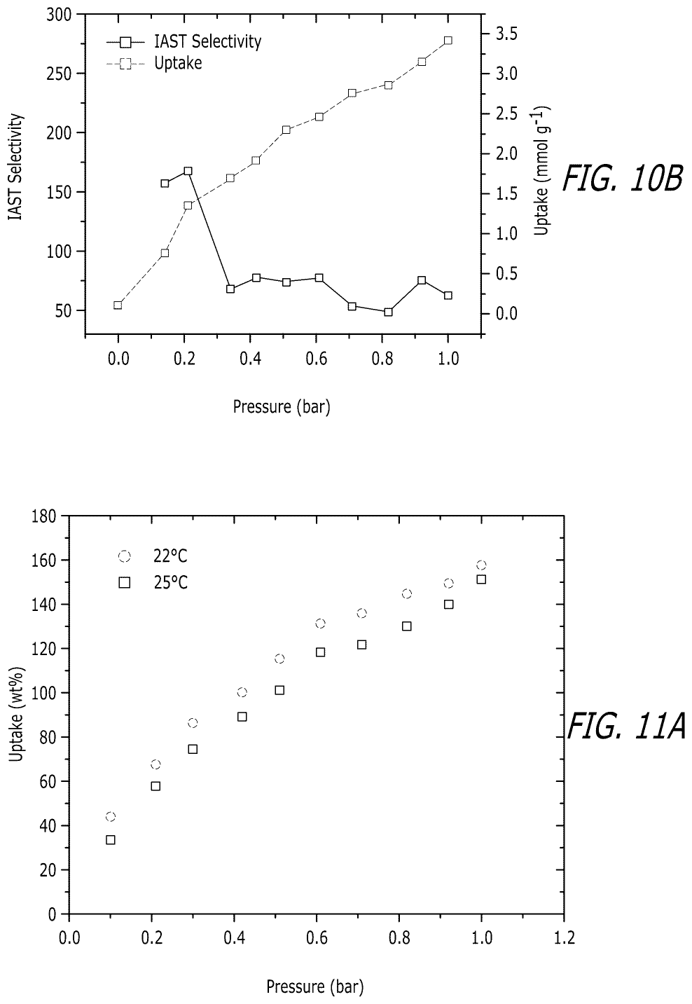

Post-combustion streams are made of around 10% CO₂ and 90% N₂. Therefore, selectivity is an important parameter for sorbent quality. FIG. 10A shows sorption isotherm of 2,1-HDPE-600 CO₂ and N₂ with far more CO₂ capacity than N₂ capacity. Ideal sorbed solution theory (LAST) was used to calculate the selectivity of the sorbent (eq. 2).

$${S}_{IAST} = ( \frac{{n}_{{CO}_{2}}}{{n}_{{N}_{2}}} ) / ( \frac{{P}_{{CO}_{2}}}{{P}_{{N}_{2}}} ) , \qquad ( eq . 2 )$$

where,
S_{IAST} is the selectivity,
n_{CO}_{₂} is the number of moles sorbent uptakes of CO₂ without the presence nitrogen,
n_{N}_{₂} is the number of moles of nitrogen in the sorbent without the presence of nitrogen, and
P_{CO}_{₂} and P_{N}_{₂} is the partial pressure of CO₂ and N₂, respectively, in the desired stream. [Myers 1965].

The LAST selectivity of the sorbent was found to be 150 at 0.1 bar and 58 at 1 bar (FIG. 10B). Since the partial pressure of CO₂ is 0.1 bar in post-combustion steams, the selectivity at low partial pressure is important when designing an sorbent for flue gas CO₂ capture. The selectivity at low pressure is high and comparable to the selectivity of metal organic frameworks (MOFs) and zeolites.

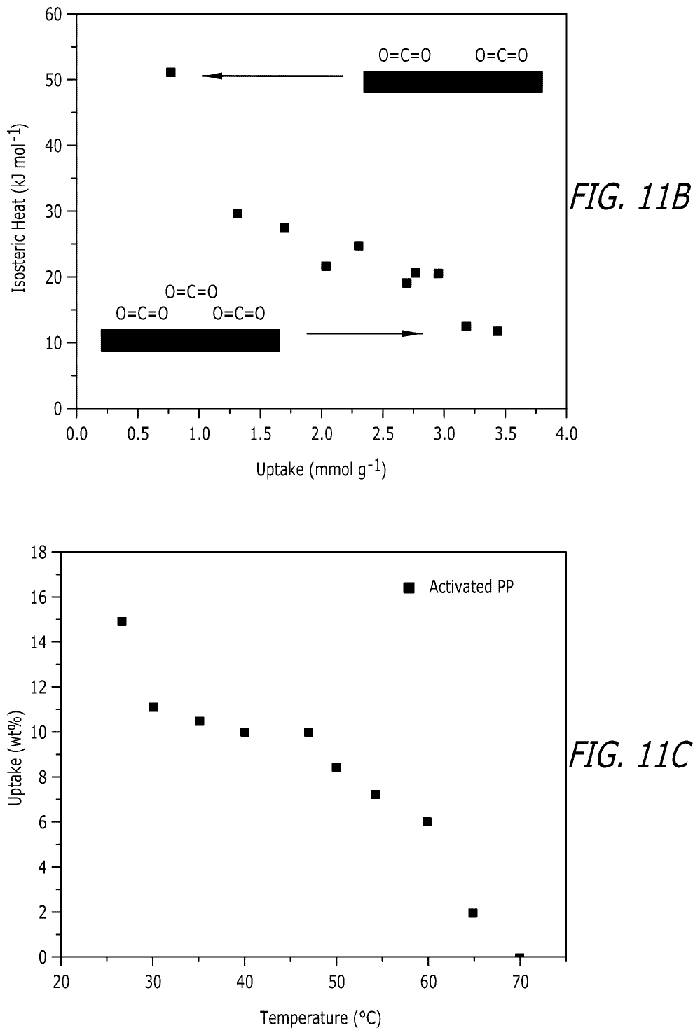

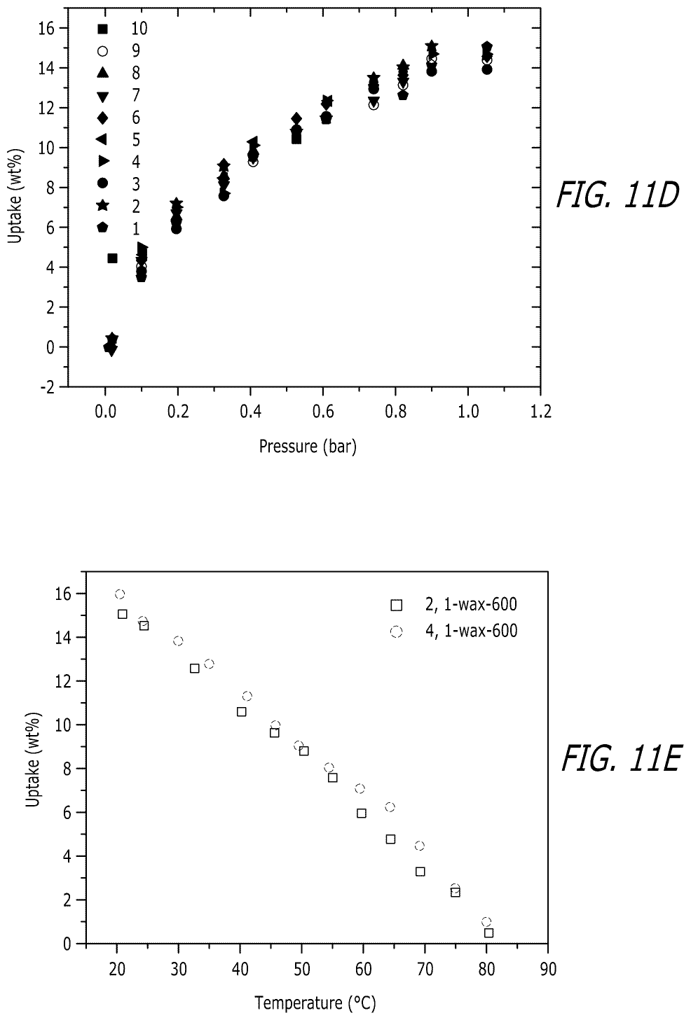

To understand the nature of interactions between the CO₂ gas and the sorbent, isosteric heat of absorption (Qₛₜ) was calculated using Clausius-Clapeyron equation (eq.3) using the isotherms collected at 20° C. and 25° C. (FIG. 11A).

$$ln P = \frac{- {Q}_{s t}}{R △ T} , \qquad ( eq . 3 )$$

where,
P is the pressure of the sorbate,
T is the temperature at which the adsorption took place, and
R is the universal gas constant.

The sorbent has a maximum heat of adsorption of 51 kJ/mol (FIG. 11B), which is a typical heat of adsorption obtained from weak physical interactions. This heat of adsorption is well below that of MOF and zeolites, which usually have heat of adsorptions at 50 kJ/mol and 90 kJ/mol, respectively. [Modak 2019]. The unique nature of interactions between the sorbent and the CO₂ allows the regeneration of the sorbent by subjecting the sorbent to vacuum or heating the sorbent to 70° C. to release trapped CO₂ from the pores as shown in FIG. 11C. This indicated that sorbent regeneration can be easily achieved using waste heat in power plants and refineries at 70-75° C. Moreover, the sorbent is stable upon cycling (FIG. 11D); 10 adsorption cycles were tested and no loss in the CO₂ capacity was observed.

FIG. 11E shows that sorbent made by activating waxes can also be regenerated by releasing the trapped CO₂ from the pores at around 80° C.

Byproducts of Reaction when Making the Carbon Materials.

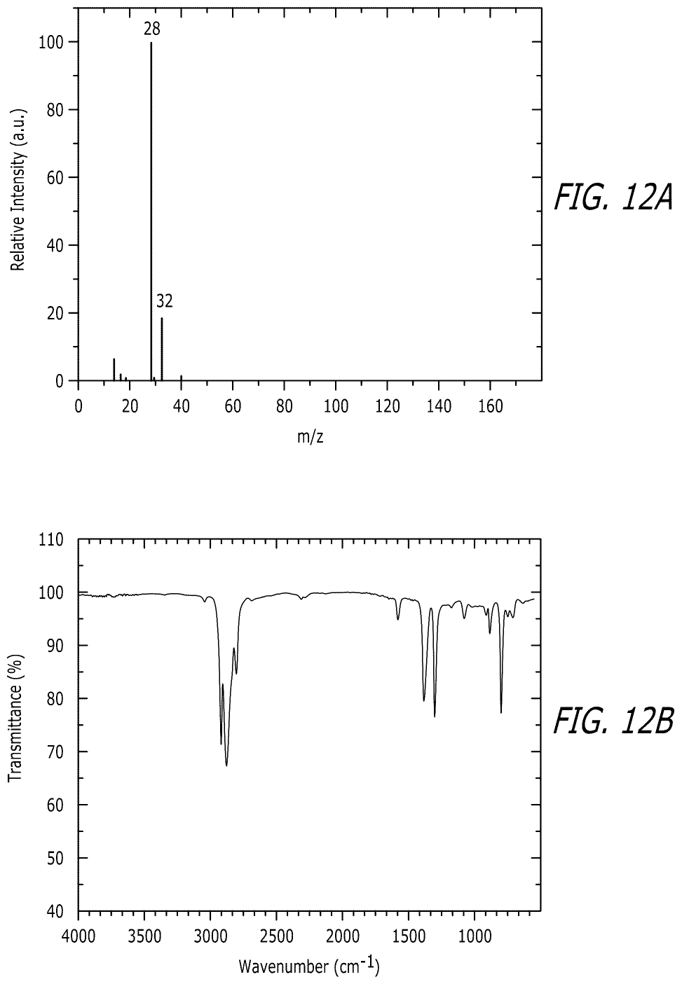

The prior art shows the feasibility of cracking plastic waste over zeolites or bentonite clay to get liquid fuels and an ash that has no significant use. [Budsaereechai 2019; Kumar 2011]. The activation process disclosed and taught herein allows one to produce monomers as a gas and oligomers as solid, waxy or oily deposits in the cool regions of the furnace without the generation of the undesirable ash that is usually obtained in conventional methods of plastic pyrolysis. FIG. 12A shows TG-MS of the evolved gases of HDPE/potassium acetate mixture with the highest abundance signal obtained from the ethylene (m/z=28) monomers, which could be polymerized to fresh HDPE polymer. Also, the TG-MS of FIG. 12A shows small traces of methanol (m/z=32), indicating partial oxidation of the carbon in the presence of potassium acetate to yield methanol. FIG. 12B shows FTIR spectrum of waxy deposits showing a typical hydrocarbon spectrum.

Ethylene can be reacted with other chemical feedstocks to produce polyvinyl chloride, polystyrene, and polyester resin. Therefore, the demand of ethylene is high worldwide. Currently, large-scale production of ethylene is carried in steam cracker where naphtha and paraffin hydrocarbon are pyrolyzed in the presence of steam. The temperatures in a typical steam cracker that could reach 850° C. and the yield of ethylene is only 30% ethylene when naphtha is cracked at high severity. While the demand for ethylene increases every year, ethylene trade is limited due to challenges in transporting and refrigerating ethylene. The pyrolysis method disclosed and taught herein is simple and allows for ethylene production on site using plastic waste, making ethylene production not limited to large petrochemicals companies. The beauty of this process is what can be done with the remaining carbon when it is mixed with an additive that will make the carbon porous while remaining flexible in desired cases.

### Synthesis Conditions and Characterization of the Sorbent for Gas Storage at High Pressure

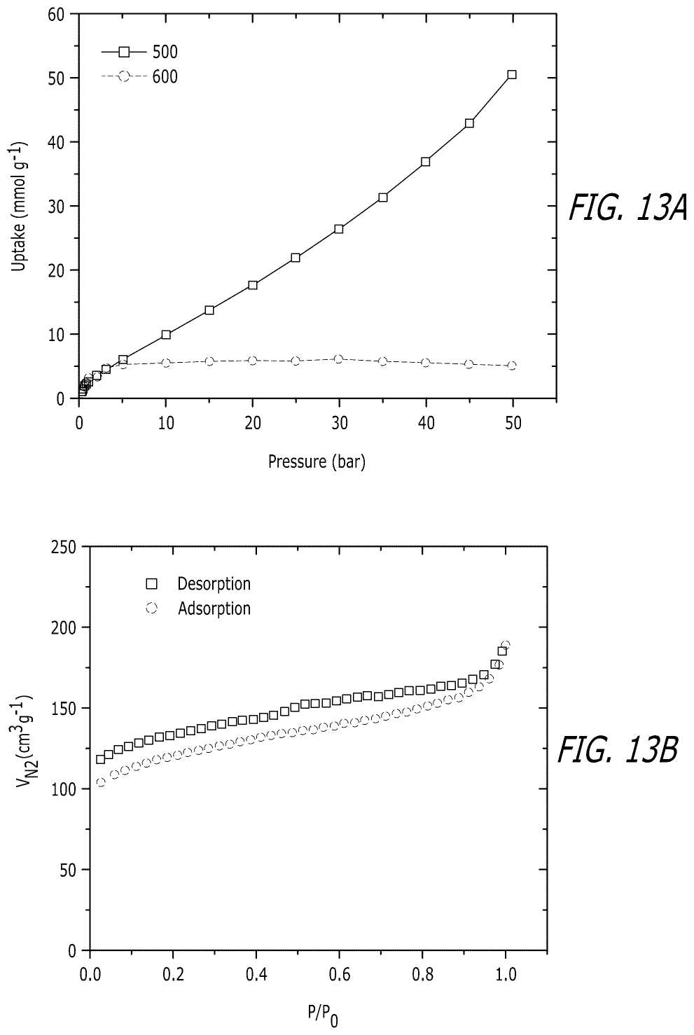

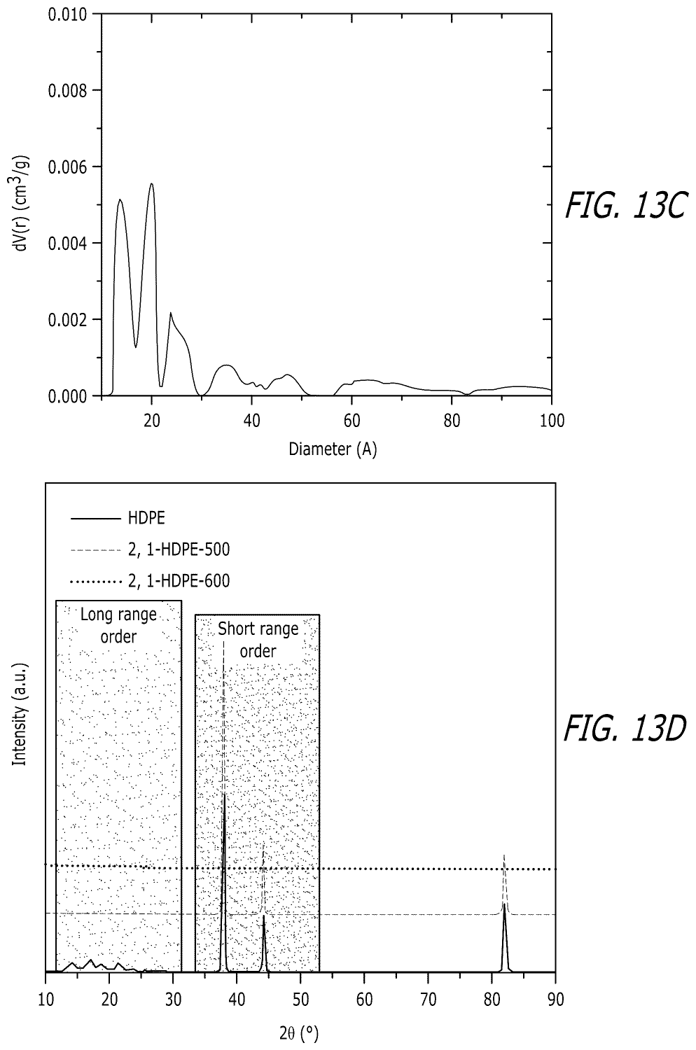

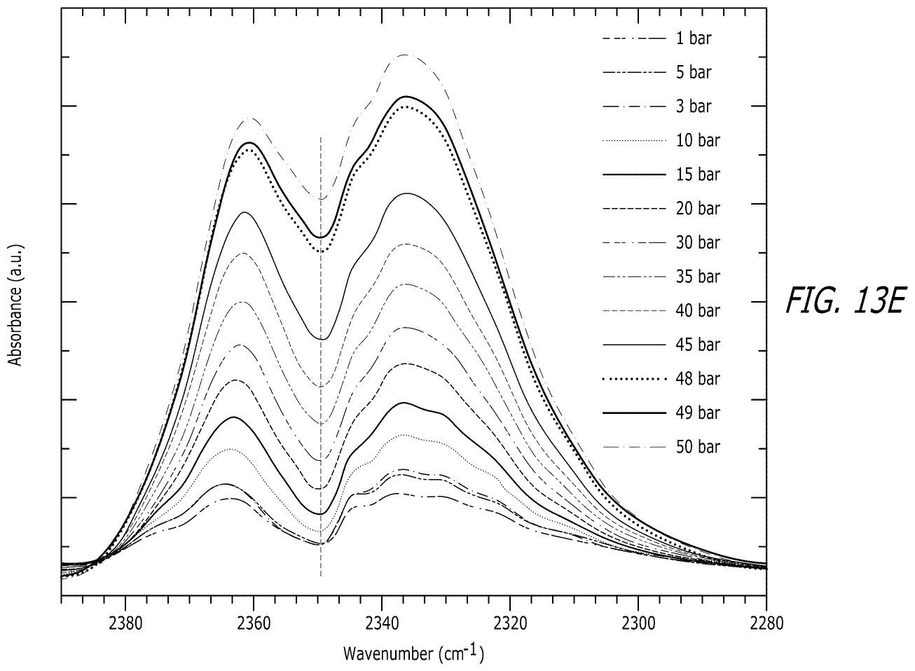

While activating plastic waste at 600° C. yields rigid porous carbon that is attractive for CO₂ capture at low pressure, it was found that activating the plastic waste at temperatures around 500° C. yields carbon materials that behave like a metal organic framework (MOF) and porous polymers. FIG. 13A shows CO₂ sorption profiles of a sorbent activated at 500° C. and 600° C. The sample activated at 500° C. shows extremely high capacities at high pressures. The sample activated at 600° C. showed an uptake of ˜4 mmol/g of CO₂, which is around 18 wt %. The BET surface area of the sorbent was ˜355 m²/g with wide distribution of pores ranging from micropores to mesopores (FIGS. 13B-13C). FIG. 13D shows XRD of 2,1-HDPE-500 shows sharp signals at 40° indicating short-range order due to the presence of plastic domains within the amorphous carbon region. If the heating is performed at 600° C., all short range order is lost. It is suggested that this preservation of short range order that affords a flexible nature to the pores of this material. Without the short range order, we have not seen this flexible polymer-like behavior from these porous carbons. In-situ FTIR analysis of the pore filling process from 1-50 bar indicates that the captured CO₂ is in gas phase within the pores (FIG. 13E). As shown in FIG. 13D, upon heating to 500° C., the short range order of the polymer remains while the long range order is lost. Upon heating to 600° C., all of the original polymer chain ordering has been lost. This underscores the dramatic difference between the flexible and the rigid carbon materials made at these two different temperatures.

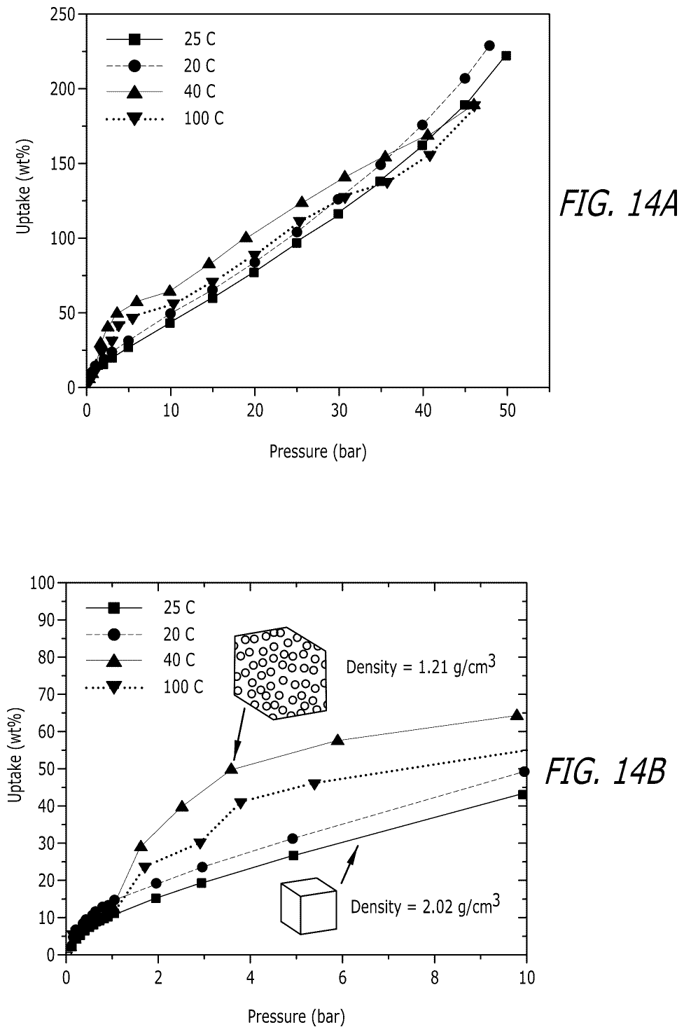

The CO₂ sorption process was evaluated at different temperatures and it was found that high temperatures increased the CO₂ uptakes at lower pressure, as shown in FIG. 14A. Moreover, it was found that the density of the materials decreased as temperature increased, which could be due to the expansion of the pores of the sorbent (FIG. 14B). The densities are greater than 1 g/cc and have been seen to be 1.7 g/cc by density measurements in liquid standards.

### Scale-Up

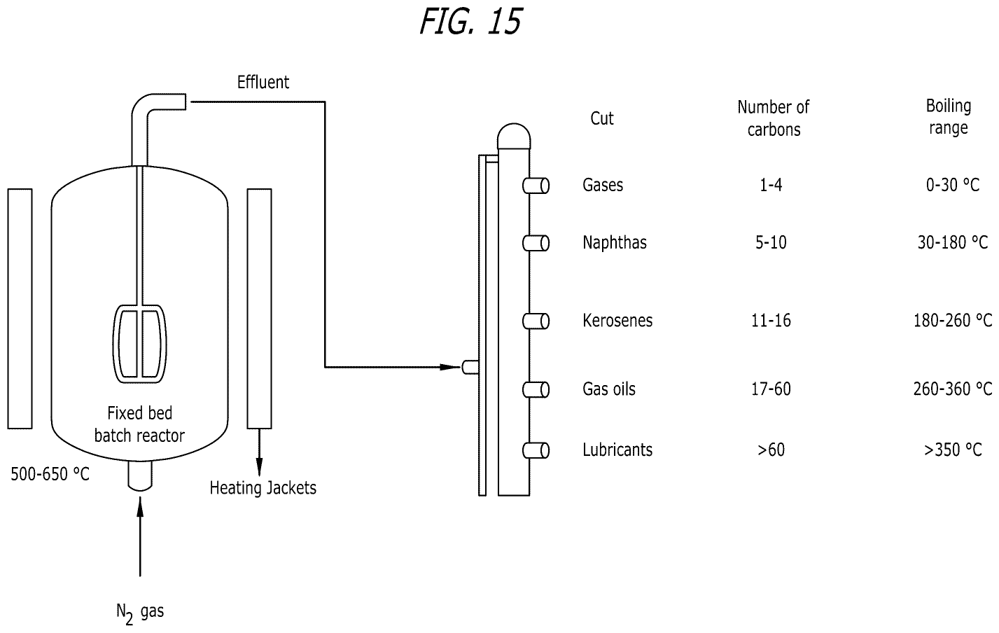

The scale up of the synthesis process was considered. FIG. 15 shows a simplified scale-up design of the synthesis processes described herein, in which a fixed bed batch reactor is utilized to mix and pyrolyze the plastic waste with potassium acetate to get the porous carbon. The evolved gases can go to a distillation unit for separating the effluent's components to get petrochemicals of high value at low cost.

As the synthesis process disclosed and taught herein involve synthesis of high surface area sorbent at 475-600° C., this eliminate the risk of forming undesired materials, such as potassium metal. For instance, in embodiments of the present invention, potassium acetate can be utilized. Potassium acetate is non-toxic and cheap as compared to potassium, which is corrosive and has determine health effects.

### Uses

Embodiments of the present invention can be used as a technology for chemical recycling of plastics via thermal cracking of plastic wastes to get oligomers, monomers and porous sorbent. Furthermore, the resultant sorbent has properties, such as the high porosity and electrical conductivity, which can be utilized.

Batteries/Cathodes

The porous carbon obtained from the processes described herein is a good CO₂ sorbent and has high capacity when used as a anode or cathode for batteries.

Hydrogen Storage

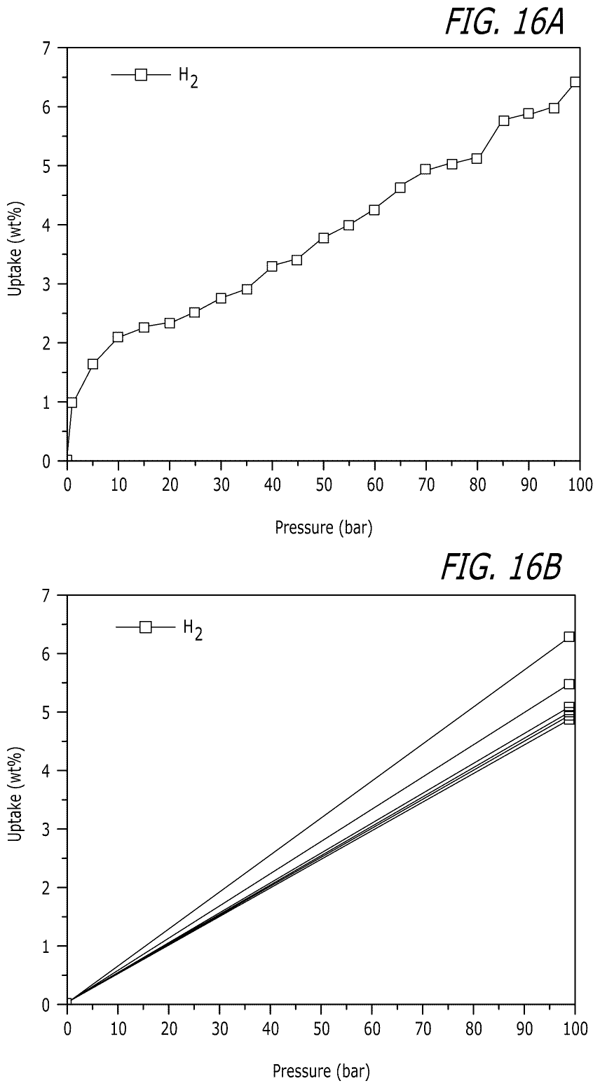

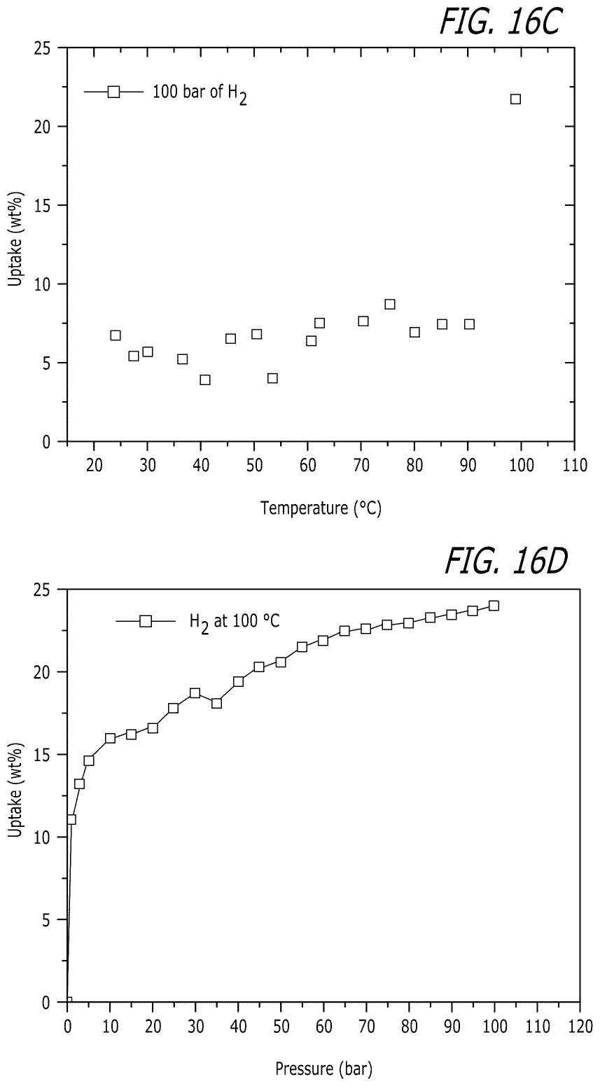

The porous carbon can be utilized for hydrogen storage. The low activation temperature of 2,1-HDPE-500 allows for the formation of micropores that are ideal for hydrogen storage at 100 bar. FIG. 16A shows hydrogen sorption isotherm of 2,1-HDPE with a capacity that can go up to 6.7 wt %, which is greater than 5.5 wt % at 100 bar, which is a Department of Energy target for such uses. Moreover, when the sorbent was allowed 15 minutes contact time with hydrogen, the uptakes were ranging from 3.4-6.5 wt % when cycled 8 times (FIG. 16B). FIG. 16C shows temperature depended uptakes at 100 bar to find that the uptake increases significantly at 100° C. FIG. 16D shows the hydrogen sorption profile of 2,1-HDPE-500 collected at 100° C. Interestingly, when one seeks to fill a tank containing a good sorbent, the heat release upon gas binding to the sorbent heats the system, therefore restricting the rate at which the gas can enter the tank because higher temperature lowers usually sorption capacity. But here, on the contrary, at 100° C., there is a marked increase in H₂ uptake (FIG. 16C). Therefore, heat release upon sorption of H₂ can actually increase the efficiency of uptake with these materials. This is a highly unusual property that can be exceedingly advantageous during gas refilling.

Methane and Mix Gases Storage

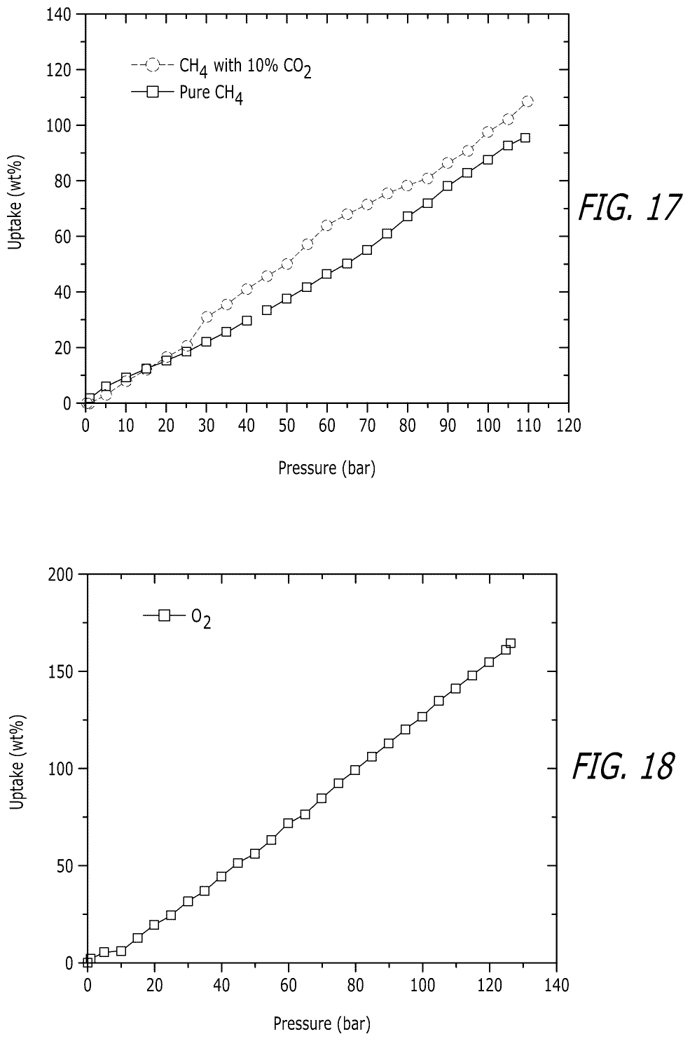

As show in FIG. 17 (methane and methane mixed gas sorption isotherm of 2,1-HDPE-500 at 25° C.), the flexible sorbent showed high storage capacity for methane. The observed capacity is around ˜100 wt % making this sorbent superb for methane and natural gas storage in tanks and operated vehicles.

Oxygen Storage Tanks

The flexible sorbent shows high oxygen capacity reaching an uptake of 155 wt % oxygen at 125 bars as shown in FIG. 18. This makes the sorbent ideal for increasing the storage capacity per tank and decreasing the overall shipping cost of oxygen to medical facilities and homes. Moreover, adding the sorbent to the oxygen tank can be utilized as a safety mechanism, because the oxygen desorption is endothermic, which minimize the chance of explosion in case of accidental release.

### N-Doped Materials

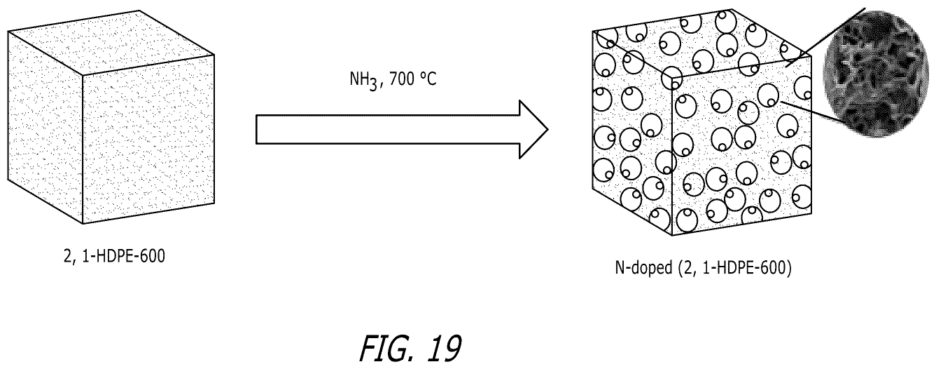

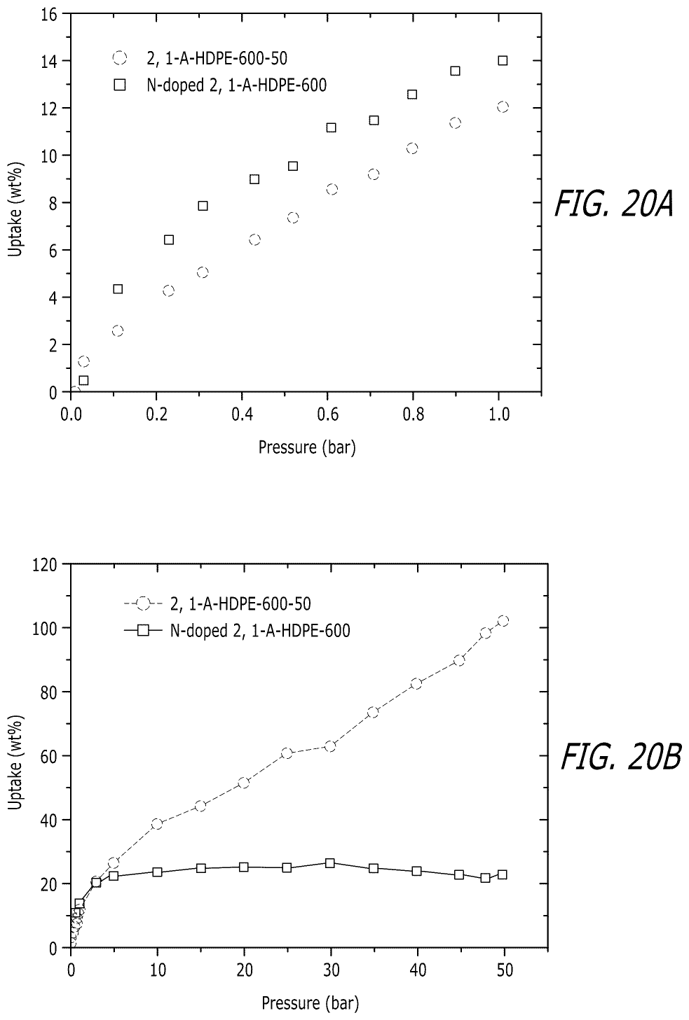

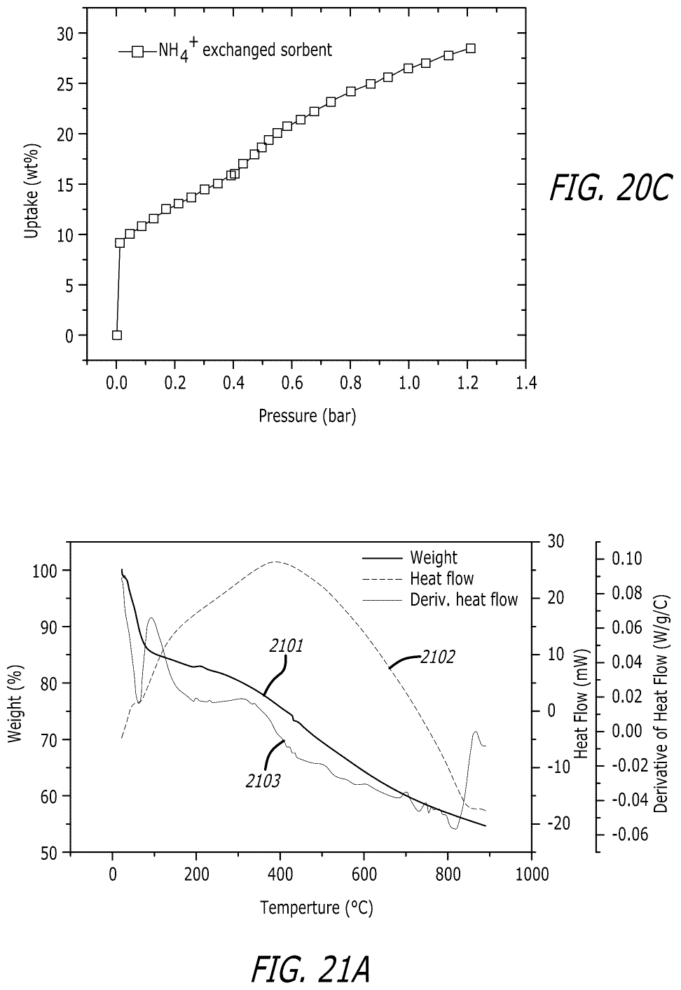

The sorbent described herein can be nitrogen-doped (N-doped) for further uses. FIG. 19 shows a scheme for N-doping a mesoporous sorbent to get microporous carbon. The sorbent was N-doped by heating the sample up to 700° C. in an ammonia atmosphere (which yielded a rigid sorbent). While the uptake at low pressure decreased due to converting some of the micropores to mesopores as shown in FIG. 19, the uptake at high pressure increased from to 25 wt % to 700 wt % at 30 bars and 25° C. FIGS. 20A-20B show CO₂ sorption isotherm of N-doped sorbent at low and high pressure, respectively. The nitrogen containing material, need a higher temperature, however, to remove the CO₂, generally exceeding 100° C. Other ways to have nitrogen in these is to use nitrogen-containing polymers such as PET or nylons or polyurethanes, or mixtures of polyethylene and polyethylene imine. Or, the applicants can treat the rigid polymer made at 600° C. as described above with a combination of aqueous ammonium hydroxide and HCl or ammonium chloride at room temperature then drying. CO₂ uptakes can be obtained at room temperature and 1 atm as high as 27 wt % CO₂. See FIG. 20C.

### Flexibility

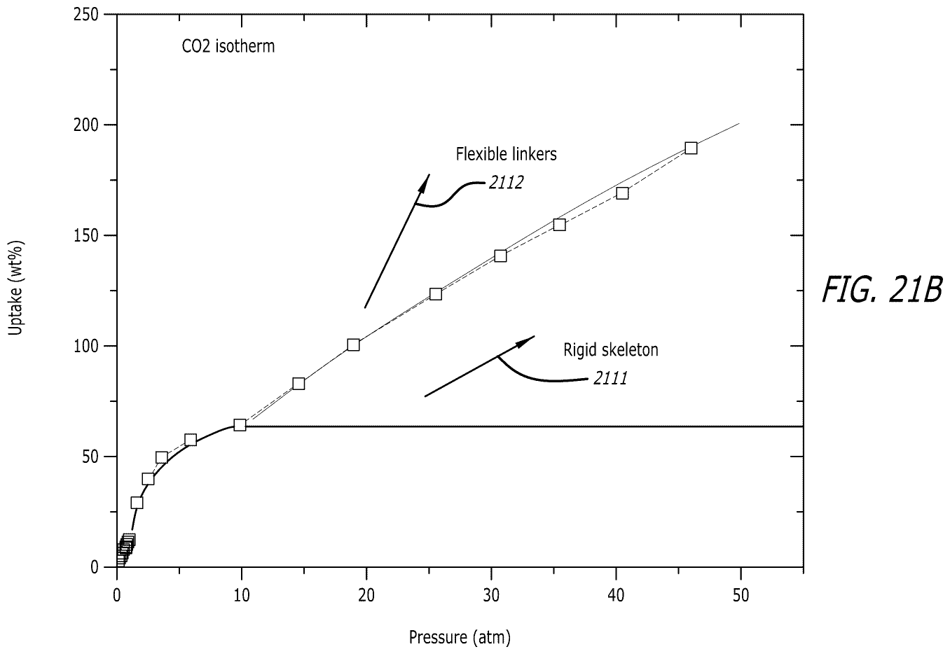

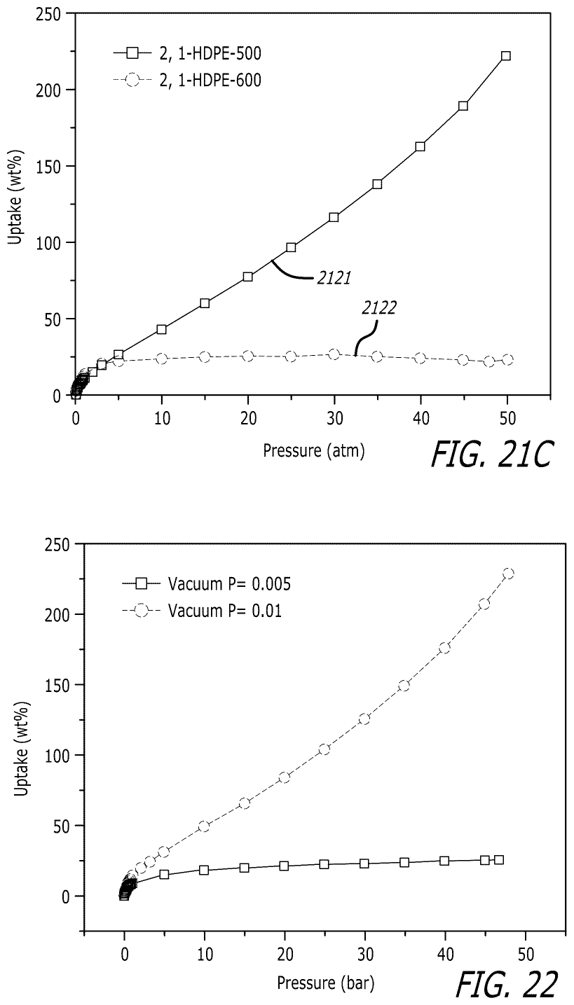

Differential scanning calorimetry was used to determine the glass-transition temperature of the sorbent 2,1-HDPE-500. FIG. 21A shows an endothermic phase transition of the sorbent occurring at 96° C. (with plots 2101-2103 showing weight, heat flow, and derivative of heat flow, respectively). This phase transition agrees with the gas sorption finding that shows higher uptake at higher temperature and a sudden increase in the storage capacity at around 100° C.

FIG. 21B shows that partial pyrolysis of HDPE yields a flexible materials (comparing HDPE pyrolyzed at 600° C. (rigid skeleton ploy 2111) with HDPE pyrolyzed at 500° C. (flexible linkers plot 2111)). FIG. 21C shows that flexibility does result in a change in storage capacity.

### Effect of Vacuum on the Sorbent

It is standard in the practice of gas uptake measurement to subject the material to an absolute pressure of at around 0.00013 bar (0.1 mmHg) or lower absolute pressure. This is done to remove any remaining sorbates from the material in order to get an accurate uptake of gas in the subsequent experiment. This is also done in BET surface area determination equipment before the surface area is determined. While low absolute pressure activation is fine for the rigid carbon materials that were prepare at around 600° C., it is destructive to the flexible carbons made at around 500° C. The applicants discovered that these low absolute pressures cause destruction of this flexible carbon material presumably by collapse of the framework. One needs to exercise extreme care in the pressure control of these carbon frameworks in order to preserve their structure. The uptake capacity of the flexible sorbent is dependent on the level of vacuum applied as a pre-treatment to activate the materials by removing the traces of sorbates like water, i.e. the absolute pressure before the sorbent gas is introduced. If the sample is subjected to even slightly more vacuum (lower absolute pressure), then the capacity to sorb the gas is drastically reduced since the material undergoes a catastrophic change in structure wherein its density lessens (from about 1.5 g/cc to less than 1.0 g/cc) and its gas uptake capacity plummets. The absolute pressure (or level of vacuum) during this pretreatment where the failure occurs is also temperature dependent. However, when the quality of the vacuum is poorer (i.e. at slightly higher absolute pressure) then the uptake is high when the gas is introduced. FIG. 22 shows the CO₂ sorption isotherm of the sorbent when subjected to 0.01 bar (7.5 mmHg, 1 hour) and 0.005 bar (3.5 mm Hg, overnight) both at room temperature of 23° C. It is observed that the high sorbent capacity plummets after subjecting it to higher vacuum (lower absolute pressure) for long periods of time on the order of hours. The typical measurement instruments that reduce the pressure to around 0.00013 bar (0.1 mmHg) or lower destroy this type of carbon material since even at 0.005 bar destruction can occur.

### Sorption Mechanism

Collapse upon drying or removal of sorbates is a known phenomenon with some metal organic frameworks (MOFs). MOF is an example of a sorbent with pores that have unique interaction with the solvent. Complete removal of the solvent from pores results, in some cases, in pore collapse. The pore collapse and interactions between the different MOFs and solvents has been studied extensively. [Hisaki 2018; Dodson 2018]. To prevent the MOFs pore collapse the pores must be supported with polymer or covalent interactions. [Peng 2019]. Furthermore, porous polymeric membranes have been reported to demonstrate unique solvent-pores interactions. It has been shown that solvent choice, heating time and temperature affect the pores interconnectivity. [Lu 2018]. Moreover, the interactions between the polymers strands also plays a role in preserving the porous structure. Strong polymer-polymer interaction may lead to pore collapse. [Lu 2018; Bhattacharjee 2018]. Pore collapse in carbon materials: (A) Cellulose cell wall pore collapse in wood derived porous structure upon drying; some work shows that drying water from the nanopores in wood leads to the collapse of the pores. [Papadopoulos 2018]. (B) Templated porous carbon can collapse upon drying. Thus, cationic polyelectrolyte template or surfactant must be used to stabilize the porous structure. [Dutta 2014]. The “pore collapse during the drying step due to large capillary forces imposed at the liquid-vapor interface” is known. [Lee 2002]. Functionalized pores collapse due to drying is known. Some structural deterioration of functionalized porous carbon is known when a hydrophilic porous carbon is dried. The work shows a decrease in the surface area and pore volume upon drying water or solvent exchange with ethanol. Freeze drying was found to be effective at preserving the porous structure. Hydrophobic porous carbons were found to remain intact upon drying and are not affected by water removal. [Zhang 2019]. Note that the porous carbons in that work by Zhang 2019 was prepared by a silicon templating method. This is distinct from embodiments of the present invention which were porous carbon that was hydrophobic with very little non-carbon content. Further, there are no known reports of porous carbon collapse in carbons prepared by potassium salt activation.

The results as described herein show that higher vacuum (lower absolute pressure) pre-treatment could alter the structure of the sorbent material and lowering its uptake capacity. Three possible mechanisms are suggested below:

First possible mechanism: after the starting polymer has been subject to partial thermal decomposition at elevated temperatures in argon, when the tube furnace is opened, room air displaces the argon. Atmospheric moisture is likely to be strongly sorbed into the pores. The material was further submersed in water to remove excess salts after the carbonization step, then the material is put in an oven at 100° C. to give it a dry surface appearance. Yet sorbed water will remain in the pores. Upon lowering the absolute pressure, the nitrogen, oxygen, argon, and similar non-polar species will be quickly pumped away, whereas water is quite “sticky,” meaning that its polar interactions keep to sorbed to the carbon. This makes water the overwhelming favorite as the sorbed species that give rise to this observation. Inside the pores, the water has a vapor pressure, but is much lower than liquid water because the water molecules are sorbed onto the surface. Let us assume for this argument that the average vapor pressure of the sorbed water in the sample is 7 mbar. If the needle valve is used to keep the pressure at 10 mbar in the pre-treatment chamber, then little water vapor escapes from the sample because there is not enough pressure to displace the external surrounding gas. A small amount will be lost due to diffusion, but nearly all water molecules that desorb will just re-sorb. When the pressure is reduced to 4 mbar (well below the internal vapor pressure), it is believed that the 7-mbar internal vapor pressure can displace the lower external pressure, and water molecules will freely escape from the sample into the chamber. The sample is quickly dehydrated, and the nano-sized pores collapse once the sorbed water is gone and cannot be re-opened.

The second possible mechanism is similar to the first: the polymer is partially decomposed, will likely leave many reactive sites, with radicals and multiple bond structures. The highly polar water molecule will adhere due to van der Waals attractions of the water to these sites. So, water is keeping the reactive sites from binding to each other. However, if the water is completely removed, then these nanoscale pores are likely to collapse, and gas species cannot pry the pores open again. In effect, this becomes a new material, with the partially decomposed hydrocarbon chains that are propped apart by water molecule.

A third possible mechanism is that at the lower absolute pressures, the flexible domains from the remaining short range polymer order (as described in FIG. 13D), become evacuated and they irreversible collapse or break, like a balloon being evacuated until the rubber splits.

External Vacuum Control System

The Rubotherm system determines gas uptake by weight increase. As is the case for most gas uptake measuring systems, it is designed to evacuate the sample to a low absolute pressure of 0.1 mmHg or less, which has the built-in assumption that vacuum will not alter the material morphology. Hence, the sample is exposed to the best vacuum (lowest absolute pressure) that the pump can generate. For a mechanical pump, this is 0.1 mmHg (0.13 mbar) and likely lower. The limit of resolution of the Rubotherm gauge is 0.01 bar, which does not allow useful pressure measurements in the range of interest when the water is outgassing. A high vacuum gauge can be installed on the pumpout line, but the many tubes, valves, and fittings in the control box will have a low gas conductance, whereas the tube connecting to the vacuum pump has a high gas conductance. Therefore, the gauge is measuring the pressure of the pump, not the sample, which could be one to two orders of magnitude higher than the gauge reading. Since it is not feasible to connect directly to the sample chamber, which is designed for greater than 200 bar, then the gauge system must necessary be mounted external to the Rubotherm control box.

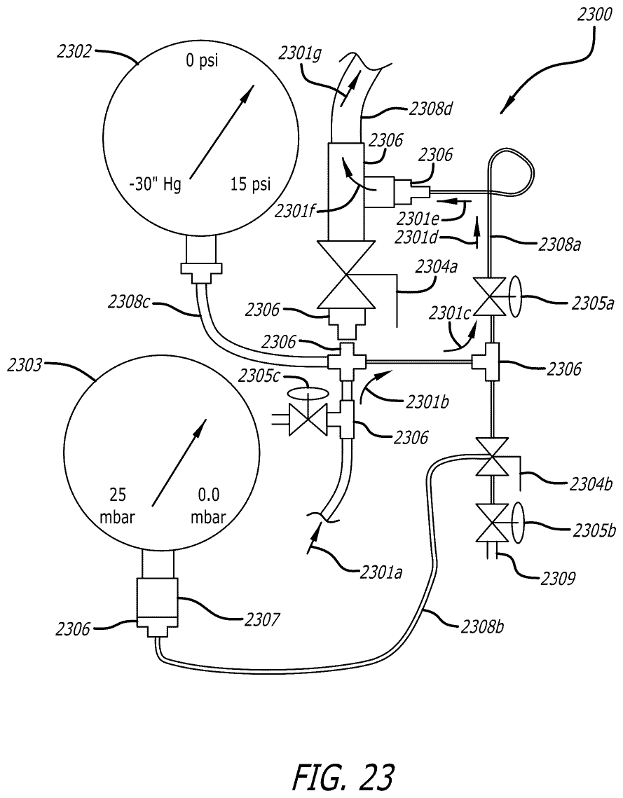

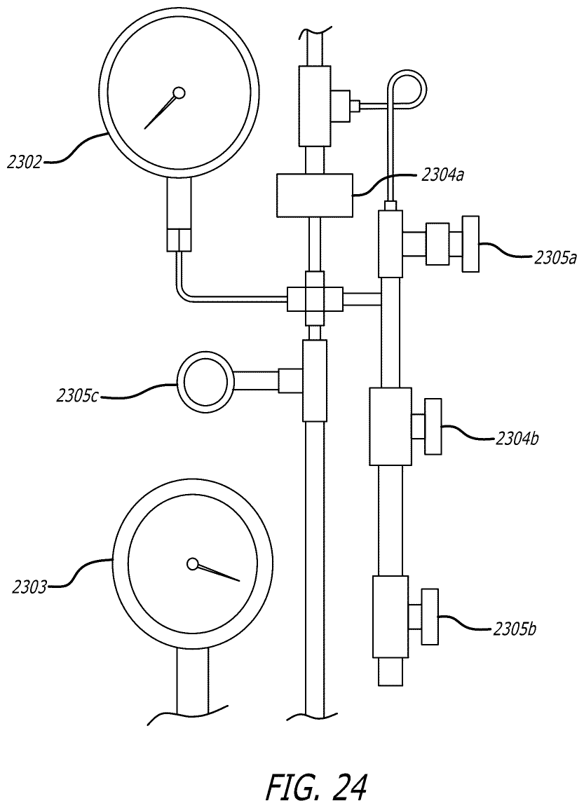

In order to measure the sample pressure so far from the gauge, it is necessary to introduce a restricted conductance with an external vacuum manifold. FIG. 23 shows schematic of the pressure control manifold 2300 that was installed on the Rubotherm with arrows 2301a-2301g showing gas flow direction (with needle valve control) from Rubotherm to vacuum pump. Pressure control manifold 2300 includes vacuum gauge 2302 (Bourdon vacuum gauge), absolute pressure gauge 2303, ball valves 2304a-2304b (on-off and 3-way), needle valves 2305a-2305c (for fine control), reducers/adapters 2306, piston snubber 2307, tubing 2308a-2308d (various diameters, such as ⅛ inch 3/16 inch, ¼ inch, and ½ inch, respectively), and air inlet 2309. FIG. 24 shows a picture of the actual pressure controlling system installed on the Rubotherm.

In embodiments of the present invention, ball valve 2304a can be main pumpout valve, ¼ turn, ½ inch tube (Swagelok B-8P6T). Ball valve 2304a can be open for total pumpdown and closed for measurements. Ball valve 2304b can be a three-way ¼ turn valve (Swagelok SS-41-XS2 or SS-41-GSX2). The middle position with the handle perpendicular to the tubing is the off position, ¼ turn up to open to the manifold, and ¼ turn down to vent absolute pressure gauge 2303. This isolates and protects absolute pressure gauge 2303 until conditions are appropriate for a measurement. Needle valve 2305a can be a regulating needle valve in parallel (Swagelok SS-ORS2) and can be a multi-turn adjustable valve. This valve provides fine control on pumpout rate when ball valve 2304a is closed. Ball valve 2305b can be a vent valve for absolute pressure gauge 2303. Needle valve 2305b is typically barely open. When the handle for ball valve 2304b is turned to the down position, needle valve 2305b lets air in slowly to bring the needle for absolute pressure gauge 2303 to full scale in about 5 seconds. Then ball valve 2304b is closed. Needle valve 2305c is a manifold vent valve that is normally kept closed.

Vacuum gauge 2302 can be a Bourdon tube gauge, which measures pressure relative to atmospheric pressure. “0” is the reading when open to air. −30 inches Hg is full vacuum, and 15 psi about 1 atmosphere above room pressure. This is termed a combination gauge. A conventional Bourdon-tube gauge is used to measure from atmosphere to vacuum and it is not suitable for an accurate measure of the absolute pressure. The term “vacuum gauge” implies that the gauge is measuring a decrease in pressure relative to atmospheric pressure and the numerals have a minus (−) sign. When the vacuum gauge 2302 goes below −25 inches Hg (≈130 Torr remaining) then the 3-way valve can be switched to absolute pressure gauge 2303. The reason for using a combination gauge rather than vacuum only, is that this provides a check to see if the Rubotherm is venting to the pump while under pressure. Since this gauge is referenced to atmospheric pressure (which changes with the weather) it is not suitable for low-pressure measurements. Absolute pressure gauge 2303 (Edwards Vacuum) has an internal evacuated “can” with a “lid” that is mechanically connected to the pointer. This reference is sealed high vacuum, and it is unaffected by the barometric pressure or temperature. The gauge glass is much thicker since the entire volume of the gauge is evacuated. The absolute pressure gauge 2303 used can be a 25 mbar (absolute) full scale, which is the most sensitive available. This type of gauge is easily damaged by the shock wave if atmospheric pressure is allowed to rush in when it is evacuated. The needle will move with extreme speed and can bend or break off. The Rubotherm pumpout valve just pops open, which will ruin the gauge, as a discussion with the manufacturer confirmed. Hence there are protective devices incorporated in the design. The connecting tube can be at least 3/16 inch OD, which can be shaped by hand. ¼ inch SS tube needs a tube bender. 40 mbar and 100 mbar ranges can alternatively utilized.

The first level of protection for the absolute pressure gauge is ball valve 2304b that has two quarter turn motions. The protective air inlet needle valve 2305b is used to control the air inlet to the absolute pressure gauge 2303 when the 3-way valve is switched to the vent position; this low-flow needle valve is the primary protection for absolute pressure gauge 2303. One position vents absolute pressure gauge 2303 to air, the opposite position connects to the vacuum manifold, with off in the middle position. Needle valve 2305b attached to the vent connection restricts the airflow to the absolute pressure gauge 2303. The absolute pressure gauge 2303 is vented through needle valve 2305b to reach full scale (but does not need to be more than 25 mbar); and then shut off ball valve 2304b. When the Rubotherm has opened to the pump, and vacuum gauge 2302 is below 25 inches Hg (typical units for Bourdon vacuum gauges) or about 100 Torr, then ball valve 2304b can be switched to connect to the manifold and measure the absolute pressure, and comes on scale at 25 mbar absolute.

Snubber 2307 (such as McMaster-Carr 4072K6 with the most restrictive “A” piston) provides a second layer of protection. There is a small piston that is pushed upward into an orifice to restrict flow when there is a fast inrush of air and protects the absolute pressure gauge 2303. With the piston engaged, it typically takes about 2 seconds for absolute pressure gauge 2303 to go to the peg at 25 mbar. A simple version of a snubber is a fitting with a pinhole passage, but this also restricts pump down rate. The largest orifice available from McMaster-Carr is 0.015″, which is too small, and it was drilled out to 0.025″ with a #72 drill in a hand-held pin vise (an electric drill would break the bit). The second option is a piston snubber that must be mounted in the vertical direction. When the airflow is too fast, it lifts the piston and plugs the orifice.

However, the surface of the orifice apparently was not smooth and did not seal well, allowing the gauge to move too fast. Since the orifice is brass and the piston is steel, a pin punch and hammer were used to gently flatten the brass orifice for a better seal. With this modified piston snubber, the evacuated gauge can be switched suddenly to atmospheric pressure without damage. When the piston is in the lower (normal) position, the pump down rate of the gauge is adequate. This piston “vibration damper” is also available from McMaster Carr (which is what is used in the described system). Normally, the 3-way valve is turned off once the needle reaches the 25 mbar peg, leaving the gauge under partial vacuum. It is kept in the off position until the manifold pumpout pressure is below 25 inches Hg and then switched to the manifold to read the decreasing pressure. For pressures below 2 mbar, it may take the gauge a minute or more to settle down. Also, it is beneficial to gently tap the gauge after a minute to help it settle. The absolute pressure is controlled with needle valve 2305a. The desired pressure can be approached gradually to allow equilibration between the sample and the absolute pressure gauge 2303. For lower pressures in the range of a few mbar, more time is needed because the pressure drop is so small and the flow rates are likewise small. Gently tap the gauge to help it settle. If the pressure rises when the bypass valve is closed, this indicates outgassing of the sample and the rise will slow down. In contrast, if there is a leak the pressure will rise at a steady rate until the gauge reaches its maximum. When the pressure is steady for 30 seconds to a minute, then this is also the pressure of the sample.

For pressure control manifold 2300, a ½ inch tube goes to the oil-type rotary vacuum pump, and the manifold is fitted with a ¼-turn ball valve 2304a for unrestricted pumping and will achieve <0.1 mbar in seconds when opened. Since needle valve 2305a bypasses ball valve 2304a, when ball valve 2304a is closed, needle valve 2305a can then be used to reduce conductance or even stop pumping action altogether to control the pressure in the sample. As needle valve 2305a is closed down and the conductance becomes much less than that through the control box, vacuum gauge 2302 will come into equilibrium with the sample. Outgassing may cause the pressure to drift upwards, and a slight opening of needle valve 2305a can compensate to keep the pressure stable. While ball valve 2304a can be used for quick pump down, needle valve 2305a is normally used to slowly approach the desired manifold pressure, and because the pressure is approached slowly, it is also close to the sample pressure.

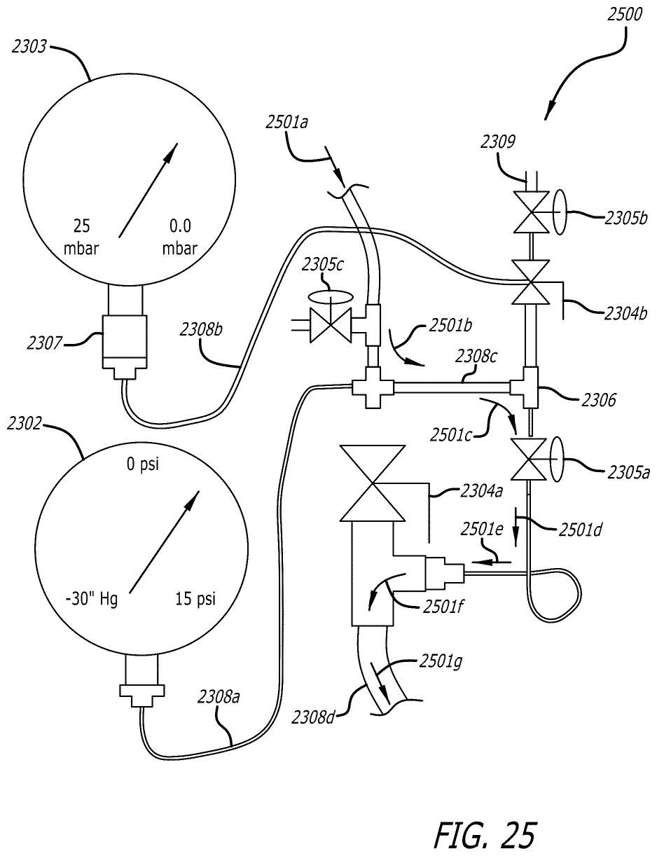

For water outgassing, all manifold components can be brass with copper tubing. However, other polar molecules may be introduced as proppants. Ammonia, NO₂ and halogen acids will attack copper and brass, and in this case, stainless steel is preferred. All fittings are Swagelok fittings. FIG. 25 shows a generic schematic for the pressure control manifold 2500 to be used for corrosive gases with arrows 2501a-2501g showing gas flow direction (with needle valve control) from Rubotherm to vacuum pump. Like pressure control manifold 2300, pressure control manifold 2500 includes vacuum gage 2302 (Bourdon vacuum gauge), absolute pressure gauge 2303, ball valves 2304a-2304b (on-off and 3-way), needle valves 2305a-2305c (for fine control), reducers/adapters 2306, piston snubber 2307 tubing 2308a-2308d (various diameters, such as ⅛ inch 3/16 inch, ¼ inch, and ½ inch, respectively), and air inlet 2309.

### Converting Plastic Bags to Flakes

Embodiments of the present invention can encompass converting plastic bags to flakes for use in the synthesis processes described herein or for use to make in other synthesis process, such as in the flash Joule heating synthesis method described in PCT International Patent Appl. Serial No. PCT/US19/47967, filed Aug. 23, 2019, to Tour et al. (which describe and teach among other things, methods for making flash graphene). Of the many problems with recycling plastic, plastic shopping bags are among the worst of the problems. Conventional recycling machines cannot handle the bags because they get entangled in the slow turning shredders that are made for harder plastics. And bags left in the open are degraded by sunlight and air, and because they are lightweight, can easily be dispersed by wind. Unfortunately, the bags do not break down completely but instead photo-degrade, becoming microplastics that absorb toxins and continue to pollute the environment. Microplastics and nanoplastics adversely affect the food chain and they degrade the immune system. [Allen 2019].

A bag flaker device utilizing the processes of the present invention can be located at a store entry to minimize employee work and allow the customer to know that the customer's efforts are directly contributing to the recycling effort.

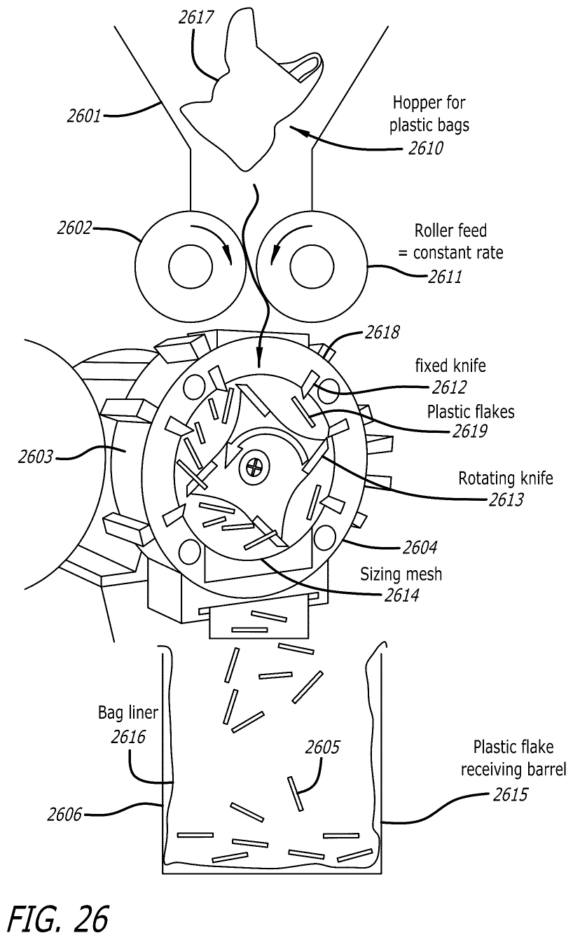

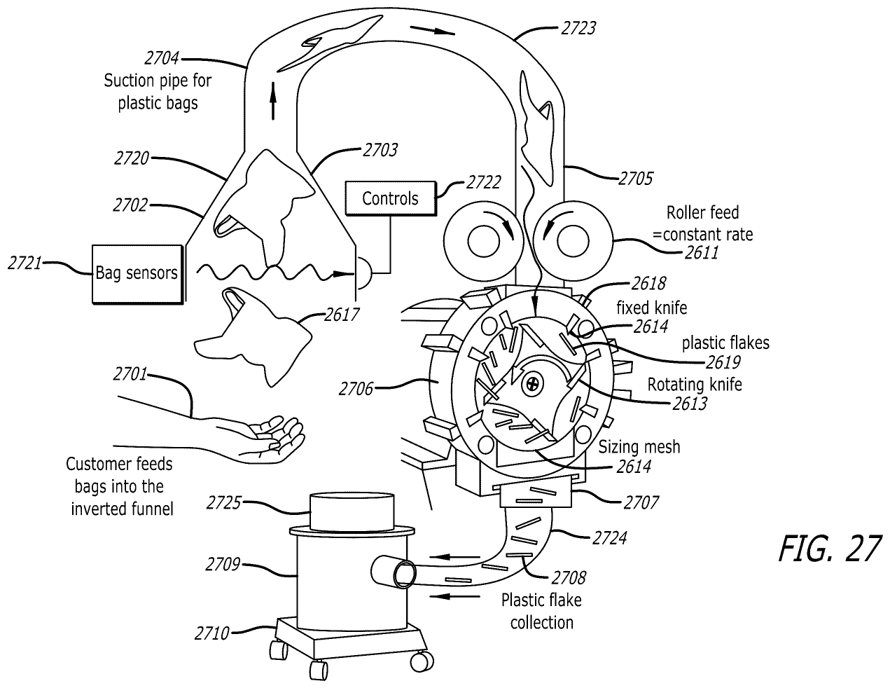

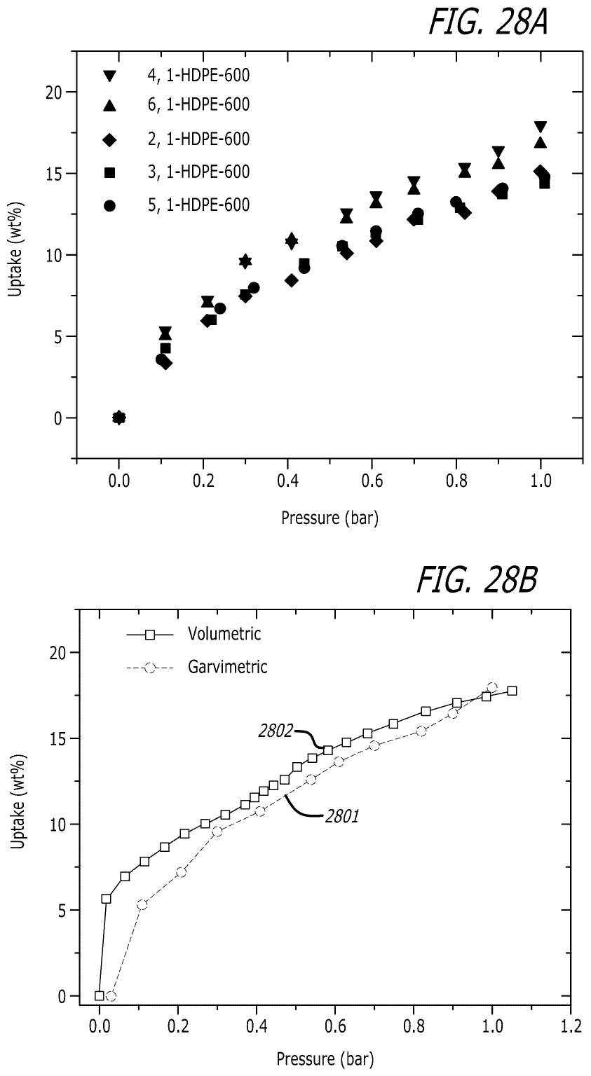

FIG. 26 shows a simple hopper device for converting plastic flakes, which flakes can be then used to form other materials (such as graphene). The hopper used here is commercial sold to shred hemp or related fibrous plant products.

As shown in FIG. 26, in step 2601 the store employee/customer/etc. loads the plastic bags 2617 into a hopper 2610.

In step 2602, the bags 2617 are feed into the chopper 2618 using rollers 2611, which feed the bags 2617 into the chopper 2618 at a constant feed rate.

In step 2603, chopper 2618 is used to sheer the bags to plastic flakes 2619. The chopper 2618 includes a high speed rotor with rotating knives 2613, which are close in tolerance to fixed knives 2614.

In step 2604, the smaller flakes 2619 will pass through sizing mesh 2614 located at the bottom of chopper 2618. The larger flakes 2619 (too big to pass through sizing mesh 2614) will circulate in chopper 2618 so that they can be cut smaller.

In step 2605, the flakes 2619 (that pass through sizing mesh 2614) will fall by gravity into a receptacle, such as barrel 2615. A bag 2616 is lined inside barrel 2615.

In step 2606, once barrel 2615 is full, the bag 2616 is removed with the flakes 2619 (and replaced with a new bag 2616). The flakes 2619 can then be utilized in a synthesis process as described above.

For safety and other reasons, equipment may be added to prevent/avoid customers (and especially children) from throwing foreign objects into the device.

FIG. 27 shows an alternative device that includes an inverted funnel design that will only pick up lightweight bags.

In step 2701, the store employee/customer/etc. feeds the plastic bags 2617 into the inverted funnel 2720.

In step 2702, bag sensors 2721 search for foreign objects. Bag sensors 2721 may use light scattering, radio waves, ultrasound and/or millimeter waves to determine that the item is a bag and does not contain foreign objects.

In step 2703 after determining that the bag 2617 is empty and there are no foreign objects, controls 2722 turn on the suction. Controls 2722 do not switch on the suction until the bag is positively identified.

In step 2704, suction pulls the bag 2617 into and through pipe 2723, and the bag is carried by the air flow to the rollers 2611.

In step 2705, the bags 2617 are feed into the chopper 2618 using rollers 2611, similar as described above in step 2602 for FIG. 26.

In step 2706, chopper 2618 is used to sheer the bags to plastic flakes 2619, similar as described above in step 2603 for FIG. 26.

In step 2707, the smaller flakes 2619 will pass through sizing mesh 2614 located at the bottom of chopper 2618, similar as described above in step 2604 for FIG. 26.

In step 2708 a suction pipe (or exit hose) 2724 is utilized to deliver the flakes 2619 to a receptacle, such as vacuum canister 2725, which can be nearby. (Alternatively, the vacuum canister 2725 can be located at a remote location, such as in the stockroom at the back of the store. The latter case will reduce employee time and could allow central collection for several bag cutters if the store has multiple entries). The vacuum canister 2725 is lined with a bag, similar to as shown in FIG. 26.

In step 2709, vacuum canister 2725 collects flakes 2619.

In step 2710, the bag is removed from the vacuum canister 2725 (such as by an employee removing it and tying it off).

The bagged flakes (such as produced from the above systems/methods of FIGS. 26-27), can then be utilized in the processes described herein or for some other processes, such as to make flash graphene. I.e., the store can sell the bags of flakes, as there is a market for these materials. As it is believed that customer participation is easy and straightforward, and the store (or other entity) has a marketable product instead of harmful waste, this is a resolution for the microplastic problem from discarded plastic bags.

Further advantages for the store (as well as other similarly situated users) include:
(i) The volume of plastic material is greatly reduced.
(ii) The flakes are collected and bagged, like emptying normal trash barrels.
(iii) A waste material has been turned into a saleable feedstock, such as for making flash graphene.
(iv) The resultant material can be sold to a graphene production center, rather than paying to haul it to landfill.
(v) If there is high customer participation in returning bags (which is believed will be the case), then plastic bag bans will be reduced/eliminated, which will reduce the use of trees for paper bags.
   CO₂ Capture from Post-Combustion CO₂ Emission Outlet Gas and CO₂ Captured Directly from Air (Direct Air Capture)

As discussed above, the present invention relates to porous polymeric carbon sorbents for CO₂ capture and methods of making and using same. The porous polymeric carbon sorbent is rigid and the CO₂ captured from the flue gas and for gases from other post-combustion CO₂ emission outlets can be released at low temperature (such as around 70° C. to 75° C.) when there are no nitrogen atoms as part of the polymeric carbon sorbant and at around 110° C. when there are nitrogen atoms as part of the polymeric carbon sorbent. Or one can reduce the pressure to release the captured CO₂ from the porous polymeric carbon sorbent. The term “post-combustion CO₂ emission outlet gas” refers to the exhaust gases (which include CO₂) that evolved from any combustion process, such as industrial applications, like flue gas from a power plant or other fossil fuel-based large point source, from a factory, exhaust from a vehicle, and the burning of oil, natural gas, gasoline, diesel, etc.) The term “rigid” as used herein when referring to the porous polymeric sorbent refers to that the polymer of the sorbent having lost its long range order and short range order as detected by powder X-ray diffraction (XRD). The term “flexible” as used herein when referring to the porous polymeric sorbent refers to the polymer of the sorbet having lost its long range order while retaining its short range order as detected by powder XRD.

HDPE, PP and LDPE may be used for this rigid polymer system.

In an example utilizing a melt mixing procedure, 8 g of plastic was cut into small 2 cm² pieces and melted at 150° C.-170° C. in a Brabender melt mixer (model type 808-400-DTI). This took less than 5 minutes. Once melted, potassium acetate was added to the polymer melt as salt: plastic weight ratio of 4:1 (salt to polymer) and was mixed at 50 RPM for 10 min at 150° C. to form a homogenous blend. Then, 2 g of the polymer-based mixture was transferred to a ceramic boat and heated in a tube furnace at a rate of 25° C./min under argon atmosphere. The temperature was held at 620° C. for 45 min to carbonize the plastic and get porous carbon. After cooling down, 1.5 g of sorbent/salt product was recovered. The product was washed with DI water and filtered using a 0.22 μm PTFE filter to obtain 0.07 g of porous carbon after drying at 100° C. overnight.

In an example that utilized an alternative approach using powdered plastic, to make plastic powder, plastic waste was chilled in liquid nitrogen before it was ground using a commercial mill. After that, 8 g of plastic powder was mixed with potassium acetate at salt: plastic weight ratio of 4:1. Using a mortar and pestle, the plastic/salt mixture was mixed until a homogeneous blend is formed. Then, 2 g of the polymer-based mixture was transferred to a ceramic boat and heated in a tube furnace at rate of 25° C./min under argon atmosphere. The temperature was held at 600° C. for 45 min to carbonize the plastic and get porous carbon. After cooling down, 1.5 g of sorbent/salt product was recovered. The product was washed with DI water and filtered using a 0.22 μm PTFE filter to obtain 0.07 g of porous carbon after drying at 100° C. overnight.

To activate the sorbent, heat the sample at a temperature of 120° C. and pressure of 1 mbar (full vacuum) for at least 1 hour.

FIG. 28A shows CO₂ isotherms of sorbents synthesized at different potassium acetate:HDPE ratios at 2:1 to 6:1, with the 4:1 ratio reflecting the uptake (wt %) in this range. This shows that 4,1-HDPE-600 captures 18 wt % CO₂. FIG. 28B is the gravimetric and volumetric CO₂ isotherms of 4,1-HDPE-600 (plots 2801-2802, respectively). The agreement of the volumetric and gravimetric data further confirms the reliability of the results (i.e., 4,1-HDPE-600 captures 18 wt % CO₂ by volume).

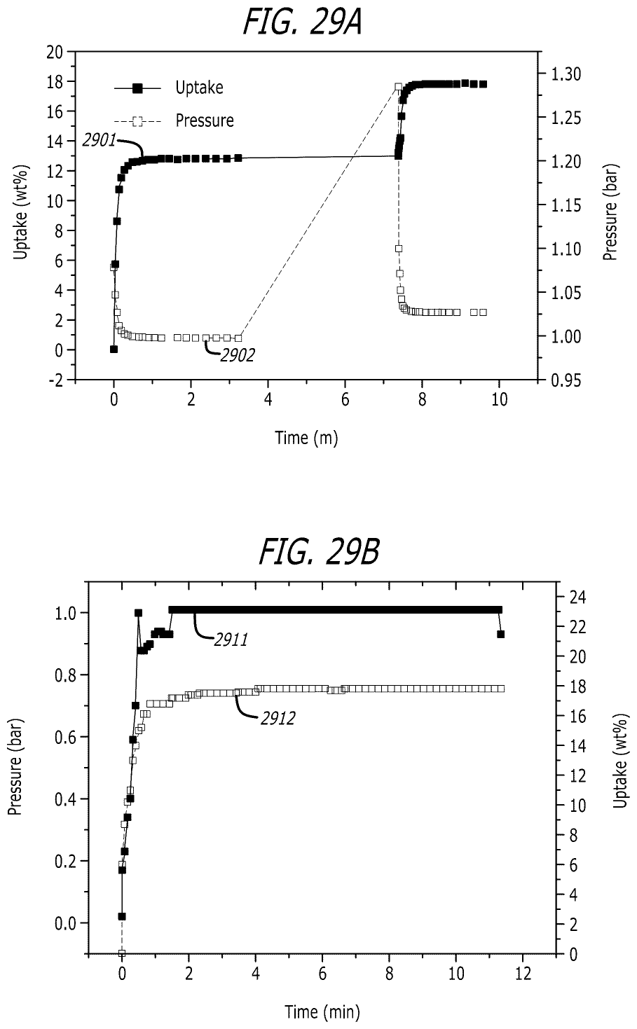

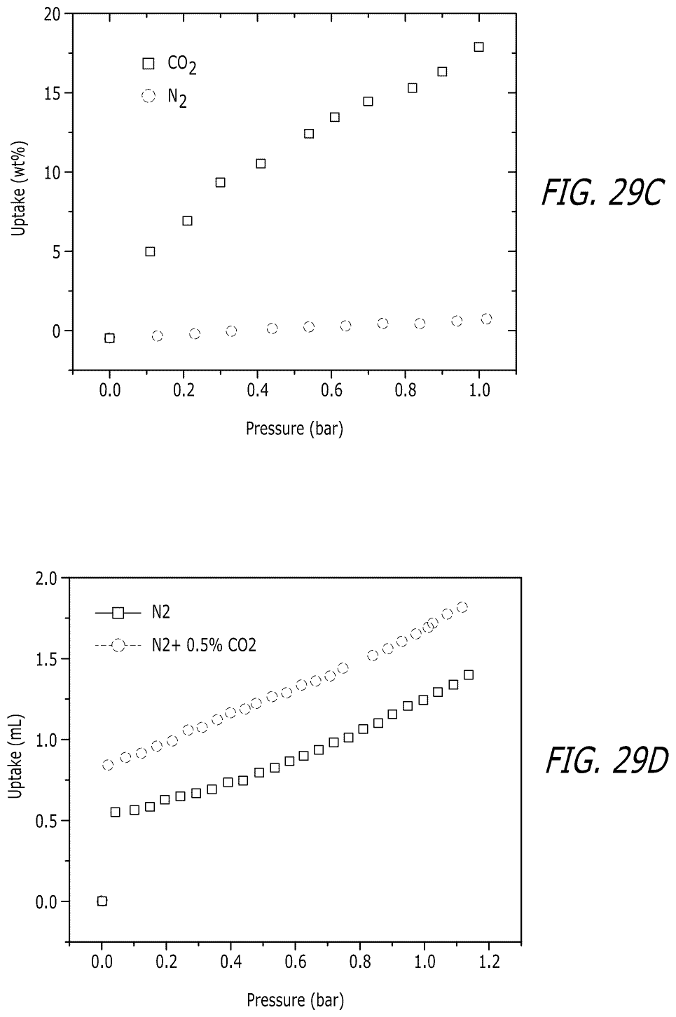

FIG. 29A shows the CO₂ uptake and change in pressure overtime (plots 2901-2902, respectively) of a rigid sorbet that shows the fast sorption kinetics upon exposing the sorbent to CO₂. Kinetics is one important parameter to look at for any sorbent for the CO₂ capture market. The results show that the sorbent exhibit fast sorption kinetics. High sorption rate allows for high number for sorbent cycling in a day and thus more CO₂ can be captured per ton of sorbent in a day.

FIG. 29B shows the CO₂ capacity change with time upon subjecting a rigid sorbet to CO₂ (plots 2911-2912 for pressure and uptake, respectively). FIG. 29B shows that the rigid sorbent staturates after ˜4 min of exposure to CO₂. As for selectivity, the rigid sorbet (such as 4-1-HDPE-600) was highly selective to CO₂, as shown in FIGS. R1A-R1C.

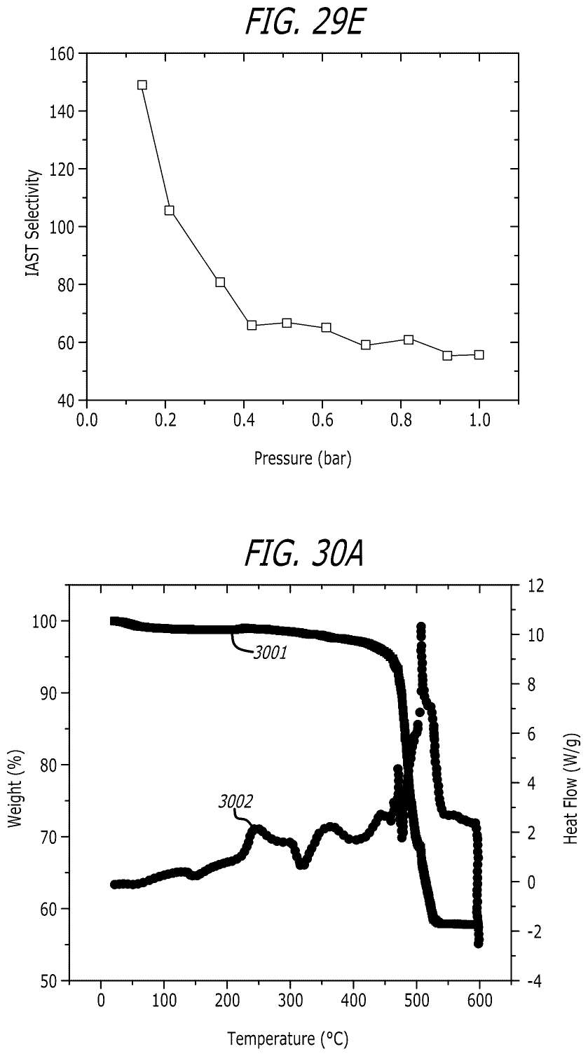

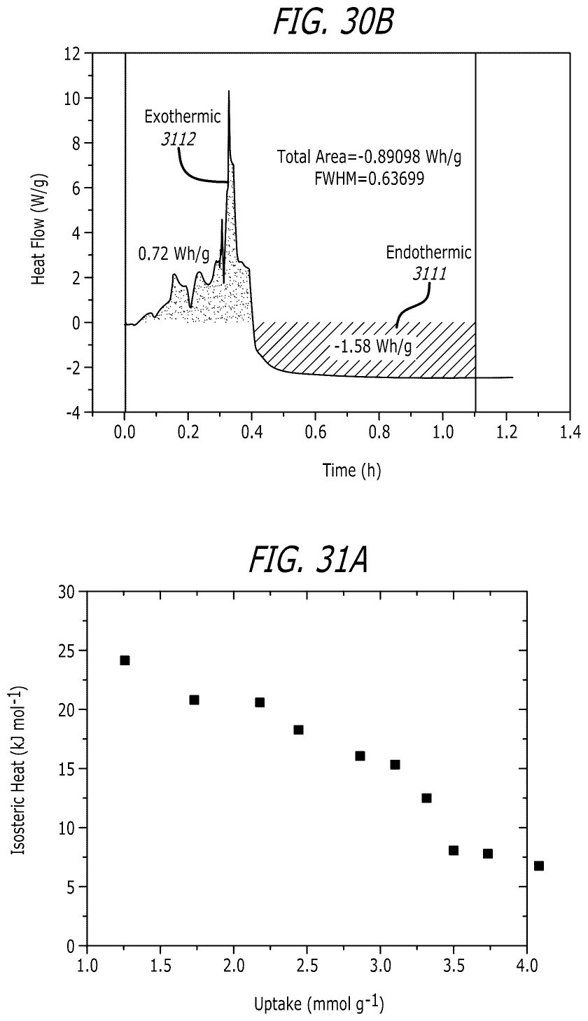

FIG. 30A shows the TGA/DSC of HDPE and potassium acetate mixture showing weight loss and heat required (plots 3001-3002, respectively) to synthesize the rigid sorbent. FIG. 30B is the heat loss (endothermic plot 3111) and heat gain (exothermic plot 3112) over time during the pyrolysis of HDPE+ acetate to synthesize the sorbent. Using the heat loss and heat gain data from FIG. 30B, this estimates a cost for sorb ent synthesis to be around $34 per ton from HDPE.

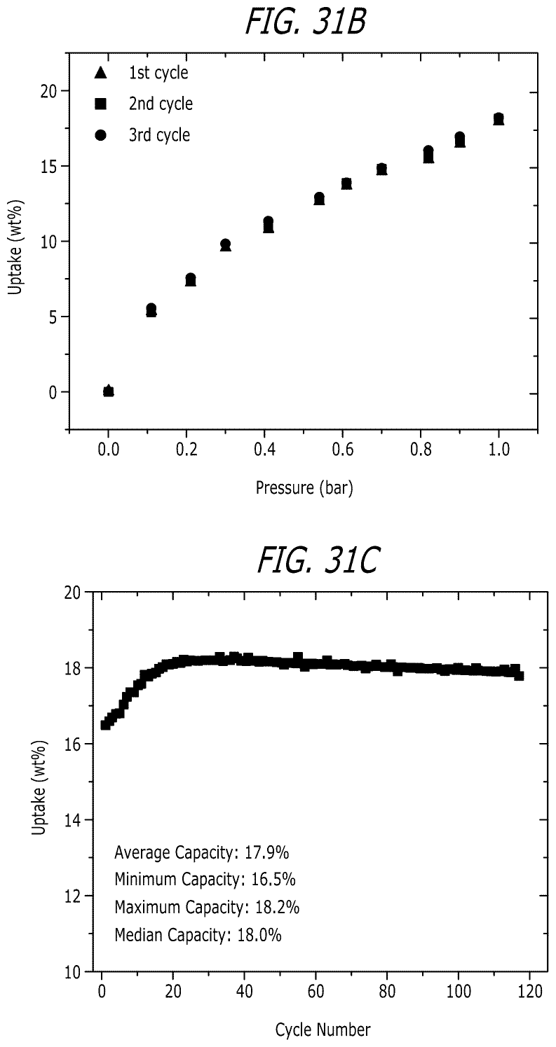

As shown in FIGS. 31A-31C, 4,1-HDPE-600 has low binding energy and cycles well. FIG. 31C shows the CO₂ capacity of 4,1-HDPE-600 upon cycling 110 time and demonstrates great stability in the CO₂ capacity. Thus, the rigid sorbet of the present invention can be repeatedly cycled over and over again while maintaining its capacity. The slight decrease is due to the rapidity in which we did the cycling. (This is because time was not given for full CO₂ desorption; however, more time would have shown greater stability to the system).

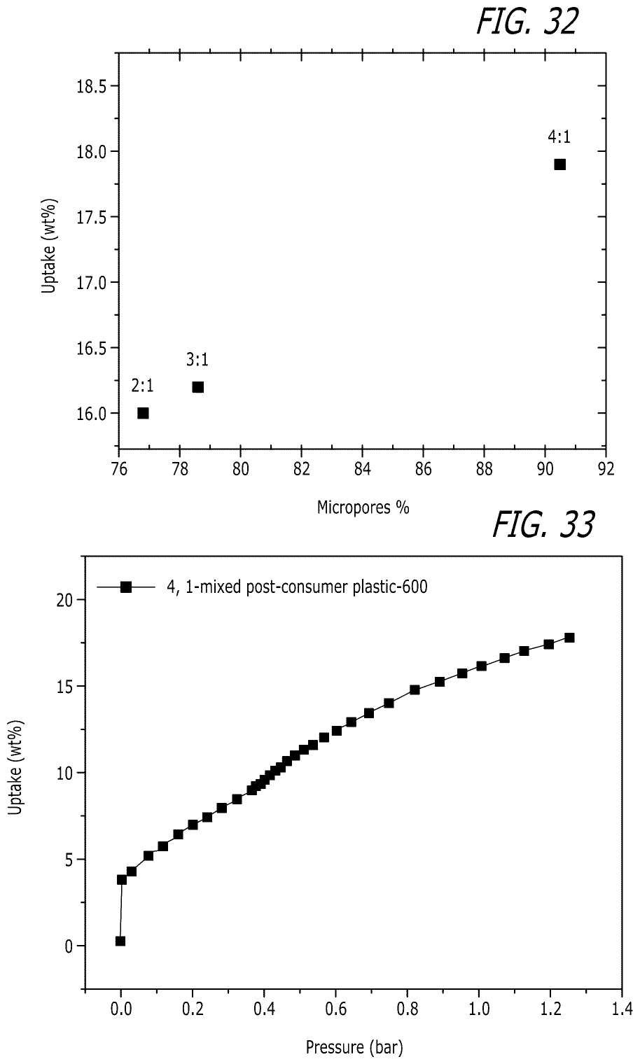

FIG. 32 shows the change in the micropores (<1 nm in radius) percentage upon changing the potassium acetate/HDPE ratio showing that ultra-high micro-porosity can be attained with 4:1 potassium acetate:HDPE ratio. Higher micro porosity can be obtained with increasing the HDPE ratio to reach 90% when the potassium acetate:HDPE is 4:1.

FIG. 33 shows the CO₂ isotherm of plastic obtained from mixed post consumer plastic. This demonstrates that the rigid sorbent of the present invention can be synthesized from all kinds of plastic including plastic from end-of-life cars.

Calcium acetate can be utilized in lieu of potassium acetate to make the rigid sorbets. FIG. 34A shows the CO₂ isotherm of sorbent activated with calcium acetate in replacement of potassium acetate showing efficient CO₂ uptake compared to different sorbents activated with potassium acetate (plots 3401-3403 for (a) 2, 1-HDPE-600 Ca acetate, (b) 2, 1-HDPE-PEI-600, and (c) 4, 1-HDPE-600, respectively). Accordingly, calcium acetate is a possible activation reagent for the rigid sorbet. Washing the calcium salts from the sorbent will require an acidic water-based solution.

FIG. 34B show XRD pattern of unwashed sorbent activated with calcium acetate showing the formation of calcite and calcium oxide at 600° C. and 800° C. (plots 3411-3412, respectively). The byproducts of pyrolysis of calcium acetate with HDPE are calcite and calcium oxide, which are noncorrosive and safe to handle. In addition, the pyrolysis of calcium acetate does not yield reactive metal that ignite upon contact with moisture (which is another advantage of the present invention). If washed with dilute aqueous acid, such a 1 M hydrochloric acid, these salts can be efficiently removed.

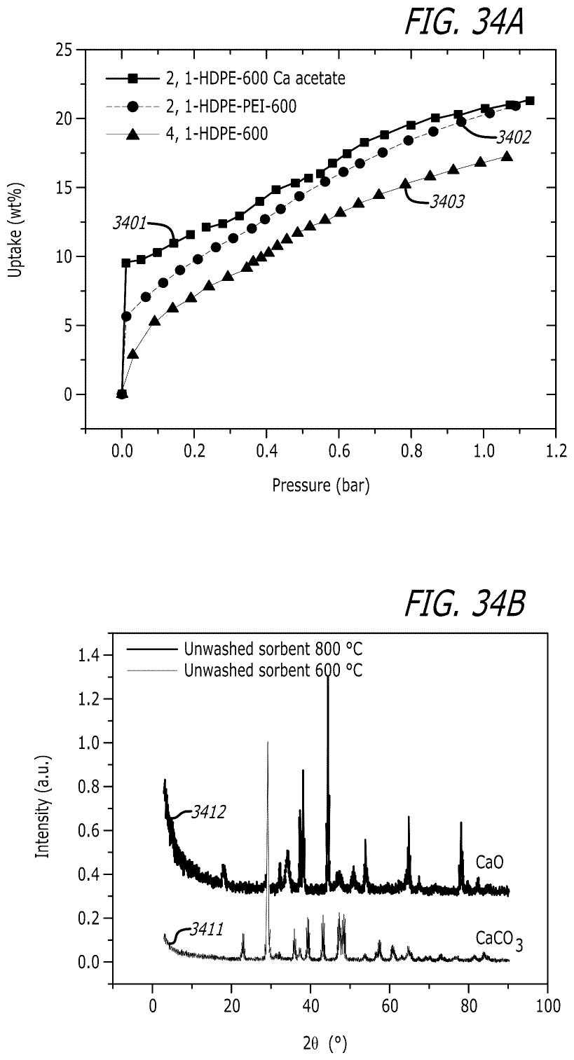

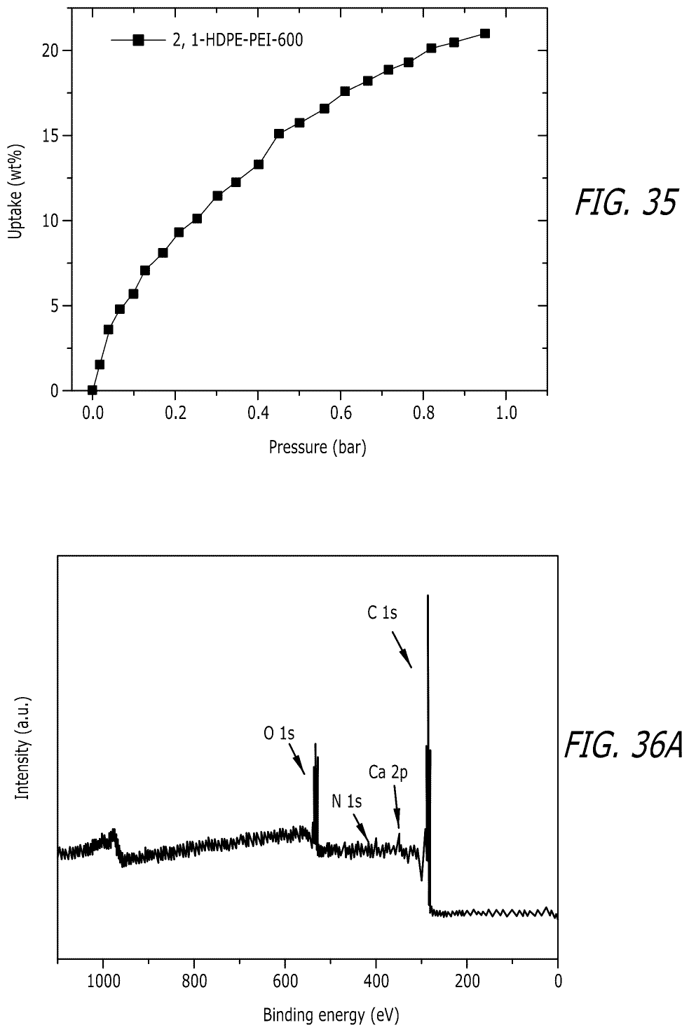

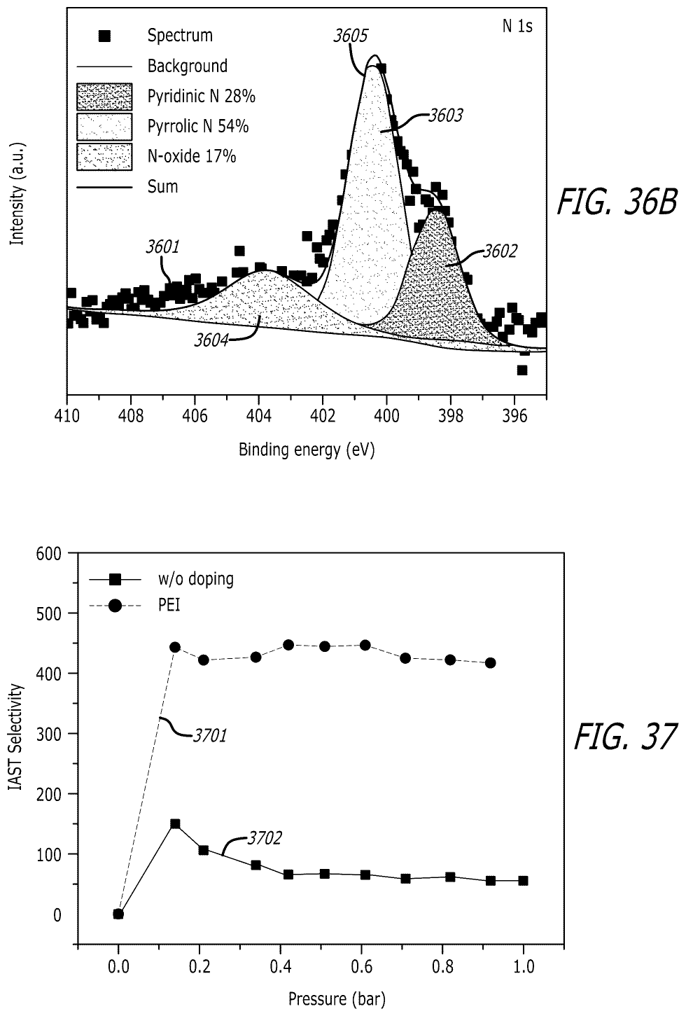

In some embodiments, the rigid sorbet can be N-doped by adding N-containing polymers to the HDPE (or other polymer). FIG. 35 show CO₂ isotherm of N-doped sorbent by the addition of polyethyleneimine. FIG. 36A shows the survey XPS scan of the N-doped sorbent. FIG. 36B shows high resolution N 1s XPS showing that the sorbent has nitrogen in the pyrrolic and pyridinic form. Blocks 3601 show the spectrum. Areas 3602-3604 are pyridinic N (28%), pyrollic N (54%), and N-oxide (17%). Plot 3605 is the sum. Pyrrolic and pyridinic nitrogen are a preferred form of nitrogen for CO₂ capture. FIG. 37 shows ideal sorbed solution theory (IAST) selectivity of the sorbent showing great increase in the selectivity upon N-doping (plot 3701) as compared to without N-doping (plot 3702).

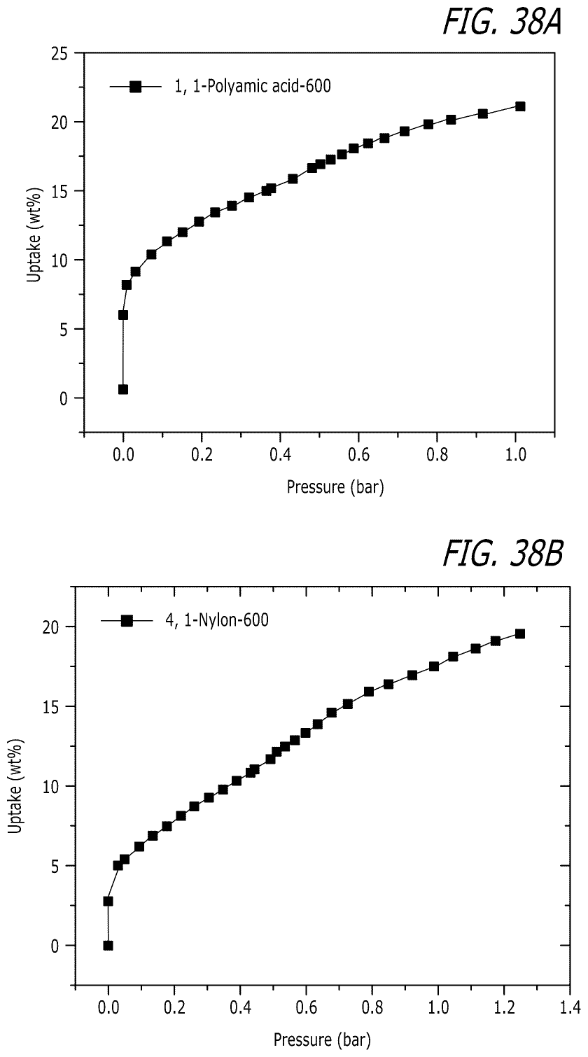

N-doped sorbent can also be synthesized from different N-containing polymers to have an uptake of 20 wt % at 1 bar. FIGS. 38A-38B are CO₂ sorption isotherm of 1,1-polyamic acid and 1,1-nylon acid, respectively.

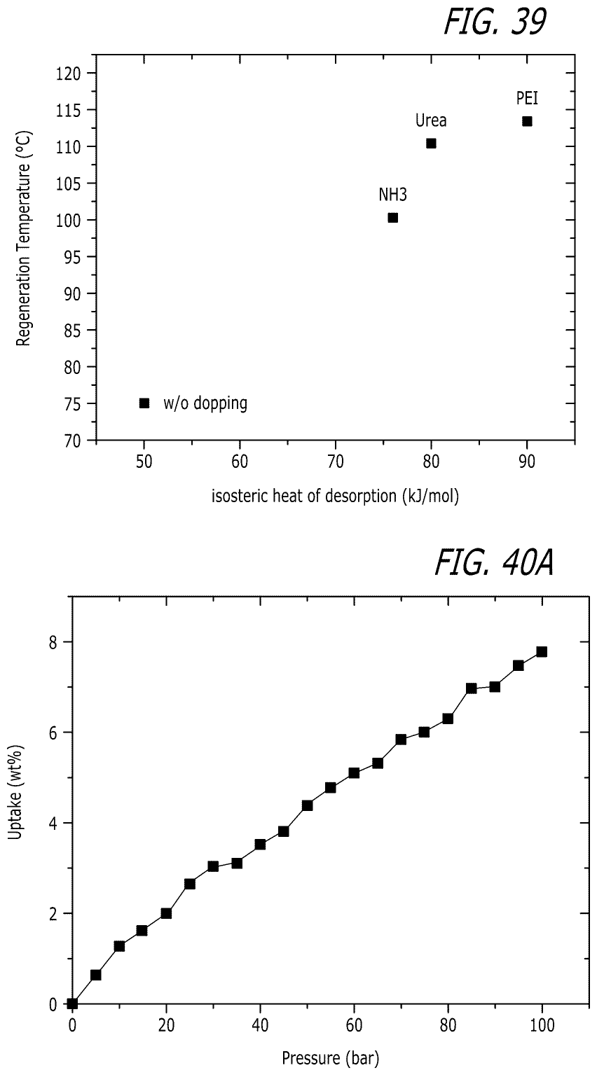

N-doping further allows for tuning heat of adsorption and will lead to higher regeneration temperature. FIG. 39 shows isosteric heat of adsorption and regeneration temperature which reveals an increase in the regeneration temperature with isosteric heat of energy.

Because the rigid sorbent material can release the captured CO₂ at low temperature, waste heat or recycle streams can then be utilized.

### Gas Storage

As discussed above, the present invention relates to flexible porous polymeric carbon sorbents for gas storage. The gas can be, for example, H₂, CO₂, O₂, methane, and natural gas. The gas can be contained in containing that includes the flexible sorbent, and an increased amount of gas can be stored in the container as compared to the container without the flexible sorbent. I.e., the storage container can store more H₂, O₂, methane, or natural gas at about 25° C. and about 100 atm than in the storage container without the flexible porous carbon material at the same conditions. For instance, the container can be a hydrogen storage vessel to contain H₂ for an automobile that runs on H₂. And even much more storage can be achieved at 300 atm.

In example utilizing HDPE, 8 g of plastic was cut into small 2 cm² pieces and melted at 150-170° C. in a Brabender melt mixer (model type 808-400-DTI). This took less than 5 minutes. Once melted, potassium acetate was added to the polymer melt at salt: plastic weight ratio of 4:1 and was mixed at 50 RPM for 10 min at 150° C. to form a homogenous blend. Then, 2 g of the polymer-based mixture was transferred to a ceramic boat and heated in a tube furnace at rate of 25° C./min under argon atmosphere. The temperature was held at 500° C. for 40 min to carbonize the plastic and get porous carbon. After cooling down, 1.5 g of sorbent/salt product was recovered. The product was washed with DI water and filtered using a 0.22 μm PTFE filter to obtain 0.08 g of porous carbon after drying at 100° C. overnight.

To activate the sorbent, one of the following can be performed:
(a) Heat the sample at a temperature of 120° C. and a pressure of 15-10 mbar (a higher vacuum cannot be applied without destruction of the material) for at least 1 hour. As the material activates, water is removed from the binding site, causing pressure to slightly increase. Be sure to adjust the vacuum to back to 10 mbar all the time during the activation process.
(b) Heat the sample at 120° C. and flush the sorbent with CO₂ three times going from 1 bar to 50 bars in each round.
(c) Do not pull high vacuum on this material as it results on pores collapse and thus sorbent failure.

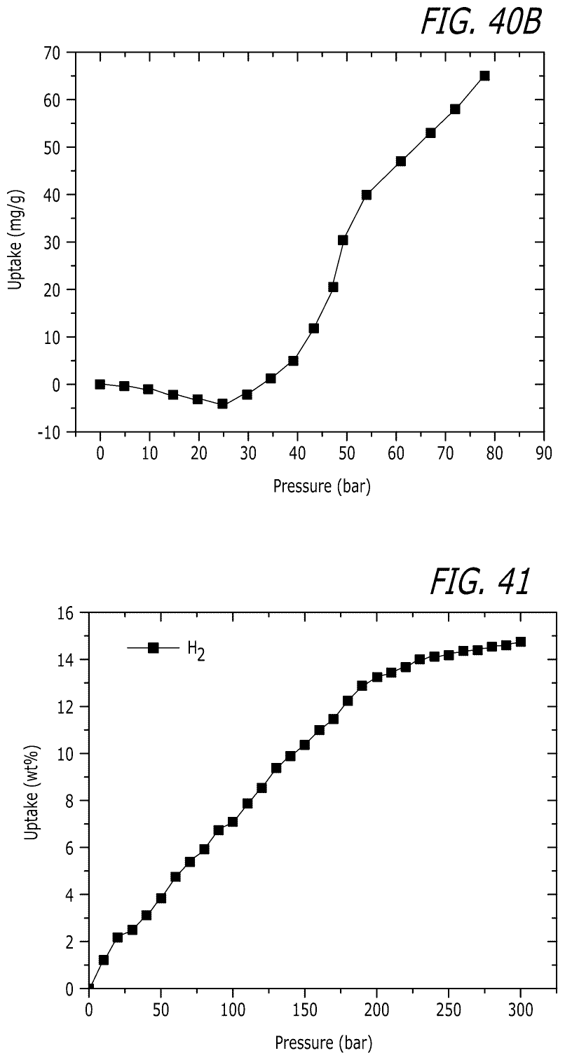

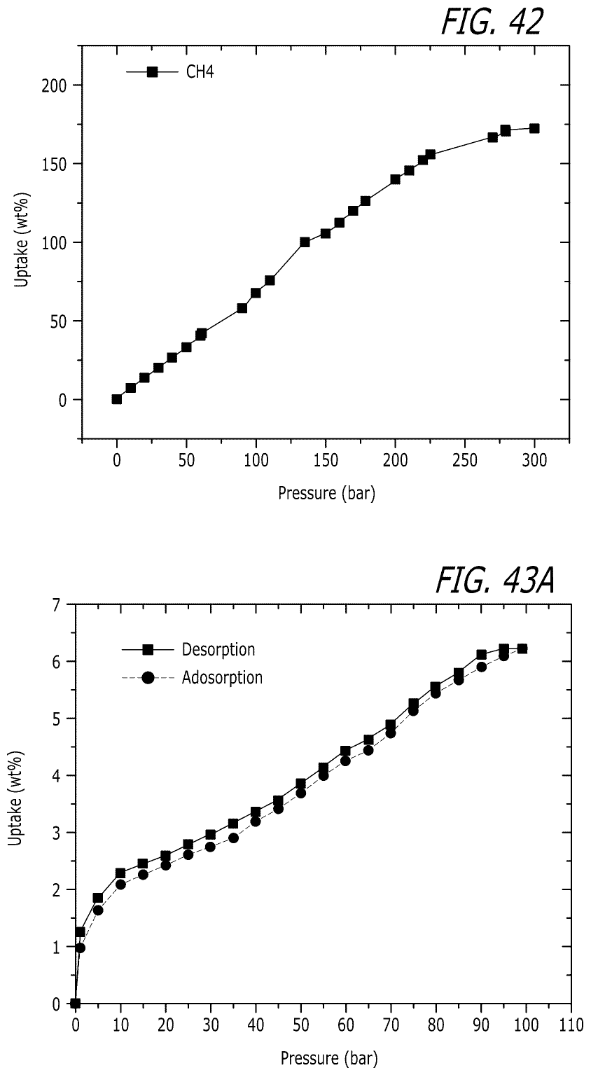

The United States Department of Energy (DOE) goal for 2020 for onboard hydrogen storage for light-duty vehicles is 4.5 wt % at 100 atm and room temperature. The DOE's goal for 2025 is 5.5 wt % at 100 atm, with an ultimate goal of 6.5 wt % at 100 atm and room temperature. [DOE Technical Targets]. Embodiments of the present invention have already exceeded the 2025 goal and the ultimate goal with their 8 wt % capture at 100 atm and room temperature, thereby underscoring the novelty of the advance described here. FIG. 40A is the gravimetric H₂ isotherm of 2,1-HDPE-500 showing an uptake of 8 wt % at 100 bars at room temperature. FIG. 40B is the volumetric H₂ isotherm of 2,1-HDPE-500 showing an uptake of 8 wt % at 100 bars at room temperature. FIG. 41 is the H₂ isotherm of 2,1-HDPE-500 showing an uptake of 13 wt % at 200 bar at room temperature and 15 wt % at 300 bar. The sorbent is approaching saturation at around 300 bar. FIG. 42 is CH₄ isotherm of 2,1-HDPE-500 at room temperature reach 160 wt %. The sorbent begins to saturate at around 275 bar.

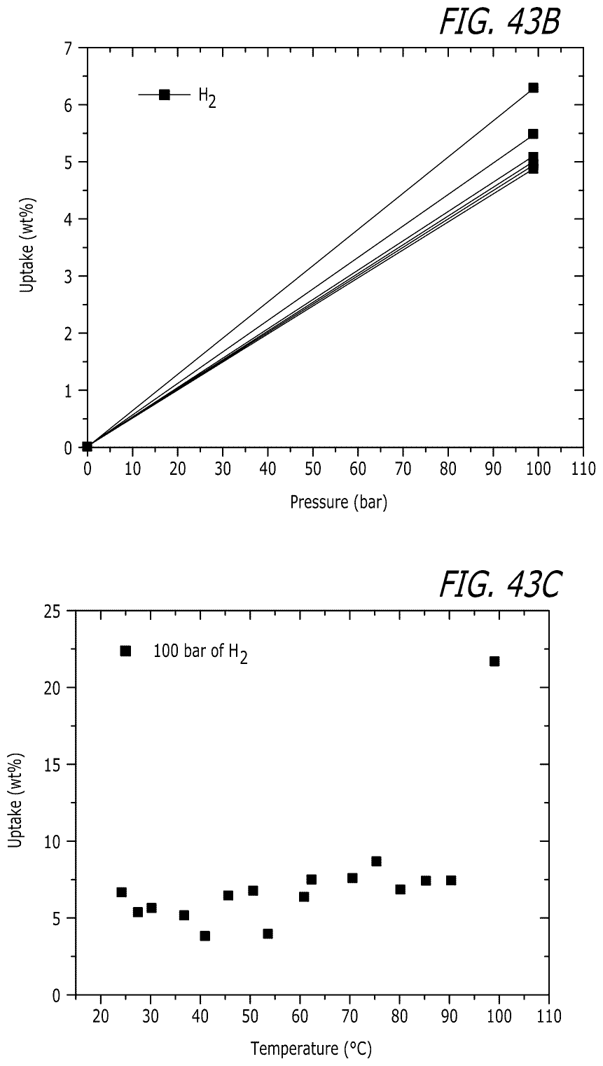

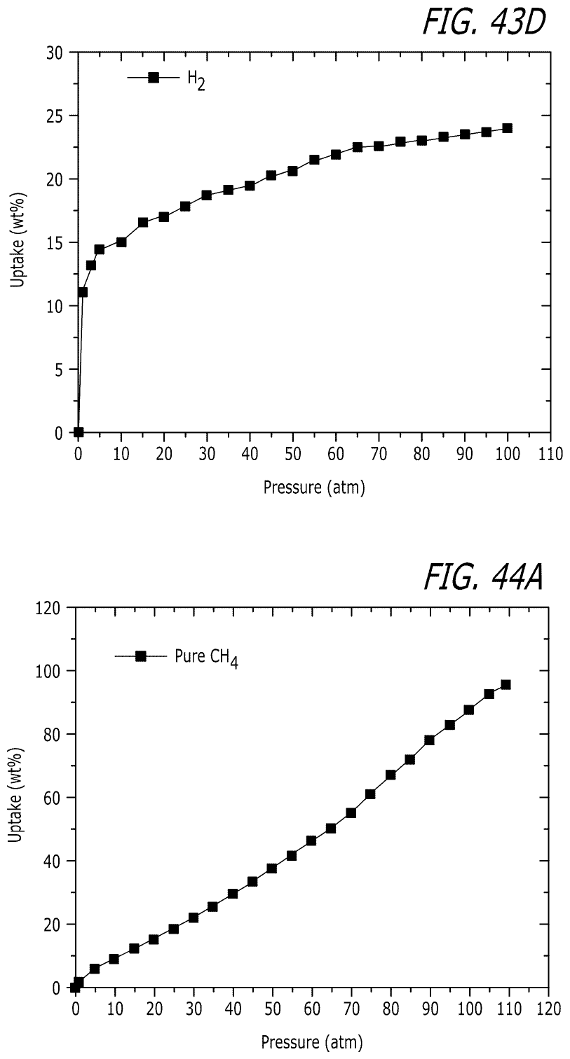

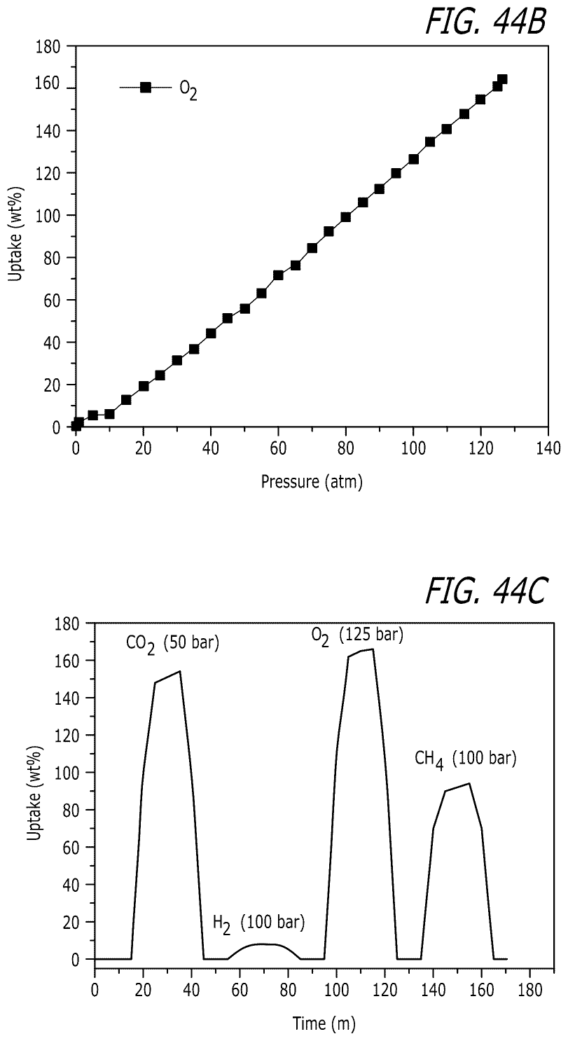

FIGS. 43A-43B shows that 2,1-HDPE-500 has high hydrogen storage capacity at room temperature. FIGS. 43C-43D show that 2,1-HDPE-500 has ultra-high storage capacity at 100° C. As shown in FIGS. 44A-44C, 2,1-HDPE-500 can have high storage capacity for CH₄ and O₂, and can capture CO₂, H₂, O₂, and CH₄ interchangeably.

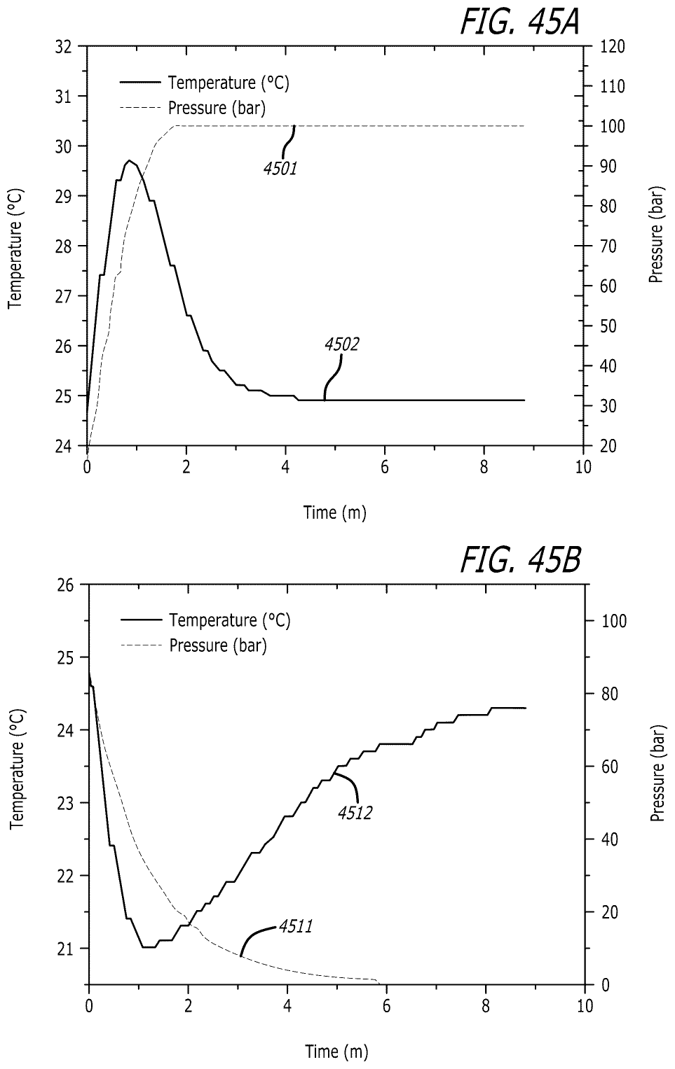

FIGS. 45A-45B show the change of temperature (plots 4501 and 4511) and corresponding change of pressure (plots 4502 and 4512) during H₂ cycling. FIG. 45A show the heat gain during the sorption process; and FIG. 45B shows the heat loss during the desorption process.

### Direct Air Capture

The present invention relates to porous polymeric carbon sorbents for direct air capture (DAC). The results reveal that the porous polymeric carbon sorbents perform better than sorbents with metal-organic framework (MOF), but with none of the high-cost, water instability, and volumetric problems associated with MOFs. Direct air capture of CO₂ (and other gases) from air is a technological goal important to large-scale industrial processes such as gas purification and the mitigation of carbon emissions. Moreover, the porous polymeric carbon sorbents can selectively sorb the gases from air.

In example utilizing HDPE and/or LDPE, to make plastic powder, plastic waste was chilled in liquid nitrogen before it was grounded using a commercial mill. After that, 1 g of plastic powder was mixed with potassium acetate at salt: plastic weight ratio of 4:1. For N-doping, 1 g of N-containing feedstock was added to the plastic/salt mixture. Using a mortar and pestle, the plastic/salt mixture was mixed until a homogeneous blend is formed. Then, 2 g of the polymer-based mixture was transferred to a ceramic boat and heated in a tube furnace at rate of 25° C./min under argon atmosphere. The temperature was held at 620° C. for 45 min to carbonize the plastic and get porous carbon. After cooling down, 1.5 g of sorbent/salt product was recovered. The product was washed with DI water and filtered using a 0.22 μm PTFE filter to obtain 0.07 g of porous carbon after drying at 100° C. overnight.

To activate the sorbent, heat the sample at 120° C. under vacuum (1×10⁻³ mbar) for at least 4 hours. Possible N-containing chemicals include melamine resin, polyethylenimine (most effective), urea, nylon, and NH₃ gas (during the furnace stage).

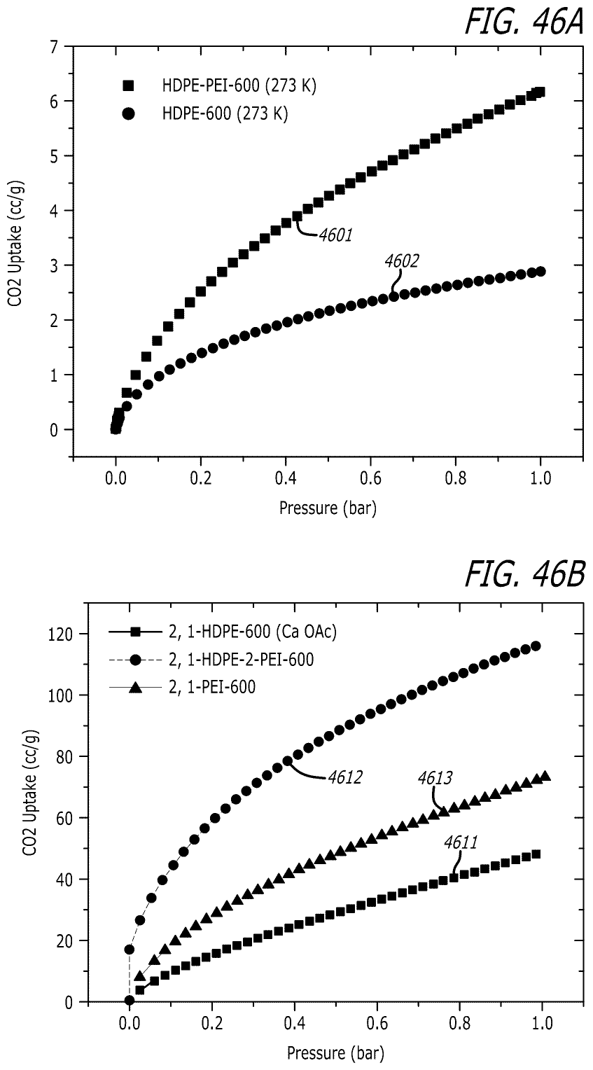

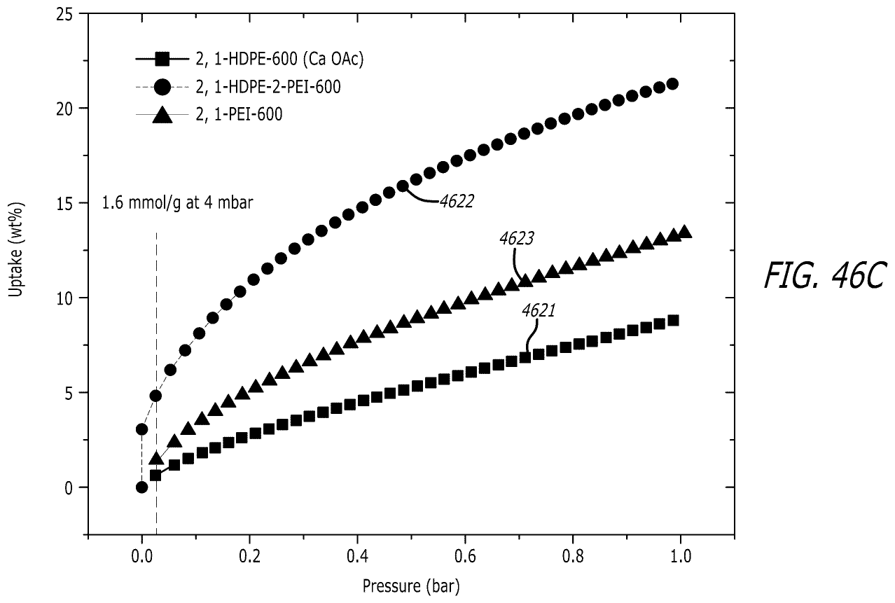

FIG. 46A is the CO₂ isotherm of different sorbent in very low pressure showing great capacity at 4 mbar (plots 4601-4602 for HDPE-PEI-600 and HDPE-600, respectively). FIGS. 46B-4C are the CO₂ isotherms in very low pressure showing great capacity at 4 mbar which is the partial pressure of CO₂ in the air (plots 4611 and 4621 for 2,1-HDPE-600 (Ca OAc), plots 4612 and 4622 for 2,1-HDPE-2-PEI-600, and plots 4613 and 4623 for 2,1-PEI-600, respectively). Thus, high uptake at very low pressure was obtained, especially for 2,1-HDPE-2-PEI-600 at 6.1 wt % CO₂ uptake at 4 mbar in the nitrogen containing polymer (which takes 110° C. for regeneration) whereas without the N-doping it has about 4.4 wt % uptake at 4 mbar but requires only 75° C. for regeneration. N-doped sorbent can also be used for DAC. FIG. 20C shows CO₂ isotherm of NH₄⁺ exchanged 4,1-HDPE-600. An uptake of 27% was obtained when NH₄OH is used to wash the sorbent. And it took 95° C. to regenerate the material by expelling the CO₂.

Additional variations of these embodiments will be obvious to those of ordinary skill in the art. Therefore, the spirit and scope of the appended claims should not be limited to the foregoing description. Only those claims specifically reciting “means for” or “step for” should be construed in the manner required under the sixth paragraph of 35 U.S.C. § 112.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “—” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### REFERENCES

U.S. Patent Appl. Serial No. 2009/0314622, “Oil Extraction Device For Pyrolysis Of Plastics Waste Material And Extraction Method Thereof,” to Joo, Y. S., published Dec. 24, 2009 (the “Joo '622 application”).
PCT Int'l Publ. No. WO/2013/117600, “Hydrothermal carbonization of plastics materials,” to Bettinger, H., et al., published Aug. 15, 2013 (the “Bettinger '600 PCT application”).
PCT Int'l Publ. No. WO/2013/187788, “The Method Of Conducting A Pyrolysis Process Of Plastic Waste And/Or Rubber Waste And/Or Organic Waste And The Installation To Carry Out This Method,” to Majchner, M. et al., published Dec. 19, 2013 (the “Majchner '788 PCT application”).
PCT Int'l Publ. No. WO/2003/010426, “Process For Converting Waste Plastic Into Lubricating Oils,” to Miller S. J., published Oct. 30, 2003 (the “Miller '426 PCT application”).
United States Department of Energy, Office of Energy Efficiency & Renewable Energy, Hydrogen and Fuel Cell Office, “DOE Technical Targets for Onboard Hydrogen Storage for Light-Duty Vehicles,” https://www.energy.gov/eere/fuekells/doe-technical-targets-onboard-hydrogen-storage-light-duty-vehicles, 2020 (“DOE Technical Targets”).
Al-Salem, S. M., et al., “Recycling and recovery routes of plastic solid waste (PSW): A review,” Waste Manage. (Oxford), 2009, 29(10), 2625-2643 (“Al-Salem 2009”).
Allen, S., et al., “Atmospheric transport and deposition of microplastics in a remote mountain catchment,” Nat. Geosci., 2019, 12, 339-344 (“Allen 2019”).
Astaria, G., et al., Gas Treating With Chemical Solvents, John Wiley and Sons, 1983 (“Astaria 1983”).
Bandosz, T. J., Chapter 5 Desulfurization on activated carbons, Interface Science and Technology, Bandosz, T. J., Ed. Elsevier, 2006, 7, 231-292 (“Bandosz 2006”).
Bhattacharjee, S., et al. “Pore size dependent cation adsorption in a nanoporous polymer film derived from a plastic columnar phase,” Chem. Commun., 2018, 54(68), 9521-9524 (“Bhattacharjee 2018”).
Budsaereechai, S., et al., “Catalytic pyrolysis of plastic waste for the production of liquid fuels for engines,” RSC Advances, 2019, 9(10), 5844-5857 (“Budsaereechai 2019”).
Camper, D., et al., “Room-Temperature Ionic Liquid-Amine Solutions: Tunable Solvents for Efficient and Reversible Capture of CO₂,” Ind. Eng. Chem. Res., 2008, 47(21), 8496-8498 (“Camper 2008”).
Chen, E., et al. “Activated Carbon-based Carbon Dioxide Adsorption Process,” Senior Design Reports (CBE), University of Pennsylvania Scholarly Commons, 2017, 89 (“Chen 2017”).
Cheng, H., et al., “Insight into the thermal decomposition of kaolinite intercalated with potassium acetate: an evolved gas analysis,” Journal of Thermal Analysis and calorimetry, 2014, 117(3), 1231-1239 (“Cheng 2014”).
Cox, K. D., et al., “Human Consumption of Microplastics,” Environmental Science & Technology, 2019, 53 (12), 7068-7074 (“Cox 2019”).
Dodson, R. A., et al., “The Metal-Organic Framework Collapse Continuum: Insights from Two-Dimensional Powder X-ray Diffraction,” Chem. Mater. 2018, 30 (18), 6559-6565 (“Dodson 2018”).
Dutcher, B., et al., “Amine-Based CO₂ Capture Technology Development from the Beginning of 2013—A Review,” ACS Applied Materials & Interfaces, 2015, 7(4), 2137-2148 (“Dutcher 2015”).
Dutta, S., et al., “Hierarchically porous carbon derived from polymers and biomass: effect of interconnected pores on energy applications,” Energy & Environmental Science, 2014, 7(11), 3574-3592 (“Dutta 2014”).
Gong, J., et al., “Sustainable Conversion of Mixed Plastics into Porous Carbon Nanosheets with High Performances in Uptake of Carbon Dioxide and Storage of Hydrogen, ACS Sustainable Chem. Eng, 2014, 2(12), 2837-2844 (“Gong 2014”).
Gray, M. L., et al., “Performance of immobilized tertiary amine solid sorbents for the capture of carbon dioxide,” International Journal of Greenhouse Gas Control 2008, 2 (1), 3-8 (“Gray 2008”).
Haszeldine, R. S., “Carbon Capture and Storage: How Green Can Black Be?” Science, 2009, 325(5948), 1647-1652 (“Haszeldine 2009”).
He, J., et al., “Tunable Polyaniline-Based Porous Carbon with Ultrahigh Surface Area for CO₂ Capture at Elevated Pressure,” Advanced Energy Materials, 2016, 6(14), 1502491 (“He 2016”).
Hisaki, I., et al., “Docking Strategy To Construct Thermostable, Single-Crystalline, Hydrogen-Bonded Organic Framework with High Surface Area,” Angew. Chem. Int. Ed., 2018, 57(39), 12650-12655 (“Hisaki 2018”).
Jalilov, A. S., et al., “Ultra-High Surface Area Activated Porous Asphalt for CO₂ Capture through Competitive Adsorption at High Pressures,” Adv. Energy Mater., 2017, 7(1), 1600693 (“Jalilov 12017”).
Jalilov, A. S., et al., “Increased CO₂ selectivity of asphalt-derived porous carbon through introduction of water into pore space,” Nat Energy, 2017, 2(12), 932-938 (“Jalilov II 2017”).
Jalilov, A. S., et al., “Asphalt-Derived High Surface Area Activated Porous Carbons for Carbon Dioxide Capture,” ACS Applied Materials & Interfaces, 2015, 7(2), 1376-1382 (“Jalilov 2015”).
Jung, J. Y., et al., “Limitations and high pressure behavior of MOF-5 for CO₂ capture,” PCCP, 2013, 15 (34), 14319-14327 (“Jung 2013”).
Kiran Ciliz, N., et al., “Pyrolysis of virgin and waste polypropylene and its mixtures with waste polyethylene and polystyrene,” Waste Manage. (Oxford), 2004, 24(2), 173-181 (“Kiran Ciliz 2004”).
Kumar, S., et al., “Recovery of hydrocarbon liquid from waste high density polyethylene by thermal pyrolysis,” Brazilian Journal of Chemical Engineering, 2011, 28, 659-667 (“Kumar 2011”).
Lee, K. T., et al., “Novel synthesis of porous carbons with tunable pore size by surfactant-templated sol-gel process and carbonization,” Chem. Commun., 2002, (22), 2722-2723 (“Lee 2002”).
Lu, A.-H., et al. (editors), Porous Materials for Carbon Dioxide Capture, 2014 (“Lu 2014”).
Lu, W., et al., “Solvent treatment: the formation mechanism of advanced porous membranes for flow batteries,” Journal of Materials Chemistry A, 2018, 6 (32), 15569-15576 (“Lu 2018”).
Mani, M., et al., “Characterisation and effect of using waste plastic oil and diesel fuel blends in compression ignition engine,” Energy, 2011, 36(1), 212-219 (“Mani 2011”).
Myers, A. L., et al., “Thermodynamics of mixed-gas adsorption,” AlChE Journal, 1965, 11(1), 121-127 (“Myers 1965”).
Modak, A., et al., “Advancement in porous adsorbents for post-combustion CO₂ capture,” Microporous Mesoporous Mater., 2019, 276, 107-132 (“Modak 2019”).
Nasri, N. S., et al., “Characteristics of Potassium Acetate-Activated Coconut Shell Carbon,” Advanced Materials Research, 2014, 1043, 193-197 (“Nasri 2014”).
Nishino, J., et al., “Catalytic degradation of plastic waste into petrochemicals using Ga-ZSM-5,” Fuel, 2008, 87(17), 3681-3686 (“Nishino 2008”).
Otowa, T., et al., “Development of KOH activated high surface area carbon and its application to drinking water purification,” Carbon, 1997, 35(9), 1315-1319 (“Otowa 1997”).
Pacala, S., et al., “Stabilization Wedges: Solving the Climate Problem for the Next 50 Years with Current Technologies,” Science, 2004, 305(5686), 968-972 (“Pacala 2004”).
Panda, A. K., “Thermo-catalytic degradation of different plastics to drop in liquid fuel using calcium bentonite catalyst,” International Journal of Industrial Chemistry, 2018, 9(2), 167-176 (“Panda 2018”).
Papadopoulos, A. N., et al. “Determination of surface area and pore volume of holocellulose and chemically modified wood flour using the nitrogen adsorption technique,” Holz als Roh-and Werkstoff, 2003, 61(6), 453-45 (“Papadopoulos 2003”).
Peng, L., et al. “Preserving Porosity of Mesoporous Metal-Organic Frameworks through the Introduction of Polymer Guests,” J. Am. Chem. Soc. 2019, 141 (31), 12397-1240 (“Peng 2019”).
Ramanathan, V., et al., “Air pollution, greenhouse gases and climate change: Global and regional perspectives,” Atmos. Environ. 2009, 43(1), 37-50 (“Ramanathan 2009”).
Rao, A. B., et al., “A Technical, Economic, and Environmental Assessment of Amine-Based CO₂ Capture Technology for Power Plant Greenhouse Gas Control,” Environ. Sci. Technol., 2002, 36(20), 4467-4475 (“Rao 2002”).
Rehman, A., et al., “Influence of nitrogen moieties on CO₂ capture by polyaminal-based porous carbon,” Macromol. Res., 2017, 25(10), 1035-1042 (“Rehman 2017”).
Rochelle, G. T., “Amine Scrubbing for CO₂ Capture,” Science, 2009, 325 (5948), 1652-1654 (“Rochelle 2009”).
Sevilla, M., et al., “Optimization of the Pore Structure of Biomass-Based Carbons in Relation to Their Use for CO₂ Capture under Low- and High-Pressure Regimes,” ACS Appl. Mater. Interfaces 2018, 10(2), 1623-1633 (“Sevilla 2018”).
Siriwardane, R. V., et al., “Adsorption of CO₂ on Molecular Sieves and Activated Carbon, Energy & Fuels, 2001, 15(2), 279-284 (“Siriwardane 2001”).
Sun, J., et al., “Natural gas storage with activated carbon from a bituminous coal,” Gas Separation & Purification, 1996, 10(2), 91-96 (“Sun 1996”).
Tetu, S. G., et al., “Plastic leachates impair growth and oxygen production in Prochlorococcus, the ocean's most abundant photosynthetic bacteria,” Communications Biology, 2019, 2(1), 184 (“Tetu 2019”).
Tour, J. M., et al., “Green carbon as a bridge to renewable energy,” Nature Materials, 2010, 9, 871 (“Tour 2010”).
Wang, Y., et al., “Desulfurization of Liquid Fuels by Adsorption on Carbon-Based Sorbents and Ultrasound-Assisted Sorbent Regeneration,” Langmuir 2007, 23 (7), 3825-3831 (“Wang 2007”).
Younas, M., et al., “Feasibility of CO₂ adsorption by solid adsorbents: a review on low-temperature systems,” Int. J. Environ. Sci. Technol., 2016, 13(7), 1839-1860 (“Younas 2016”).
Xu, J., et al., “Preparation of nitrogen doped carbon from tree leaves as efficient CO₂ adsorbent,” Chem. Phys. Lett. 2018, 711, 107-112 (“Xu 2018”).
Zhang, E., et al., “On the origin of mesopore collapse in functionalized porous carbons,” Carbon, 2019, 149, 743-749 (“Zhang 2019”).
Zhu, X.-L., et al., “Activated carbon produced from paulownia sawdust for high-performance CO₂ sorbents, Chinese Chemical Letters, 2014, 25(6), 929-932 (“Zhu 2014”).

What is claimed is:

1. A method of synthesizing a rigid porous polymeric carbon sorbent, wherein the method comprises the steps of:
(a) mixing a polymer with an additive to form a mixture, wherein
(i) the polymer has a polymer chain order comprising long range order and short range order as detected by powder X-ray diffraction (XRD), and
(ii) the additive is an activation reagent that is selected from the group consisting of metal hydroxide, metal oxalate, metal acetate, metal acetylacetonoate, and mixtures thereof; and
(b) heating the mixture to a temperature to form a porous polymeric carbon sorbent via chemical activation, wherein
(i) the chemical activation results in a loss of the long range order and the short range order of the polymer as detected by powder XRD such that the porous polymeric carbon sorbent material is a rigid porous polymeric carbon sorbent,
(ii) the rigid porous polymeric carbon sorbent is operable for capturing CO₂ at a pressure between 0.75 atm to 5 atm, and
(iii) the rigid polymeric carbon sorbent has a selectivity for capturing CO₂ over N₂ at least 40:1 at 0.15 bar of CO₂ in 0.85 bar of N₂ at 23° C.

2. The method of claim 1, wherein the polymer is selected from a group consisting of high density polyethylene (HDPE), low density polyethylene (LDPE), polypropylene (PP), and combinations thereof.

3. The method of claim 1, wherein the polymer is selected from a group consisting of polyvinyl chloride (PVC), nylon, melamine mixed with HDPE, melamine mixed with LDPE, melamine mixed with PP, melamine-formaldehyde resins, polyethylene imine (PEI), PEI mixed with HDPE, polyurethanes (PU), polyacrylonitrile, (PAN), and polyethyleneteraphthalte (PET) and mixtures therefrom.

4. The method of claim 1, wherein the polymer comprises nitrogen atoms.

5. The method of claim 4, wherein the rigid polymeric carbon sorbent has a selectivity for capturing CO₂ over N₂ at least 300:1 in 0.15 bar of CO₂ in 0.85 bar N₂ at 23° C.

6. The method of claim 1, wherein the polymer comprise a plastic from a waste plastic source.

7. The method of claim 1, wherein the step of heating is performed at a temperature that is between 550° C. and 700° C.

8. The method of claim 7, wherein the step of heating is performed at a temperature that is between 575° C. and 600° C.

9. The method of claim 1, wherein the activation reagent is an acetate salt of potassium or calcium.

10. The method of claim 1, wherein the activation reagent is potassium acetate.

11. The method of claim 1, wherein the activation reagent is calcium acetate.

12. The method of claim 1, wherein weight ratio of the additive and the polymer in the mixture is between 0.5:1 and 5:1.

13. The method of claim 12, wherein weight ratio of the additive and the polymer in the mixture is between 2:1 and 4:1.

14. The method of claim 1, wherein the rigid porous polymeric carbon sorbent is operable for capturing CO₂ from a post-combustion CO₂ emission outlet gas.

15. The method of claim 14, wherein the post-combustion CO₂ emission outlet gas is a flue gas.

16. The method of claim 1, wherein the rigid porous polymeric carbon sorbent is operable for capturing more than 15 wt % CO₂ from a post-combustion CO₂ emission outlet gas at 25° C. and at 1 atm.

17. The method of claim 16, wherein the rigid porous polymeric carbon sorbent is operable for releasing the CO₂ captured from a post-combustion CO₂ emission outlet gas by heating the rigid porous polymeric carbon sorbent to at most 110° C. at 1 atm.

18. The method of claim 16, wherein the rigid porous polymeric carbon sorbent is operable for releasing the CO₂ captured from a post-combustion CO₂ emission outlet gas by heating the rigid porous polymeric carbon sorbent to at most 75° C. at 1 atm.

19. The method of claim 1, wherein the rigid porous polymeric carbon sorbent is operable for capturing more than 18 wt % CO₂ from a post-combustion CO₂ emission outlet gas at 25° C. and at most 5 atm.

20. The method of claim 1, wherein the rigid porous polymeric carbon sorbent is operable for capturing more than 100 wt % CO₂ from a post-combustion CO₂ emission outlet gas at 25° C. and at most 300 atm.

21. The method of claim 1 further comprising controlling pore size of the rigid porous polymeric carbon sorbent by controlling pressure during the step of heating.

22. The method of claim 1, wherein the step of heating the mixture is performed at a near vacuum pressure of at least 0.01 bars.

23. A rigid porous polymeric carbon sorbent that is operable to capture more than 15 wt % CO₂ from a post-combustion CO₂ emission outlet gas at 25° C. and at 1 atm and the rigid polymeric carbon sorbent has a selectivity for capturing CO₂ over N₂ at least 40:1 at 0.15 bar of CO₂ in 0.85 bar of N₂ at 23° C.

24. The rigid porous polymeric carbon sorbent of claim 23, wherein the rigid porous polymeric carbon sorbent comprises a polymer that has no polymeric long range order and no polymeric short range order detectable by powder X-ray diffraction.

25. The rigid porous polymeric carbon sorbent of claim 23, wherein the rigid porous polymeric carbon sorbent comprises pores having an average pore size of between 2 Å and 100 Å.

26. The rigid porous polymeric carbon sorbent of claim 23, wherein the rigid porous polymeric carbon sorbent comprises pores having an average pore size of between 5 Å and 20 Å.

27. The rigid porous polymeric carbon sorbent of claim 23, wherein the rigid porous polymeric carbon sorbent is operable for releasing the CO₂ captured from post-combustion CO₂ emission outlet gas by heating the rigid porous polymeric carbon sorbent to at most 110° C. at about 1 atm pressure.

28. The rigid porous polymeric carbon sorbent of claim 23, wherein the rigid porous polymeric carbon sorbent is operable for releasing the CO₂ captured from post-combustion CO₂ emission outlet gas by heating the rigid porous polymeric carbon sorbent to at most 75° C. at about 1 atm pressure.

29. The rigid porous polymeric carbon sorbent of claim 23, wherein the rigid porous polymeric carbon sorbent is operable for capturing more than 18 wt % CO₂ from post-combustion CO₂ emission outlet gas at 25° C. and at 5 atm.

30. The rigid porous polymeric carbon sorbent of claim 23, wherein the rigid porous polymeric carbon sorbent is operable for capturing more than 100 wt % CO₂ from post-combustion CO₂ emission outlet gas at 25° C. and at 300 atm.

31. The rigid porous polymeric carbon sorbent of claim 23, wherein the rigid porous polymeric carbon sorbent comprises nitrogen atoms.

32. The rigid porous polymeric carbon sorbent of claim 31, wherein the rigid polymeric carbon sorbent has a selectivity for capturing CO₂ over N₂ of at least 250:1 at 0.15 bar of CO₂ in 0.85 bar of N₂ at 23° C.

33. A method comprising:
(a) selecting a rigid porous polymeric carbon sorbent having a selectivity for capturing CO₂ over N₂ least 40:1 at 0.15 bar of CO₂ in 0.85 bar of N₂ at 23° C., and
(b) utilizing the rigid porous polymeric carbon sorbent to capture more than 15 wt % CO₂ from post-combustion CO₂ emission outlet gas.

34. The method of claim 33, wherein the post-combustion CO₂ emission outlet gas is a flue gas.

35. The method of claim 33, wherein the CO₂ is captured from post-combustion CO₂ emission outlet gas at atmospheric pressure.

36. The method of claim 33, wherein the CO₂ is captured from post-combustion CO₂ emission outlet gas at room temperature at around 25° C.

37. The method of claim 33, wherein the rigid porous polymeric carbon sorbent is utilized to capture more than 18 wt % CO₂ from post-combustion CO₂ emission outlet gas.

38. The method of claim 37, wherein the CO₂ is captured from post-combustion CO₂ emission outlet gas at a pressure that is at most 5 atm.

39. The method of claim 33, wherein the rigid porous polymeric carbon sorbent is utilized to capture more than 100 wt % CO₂ from post-combustion CO₂ emission outlet gas.

40. The method of claim 39, wherein the CO₂ is captured from post-combustion CO₂ emission outlet gas at a pressure that is at most 300 atm.

41. The method of claim 33 further comprising releasing the CO₂ captured from post-combustion CO₂ emission outlet by heating the rigid porous polymeric carbon sorbent.

42. The method of claim 41, wherein the CO₂ is released by heating the rigid porous polymeric carbon sorbent to at most 110° C.

43. The method of claim 41, wherein the CO₂ is released by heating the rigid porous polymeric carbon sorbent to at most 75° C.

44. The method of claim 41 further comprising repeating the capture and release of the CO₂ by the rigid porous polymeric carbon sorbent for at least 1000 cycles.

45. The method of claim 41 further comprising repeating the capture and release of the CO₂ by the rigid porous polymeric carbon sorbent for at least 100,000 cycles.

46. The method of claim 33, wherein the rigid porous polymeric carbon sorbent having a selectivity for capturing CO₂ over N₂ of at least 70:1 at 0.15 bar of CO₂ in 0.85 bar of N₂ at 23° C.

47. The method of claim 33, wherein the rigid porous polymeric carbon sorbent comprises nitrogen atoms.

48. The method of claim 47, wherein the rigid porous polymeric carbon sorbent having a selectivity for capturing CO₂ over N₂ of at least 300:1 at least 40:1 at 0.15 bar of CO₂ in 0.85 bar of N₂ at 23° C.
